(19) United States
(12) Patent Application Publication
(10) Pub. No.: US 2005/0132060 A1
(43) Pub. Date: Jun. 16, 2005

(54) SYSTEMS AND METHODS FOR PREVENTING SPAM AND DENIAL OF SERVICE ATTACKS IN MESSAGING, PACKET MULTIMEDIA, AND OTHER NETWORKS

(76) Inventors: Richard Mo, Colorado Springs, CO (US); James William Bishop JR., Colorado Springs, CO (US); Sandra Au, Colorado Springs, CO (US)

Correspondence Address: Chief Technology Officer, ArmorPost, 8430 Terrapin Trail, Suite 200, Colorado Springs, CO, 80919, US

(21) Appl. No.: 10/904,919

(22) Filed: Dec. 5, 2004

Related U.S. Application Data
(60) Provisional application No. 60/529,532, filed on Dec. 15, 2003.
(60) Provisional application No. 60/579,575, filed on Jun. 14, 2004.
(60) Provisional application No. 60/605,993, filed on Aug. 31, 2004.

(51) Int. Cl. G06F 15/16

(52) U.S. Cl. 709/227

(57) ABSTRACT

A system, various methods, and various apparatuses are provided for the purpose of supplying and including in an electronic message or multimedia session signalling unit a valid cryptographic authentication token, verifying said token's validity upon arrival of said message or signalling unit, and thereby providing message recipients or session parties with the assurance that said message or signalling unit is from a valid sender. A system, apparatus, and various methods are further provided for the purpose of protecting legitimate application traffic and the network elements exchanging it from intrusion by wild packets attempting to consume application resources and thereby deny service to legitimate users or network elements. A system, various methods, and various apparatuses are further provided for the purpose of enabling legitimate advertising via electronic messages, relying upon message and sender authentication to assure both advertisers and viewers of advertising messages that all participants are valid, legitimate, and accountable for any abuse that may occur.

### CROSS-REFERENCE TO RELATED APPLICATIONS

This application claims the benefit of U.S. Provisional Patent application 60/529,532 filed on Dec. 15, 2003, 60/579,575 filed on Jun. 14, 2004, and 60/605,993 filed on Aug. 31, 2004, the disclosures of which are incorporated herein by reference.

### TECHNICAL FIELD OF THE INVENTION

This invention pertains in general to electronic communication in messaging networks, such as email and similar media, in packet multimedia networks, such as those using Voice over Internet Protocol (VoIP) technologies, and in other networks, such as those providing web-based transaction services. The invention pertains in particular to providing authentication of message originators (senders) and media session originators (callers), such that unsolicited communications originated by commercial and/or disreputable entities, commonly referred to as spam, may be rejected prior to acceptance or redirected to an alternate network. The invention further pertains in particular to creating a network in which servers receive traffic only from other servers that are trusted and authorized. Offered traffic from unauthorized, untrusted computers does not even reach the destination server, thereby preventing unwanted signalling such as spam and Denial of Service attacks. The invention further pertains in particular to a mechanism whereby legitimate businesses may correspond via electronic mail with interested customers, and send direct mail electronically to interested recipients.

### BACKGROUND OF THE INVENTION

Spam is generally defined as any communication that is both unsolicited and unwanted. It has become a costly, annoying, often offensive, and occasionally destructive common hazard in most users' experience with electronic messaging (email). Similarly, most people with a telephone have experienced unwanted and unsolicited calls from telemarketers, and most people with a residential address receive junk mail, both of which may properly be considered a kind of spam as well. Spam is often sent in large quantities to random recipients by less-than-reputable organizations or individuals, but even ordinary products advertised with low-volume and inoffensive communications can be unsolicited and unwanted, and therefore be classified as spam.

Messaging spam currently consumes network capacity in an amount roughly equal to the intended traffic. Over the next half decade this unwanted consumption is expected to grow to roughly three times the intended traffic. Voice spam (telemarketing) pays its own way in the “Plain Old Telephone Service” (POTS) network, but as VoIP and related technologies continue their steady growth to prominence, the economics of the situation will change. Voice spam, and eventually multimedia spam, will grow to traffic proportions that reach and perhaps surpass those of messaging spam.

Many systems exist which attempt to prevent the flow of messaging spam. The most common technique involves lexically scanning each message passing through a server or arriving in a user's mailbox, and discarding or setting aside those messages which match certain patterns. One widely-used such system is the Brightmail message filtering service. Others include filtering capabilities built into popular message handling software such as sendmail, Microsoft Exchange, and Microsoft Outlook. Usually, the email address of the sender is forged in order to evade these filters, and spammers tend to change their message content frequently as well, again in an attempt to evade filters. Thus even the best filters, including the highly-regarded Bayesian analysis technique found in Spam Assassin and similar programs, can never be 100% effective.

Further, while lexical scanners and other filters can, to some degree, prevent users from receiving spam, they cannot prevent the messages from being sent in the first place. They are inherently reactive, catching new forms as they are discovered. An extreme example of this technique can be found in Vipul's Razor, commercialized by Cloudmark as SpamNet, which provides a user-driven spam-reporting system that in turn provides distribution of filter rules. Because of this reactive nature, the network traffic associated with spam is not avoided. Several techniques exist which attempt to prevent those who create spam from being able to send any messages at all. However, these tend to depend on vigilance by large numbers of network administrators, and can easily be circumvented by intentional non-conformers. As well, the practice of forging headers mentioned above contributes further to the difficulty in this problem. Because there is no shortage of such non-conformant service providers, the cost of spam to its senders is so low that they can generate enormous volumes of it and still recover the cost with only a few responses. Thus the cost of messaging spam is actually borne more by those users who don't want it than by the spammers and their customers. The non-electronic counterpart of messaging spam, junk mail, generally doesn't overwhelm its recipients precisely because it costs its senders real money. Only by raising the cost or reducing the response rate can the messaging spammer's business model be rendered unworkable.

Proposals have been made that attempt to shift the cost of electronic messaging to senders by having them perform costly tasks for each message. In one approach, cited in the April, 2003, issue of Technology Review, unknown senders are forced by the recipient to spend roughly 10 seconds computing the response to a challenge, thereby proving their legitimate desire to have the message accepted. In another, cited Mar. 20, 2003 by InternetWeek, messages from unknown senders are rejected unless they carry a code purchased from a charitable organization. These proposals do appear to shift costs to senders in a way that would destroy the spammer's business case. However, they also rely upon significant infrastructure changes within the messaging network in order to operate, and require senders to take steps that benefit recipients with no corresponding advantage to themselves.

An emerging class of messaging spam prevention techniques involves detecting legitimate senders and giving them free tokens, which they include in each message so that the message will be recognized by the recipients' email infrastructure as valid. Several different token-based systems are in use, featuring various kinds of tokens. Among these are challenge-response systems, which detect real users by imposing a reverse-Turing test upon senders, and thenceforth use the sender's email address as a token for safe passage (for example, Mailblocks); secret-word systems, wherein recipients provide senders with a character string, known only amongst themselves and the recipients' mail server, to be included in the message Subject (for example, MailKey); and copyrighted-token systems, in which legitimate users are licensed to attach a copyrighted character string, such as a poem, to their messages for safe passage (Habeas). Each of these is essentially a non-cryptographic means of user authentication, and in such systems forgery is both trivial to accomplish and hard to detect.

A few techniques exist which take advantage of cryptographic authentication. Many lexical filters allow messages that are signed using common protocols (S/MIME, PGP) to pass unhindered. However, no mail server attempts to verify the signature because the encryption involved uses keys that are available only to the end users participating in the message. Though invalid messages can be ignored by recipients using this technique, forged signatures can be used for server passage, so traffic reduction is not achieved. Similarly, the ArmorPost Email Privacy system, previously disclosed by the present inventors in U.S. patent application Ser. No. 10/701,355 entitled “System and method for private messaging” and filed Nov. 4, 2003, permits end users to ignore messages that are not signed and encrypted. In that system, a server verifies cryptographic signatures and discards invalid messages, so forgeries are prevented. However, most email users do not regard encryption as a significant need, so the likelihood that most recipients can depend upon most legitimate senders to use this system is low. The Yahoo DomainKeys proposal also uses server-generated and server-verified cryptographic signatures for message source authentication. However, that system relies upon self-published, and therefore potentially self-signed, encryption certificates stored in openly accessible Domain Name System (DNS) servers. Such an approach raises important trustworthiness and scalability questions.

Efforts are ongoing in the networking standards community to create mechanisms whereby certain network topology constraints may be imposed on mail servers. The AntiSpam Research Group (ASRG) of the Internet Engineering Task Force (IETF) in particular are standardizing a requirement that mail servers which are authorized to send mail from a domain be identified in the name server for that domain. Proposals to this process include Microsoft's “Caller ID for Email” and the “Sender Policy Framework” (SPF). These “Reverse Mail Exchanger” techniques have the potential to be effective in preventing forgery of senders' addresses, and in identifying renegade networks. However, they have the side effect of making somewhat difficult, and thereby potentially preventing entirely, behaviors upon which certain legitimate users depend. Further, for any portion of the network to benefit from these techniques, it is necessary for substantially all of the network to participate. Such an extreme dependence on universal deployment can lead to significant delays in activation of the benefits.

Similar issues arise for multimedia spam as arise for messaging spam. In the POTS network, traditional telemarketing is regulated, somewhat successfully, through the so-called “Do Not Call List” approach. In VoIP technologies, which support not just voice calls but generalize to sessions supporting any combination of streaming media, this approach will be mostly ineffective due to the different economics associated with traditional telephony compared with those of VoIP.

Specifically, circuit-oriented technologies and traditional tariffing practices create call pricing that makes international telemarketing generally expensive; domestic telemarketing is not inexpensive, either. Organizations that engage in traditional telemarketing are generally well funded and reasonably reputable; the high cost of calling keeps out the riff-raff, as it were, just as the price of mailing affects the quality and volume of junk mail people receive. However, in a VoIP network a caller experiences roughly the same very low cost regardless of location and calling volume, just as in the case of electronic messaging. Many countries do not or cannot charge their traditional international tariffs on VoIP calls, so there is a significant cost advantage to using VoIP technology. Since domestic regulations generally do not extend internationally, and calling costs are mostly the same for VoIP-based telemarketing regardless of origin, unwanted calls will rise in frequency to and beyond the levels which prompted “Do Not Call” regulations. Worse, the ease of originating VoIP-based calls using ordinary computers may lead to many of the same sorts of annoyances and hazards in this medium as are seen in electronic messaging.

With these similarities, it might seem that many of the same approaches created over the years for preventing messaging spam could apply to preventing voice and multimedia spam. However, while the signalling architectures of messaging and VoIP are fundamentally the same, their content architectures are quite different. Content filtering techniques that are used to analyze text-based messages generally are not applicable to VoIP-based audio or video streams. Real-time streaming media content analysis technologies may or may not mature sufficiently for widespread use. However, as has been seen in the messaging anti-spam arena, content filtering does not solve the problem anyway. Clearly, just as is required to stop messaging spam, stopping VoIP spam requires authentication of the call setup signalling and its sender. With this in place, unwanted calls can be screened on the basis of sender identity, and call-handling servers can constrain their users to reasonable numbers of calls in any given period of time.

What is needed, then, is a system for authenticating message senders and media session originators that is not susceptible to forgeries, is not required to impose the indignity of a reverse-Turing test (although it could impose one for additional assurance), is sufficiently simple that practically all senders, callers, and service providers will endure no significant burden using it, and is sufficiently simple that any recipient mail or call server can participate, thereby rejecting spam prior to its entry into the recipient network. Such a system would further be able to track and control the number of messages sent, calls placed, and recipients named by participating senders and callers. Multiple levels of service can be offered for heavy and light users, but the system would simply not offer a service level that permits a user to send the number of messages required by successful spammers, or to place more outgoing calls than a human can reasonably make. Recipients can thus be assured that any communication arriving through such a system is legitimate; recipient mail and call servers can successfully reject any other communications, thereby avoiding the unwanted traffic and the cost of its corresponding network capacity. Such a system would further be able to provide its benefits immediately to any user of a network which deploys it, without being required to wait for universal deployment in other networks before benefiting from local deployment.

It is thus a principal aim of the present invention to create an antispam solution that is both simpler for originators and more reliable for recipients than existing options, and which permits receiving service providers to protect their networks from unwanted traffic, immediately upon deployment in their networks.

Network Denial of Service (DoS) attacks, whether from a single source or, more commonly, from multiple sources in what is called a Distributed Denial of Service (DDoS) attack, have the potential to disable a server and prevent its legitimate users from receiving the expected service. One way to characterize attack strategies is to recognize whether the attacker is attempting to access the victim server's application layer and overwhelm its processing capacity or memory resources, or merely overwhelm its packet layer with junk and consume all of its network bandwidth.

In general, both classes of attack are difficult to defend. A DDoS of sufficient scope can consume a server's network access bandwidth entirely without the server itself being able to do anything, simply due to the architecture of networks: the bandwidth consumption occurs on a resource that is physically encountered by the packets before the target server is involved. Similarly, if the server is listening to the network at the application layer (usually a TCP or UDP port number) in order to provide the corresponding service, attack packets aimed at that application layer (port) must be handled at least partly in order to determine if they are valid and eligible for service.

Typical defenses, well known to those skilled in the art, include firewalls, which can stop packets addressed to a service the server does not provide; intrusion detection/prevention systems, which monitor traffic for abnormal patterns and redirect or halt extraordinary loads; application-layer gateways, which attempt to perform some portion of the service processing (often the request validation and authorization portions) in advance of the actual server; and over-provisioning, in which the service provider allocates excess server and/or network access capacity so that an attacker's job is that much harder. Overprovisioning is simple, but usually not inexpensive, and merely moves the problem to a higher resource plateau; the defender ends up paying more for larger attacks and not gaining any value from the extra resource that isn't needed for the service. Application-layer gateways are in a practical sense just as vulnerable to the DDoS attack as the servers they are protecting. The exact vulnerabilities may be different, due to diverse implementations and distribution of the service state machine. However, fundamentally this is simply another form of overprovisioning so the costs must be considered carefully. The first two defenses, on the other hand, do attempt to conserve resources. They endow routers, which would exist in the network anyway, with additional functionality that attempts to screen out packets that would be invalid at, or simply overwhelm, the server. In both cases, however, determining application-layer validity of a particular packet or stream of packets can generally only be performed with 100% accuracy by the application layer itself, due to state and algorithm/semantic dependencies. Therefore, routers with firewall or IPS capability typically screen only for syntactic correctness. While this is a significant improvement over an unprotected server, blocking many packet-layer attacks, an effective application-layer attack may still be constructed using “correct” packets. As with spam filters, ever finer definitions of “correct” do not prevent unwanted packets; they merely change the specifics of the attacker's requirements, thus precipitating an escalating interchange of capabilities development (also called an “arms race”).

These defenses also struggle to distinguish random traffic, which may or may not be valid, from traffic that can be predicted because it is explicitly authorized. Most services are designed to handle random traffic, such as incoming email from arbitrary sources or web requests from arbitrary unknown clients. Therefore, firewall and IPS designs tend to be tuned to such behavior as well. However, in general a service will actually experience both random traffic and routine traffic, such as correspondence with known associates or web-based process signalling among known business partners. Attempts to distinguish these categories of traffic run into the problem of identity spoofing by attackers, which cannot be prevented without a strong authentication technique such as one based upon Public Key Cryptography. A common solution is to establish explicitly authorized encrypted tunnels (sometimes called Virtual Private Networks, or VPNs) among the correspondents. This technique can be quite effective, but it suffers high complexity due to the need for exchange of encryption keys among the participants. While public-key implementations such as Transport Layer Security (TLS) handle part of this problem automatically, the critical first step—trading trusted public key certificates—still depends in many applications on interpersonal exchange or bilateral agreement. To accomplish this step with more than a few correspondents is challenging; to establish arbitrary new relationships quickly is beyond the capabilities of prior art systems. Further, since a server handling both random and routine traffic is by definition exposed to the random traffic, attack traffic may overwhelm server resources and still block VPN traffic despite its known, expected, and authorized nature.

What is needed, then, is a system whereby different types of traffic may be handled with different defense mechanisms, as well as a defense mechanism specifically designed to detect and promptly handle predicted, authorized traffic while applying traditional techniques to the arbitrary remaining traffic. Such a system would be very simple to configure and manage, and would not require bilateral agreements among pairs of correspondents.

It is thus another principal aim of the present invention to create a DoS defense that reliably separates predicted traffic from random traffic, ensures that attacks structured as valid random traffic cannot impinge upon the predicted traffic, and does so without incurring the so-called “n-squared” complexity of multiple bilateral relationships among predicted correspondents.

Because of the prevalence of spam in email, it is for all practical purposes impossible for legitimate businesses to use email as a medium for legitimate advertising. Several companies have attempted to create legitimate direct email marketing businesses, but economies of scale require that for such a business to be viable it must subscribe a significant portion of network users as participants, yet before such an event it must subscribe a significant portion of potential advertisers. Further, societal forces require that such a business earn the trust of the community before users will subscribe and agree to receive marketing messages (also known as “opt-in”). Many existing systems based on opt-in are generally untrusted in the user community because their operators share the permission with one another in an unconstrained fashion. A user who opts in for advertising messages from a human-services charity may begin to receive messages from an animal-rights organization, for example. These secondary messages are considered spam, the credibility of the primary organization is damaged, and the user no longer opts in anywhere.

It is the sharing of email addresses among these advertisers that creates the problem. Similarly, the “Do-not-Spam Registry” authorized by the so-called CAN-SPAM Act recently enacted in the United States is expected to create more spam than it prevents precisely because it shares a large list of valid email addresses with those who would advertise. While they are required not to send advertising messages to those listed, it is likely that unscrupulous organizations will violate this restriction routinely. Further, many advertising organizations, including both spammers and legitimate businesses, exist outside the jurisdiction of U.S. law. They may be able to access the “Registry” CAN-SPAM authorizes without being subject to its usage limitations.

Most current mass-targeted advertising in the Internet medium takes place via search engines, such as the widely-used Google. These services provide a mechanism for users to specify what information they seek, and respond with a list of likely sources for that information. Most search engines provide results that include both non-commercial sources and advertisements.

Because of the difficulties identified above with direct email marketing, such advertising is inherently poorly targetted. Advertisers must attract users to their information, and entice them to provide an address for future direct mail. No mechanism exists for advertisers to offer future information to users, who may or may not search again, and who may or may not provide an address. Users who prefer not to provide an address cannot be reached with existing systems.

What is needed, then, is a system whereby legitimate businesses and other organizations may advertise through a reputable and trusted intermediary, users may selectively permit direct email marketing on topics or advertisers of interest, and users' addresses are never shared directly with the advertisers. In such a system, the trusted intermediary would provide a communication path between the advertiser and the users who have opted in, whereby only the intermediary knows the addresses of the users. Thus, advertisers would be unable to share addresses and convert a legitimate opt-in into spam. The intermediary would have sufficient pre-existing scale and trust to attract both advertisers and users in large numbers, thereby overcoming the business deficiencies of existing direct email marketing companies.

It is thus another principal aim of the present invention to provide a system that enables direct email marketing, by legitimate advertisers and targetted at verified recipients, through a trusted intermediary that does not share users' email addresses with advertisers. That is, having eliminated spam, it is desirable to enable legitimate email marketing.

### SUMMARY OF THE INVENTION

Accordingly, the present invention provides a simple, universal means of creating and distributing cryptographic tokens for authenticating messages, senders, call signalling, and callers. The present invention further provides that user addresses are confirmed to be valid, cryptographic tokens are created and distributed for each user address automatically, and a cryptographic token associated with a user address is thereby assured to correspond correctly with that address. The present invention also provides that the address of a message's sender or session's originator is confirmed to be valid, a cryptographic token that binds the message/call request and its validated sender/caller is created automatically and attached to the message/signalling, and the recipients are thereby assured of the sender's/caller's address. In addition, the present invention provides that message and call setup traffic from each user address can be limited to typical or enhanced levels by subscription. Taken together, these features provide the significant additional advantage that spam traffic can be rejected at recipient mail and call servers, thereby avoiding the cost associated with moving such traffic within the network.

The present invention additionally provides a gateway which distinguishes predicted, authorized network traffic from traditional arbitrary network traffic. Further, in the present invention the discriminated traffic is routed to its destination in a manner that prevents each class from interfering with the other at the application layer, such that the receiving gateway can handle the authorized traffic at a higher priority than the arbitrary traffic. The present invention also provides that the application layer ports used for authorized traffic are randomized in a manner that prevents discovery of the correct port by any sender other than an authorized sender, thus making it practically impossible for an application layer denial of service attack to find the application and disrupt the authorized traffic.

The present invention additionally provides a scalable, trustable means of electronic advertising. Further, the present invention provides that advertising may be delivered specifically to self-identified interested parties via direct electronic mail, without identifying to the advertiser the interest parties' addresses.

The above and other advantages of the present invention are carried out in one form by a system of cooperating elements, each of which applies cryptographic and other procedural means as specified below to ensure the authenticity of a message or call request as it is conveyed from its sender to its recipients.

### BRIEF DESCRIPTION OF THE DRAWINGS

The invention will be better understood from a reading of the following detailed description in conjunction with the drawing figures, in which like reference designators are used to identify like elements and in which:

FIG. 1 illustrates a high-level block diagram of the overall system in which the messaging spam prevention capability of the present invention operates;

FIG. 2 illustrates a block diagram of a software program and corresponding computer system which can operate as a Messaging AntiSpam Gateway in the system of the present invention;

FIG. 3 illustrates a block diagram of a software program and corresponding computer system which can operate as a Registry in the system of the present invention;

FIG. 4 illustrates a block diagram of the authentication Token data structure in accordance with the present invention;

FIG. 5 illustrates a flow chart for the Token Creation process in accordance with the present invention;

FIG. 6 illustrates a flow chart for the Token Verification process in accordance with the present invention;

FIG. 7 illustrates a combination signalling sequence chart and flow chart for the Message Transfer and Token Handling process in accordance with an embodiment of the present invention in which both sender and recipient are served by Messaging AntiSpam Gateways;

FIG. 8 illustrates a combination signalling sequence chart and flow chart for the Message Transfer and Token Handling process in accordance with an embodiment of the present invention in which the sender is registered at a Registry and is not served by a Messaging AntiSpam Gateway, and the recipient is served by a Messaging AntiSpam Gateway;

FIG. 9 illustrates a combination signalling sequence chart and flow chart for the Message Transfer and Token Handling process in accordance with an embodiment of the present invention in which the sender is not registered at a Registry and is not served by a Messaging AntiSpam Gateway, and the recipient is served by a Messaging AntiSpam Gateway;

FIG. 10 illustrates a combination signalling sequence chart and flow chart for the Message Transfer and Token Handling process in accordance with an embodiment of the present invention in which the sender is served by a Messaging AntiSpam Gateway, and the recipient is registered at a Registry and is not served by a Messaging AntiSpam Gateway but instead uses an ArmorPost Agent Client;

FIG. 11 illustrates a combination signalling sequence chart and flow chart for the Message Transfer and Token Handling process in accordance with an embodiment of the present invention in which both sender and recipient are registered at Registries, and neither is served by a Messaging AntiSpam Gateway, and each uses an ArmorPost Agent Client;

FIG. 12 illustrates a combination signalling sequence chart and flow chart for the Message Transfer and Token Handling process in accordance with an embodiment of the present invention in which the sender is not registered at a Registry and is not served by a Messaging AntiSpam Gateway, and the recipient is registered at a Registry and not served by a Messaging AntiSpam Gateway but instead uses an ArmorPost Agent Client;

FIG. 13 illustrates a high-level block diagram of the overall system in which the dynamic business directory capability of the present invention operates;

FIG. 14 illustrates a block diagram of a software program and corresponding computer system which can operate as a Dynamic Directory Engine in the system of the present invention;

FIG. 15 illustrates a block diagram of a software program and corresponding computer system which can operate as a Dynamic Directory Clearinghouse in the system of the present invention;

FIG. 16 illustrates a combination signalling sequence chart and flow chart for an interactive mediated communication between a user and an advertiser in accordance with an embodiment of the present invention;

FIG. 17 illustrates a combination signalling sequence chart and flow chart for a mediated bulletin from an advertiser to a user in accordance with an embodiment of the present invention;

FIG. 18 illustrates a combination signalling sequence chart and flow chart for the Dynamic Directory transaction clearing process in accordance with an embodiment of the present invention;

FIG. 19 illustrates a high-level block diagram of the overall system in which the multimedia spam prevention capability of the present invention operates;

FIG. 20 illustrates a block diagram of a software program and corresponding computer system which can operate as a Multimedia AntiSpam Gateway in the system of the present invention;

FIG. 21 illustrates a combination signalling sequence chart and flow chart for the Session Setup and Token Handling process in accordance with an embodiment of the present invention in which both caller and recipient are served by Multimedia AntiSpam Gateways;

FIG. 22 illustrates a block diagram exemplifying the authorization topology of the present invention;

FIG. 23 illustrates a combination signalling sequence chart and flow chart for an exemplary detailed Introduction process;

FIG. 24 illustrates a block diagram of a software program and corresponding computer system which can operate as a Network Authority in the system of the present invention;

FIG. 25 illustrates a high-level block diagram of the overall system in which the DoS prevention capability of the present invention operates;

FIG. 26 illustrates a block diagram of a software program and corresponding computer system which can operate as a Secure Application Gateway in the system of the present invention;

FIG. 27 illustrates a flow chart for the Port Randomization process in accordance with the present invention;

FIG. 28 illustrates a combination signalling sequence chart and flow chart for the Transaction Data Exchange process in accordance with an embodiment of the present invention in which both originating and destination servers are protected by Secure Application Gateways; and

FIG. 29 illustrates a combination signalling sequence chart and flow chart for the Transaction Data Exchange process in accordance with an embodiment of the present invention in which only the originating server is protected by a Secure Application Gateway.

### DETAILED DESCRIPTION OF THE PREFERRED EMBODIMENTS

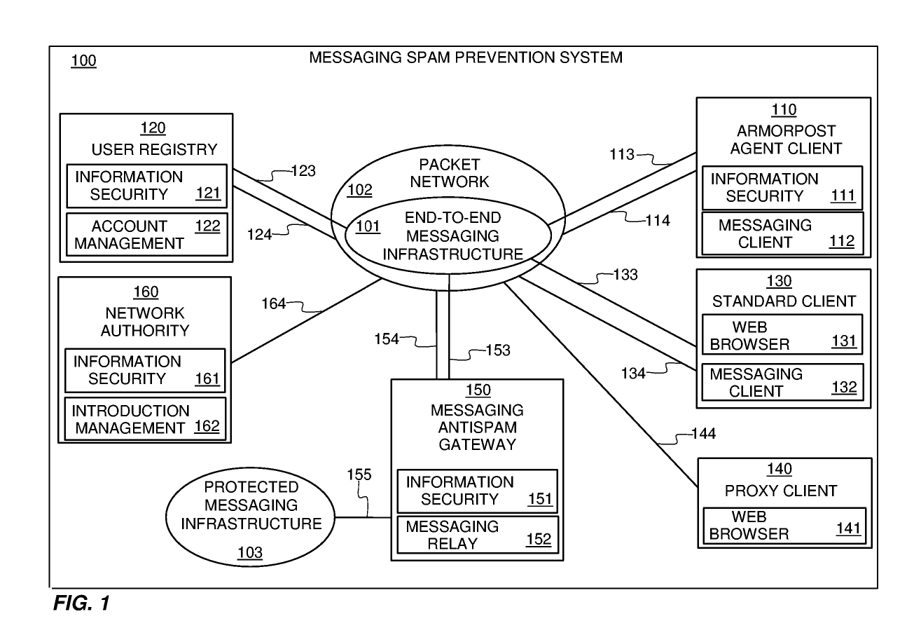

In FIG. 1, Messaging Spam Prevention System 100 represents the system of the present invention. It is in some respects an extension of the Private Messaging System disclosed by the present inventors in Utility patent application Ser. No. 10/701,355, and sharing many of its elements. That application is incorporated herein by reference and referred to hereinafter as ArmorPost. Several major elements make up this system. First, End-to-End Messaging Infrastructure 101 represents the messaging backbone to which the Spam Prevention capability is added. This Infrastructure can be any messaging system that allows users or automatic programs to exchange messages with one another. It is preferably the Internet-standard email service, but may also be implemented as an instant messaging service, a wireless short message service (SMS), any other messaging service, or any combination of these. Second, Packet Network 102 forms the foundation for all communication among elements, including End-to-End Messaging Infrastructure 101 and the messages exchanged thereon, but also supporting other non-messaging interactions such as web browsing. This element is preferably an Internet-based network, and may be the Internet itself, another network like it, or a composite of networks using multiple interworking technologies.

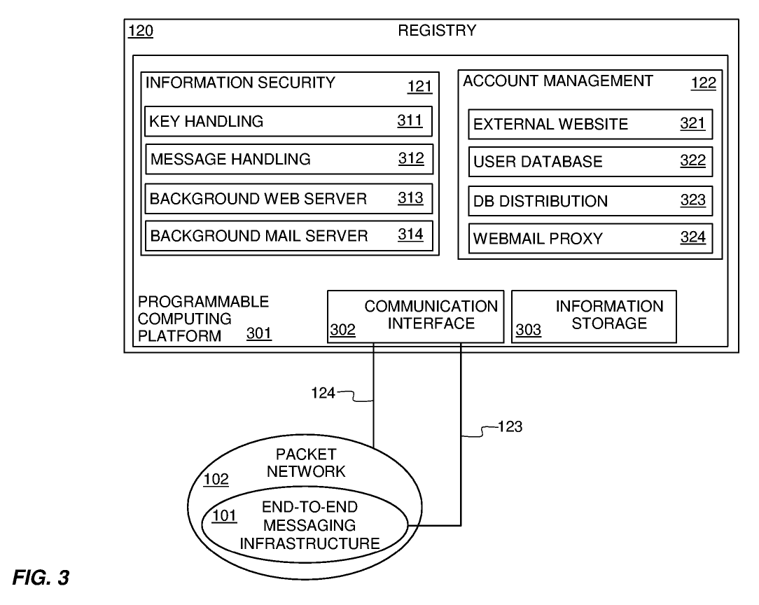

Connected to End-to-End Messaging Infrastructure 101 and Packet Network 102 is at least one User Registry 120 (also referred to as simply Registry 120). This element allows users to register for service. It is similar in many respects to the Trusted Courier 120 described in ArmorPost Its components, Information Security component 121, Account Management component 122, Interface 123 to End-to-End Messaging Infrastructure 101, and Interface 124 to Packet Network 102, are all as described in ArmorPost. Additional functionality, which will become clear in the description of FIG. 3, is provided so that the various types of Client, described below, can acquire message authentication Tokens, and so that AntiSpam Gateways and certain Clients, also described below, can verify them.

Also connected to End-to-End Messaging Infrastructure 101 and Packet Network 102 are one or more Clients with various capabilities. Each Client is a set of computer software applications which enable acquisition of authentication Tokens and their placement in outgoing messages on behalf of an end user, in support of the Messaging Spam Prevention System.

ArmorPost Agent Clients 110 are instances of the ArmorPost Agent from the aforementioned ArmorPost System, and comprise Information Security component 111, Messaging Client 112, Interface 113 to End-to-End Messaging Infrastructure 101, and Interface 114 to Packet Network 102, all as described there. For the purposes of the Messaging Spam Prevention System, the functionality of this Agent is extended to include automatic generation of an authentication Token, and inclusion of the current Token in outgoing messages. Recalling that the ArmorPost Agent can be implemented with either a tight coupling or a loose coupling between Information Security component 111 and Messaging Client 112, inclusion of the current Token in an outgoing message can either occur automatically or manually. The ArmorPost Agent is also extended to include verification of authentication Tokens found in incoming messages.

Standard Client 130 is nothing more than an unmodified Web Browser 131, paired with an unmodified Messaging Client 132. It communicates with other elements via End-to-End Messaging Infrastructure 101 on Interface 133 using standard messaging protocols; Interface 133 is identical to Interface 113. It also communicates with other elements via Packet Network 102 on Interface 134 using standard packet protocols; Interface 134 is substantially identical to Interface 1114. With Web Browser 131, a user can authenticate to Registry 120 via its website by providing the account password established during Registration (see ArmorPost), then request and download a current authentication Token as needed. After thus acquiring a Token, the user can then attach or otherwise include it in an outgoing message using Messaging Client 132. These actions are performed with standard functions of the respective components. This configuration supports the users who are unable to install a complete ArmorPost Agent Client 110. Such inability may stem from a lack of permissions granted to the user by system administrators, or from lack of a suitable ArmorPost Agent implementation for the user's computer system.

Proxy Client 140 supports users who can neither install an ArmorPost Agent nor send and receive messages at all on a particular computer system. The standard Web Browser 141 which is the sole element of Proxy Client 140 allows the user to access Registry 120 via its website by providing the account password established during Registration. Once so authenticated, the website provides the user with functions for composing and sending messages with an authentication Token attached. Proxy Client 140 also communicates with Registry 120 via Packet Network 102 on Interface 144 using standard packet protocols; Interface 144 is substantially identical to Interface 114.

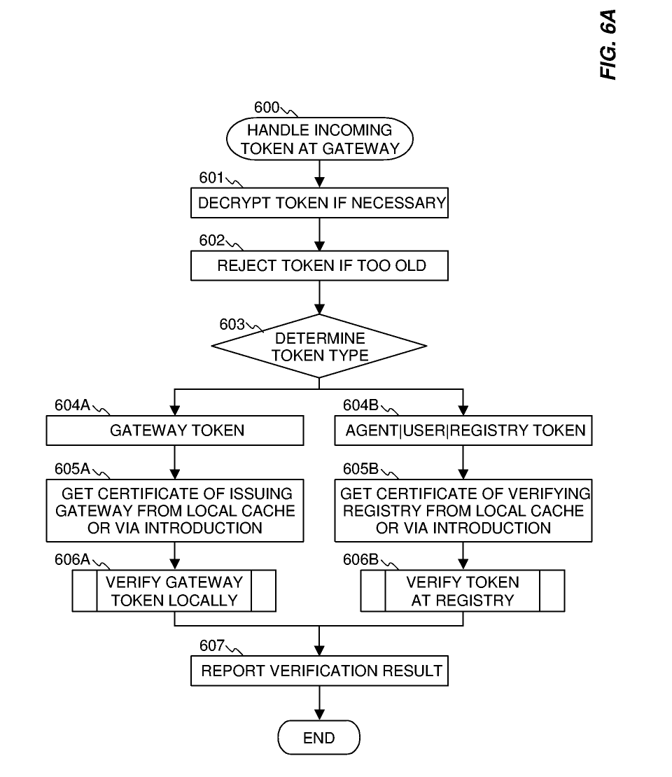

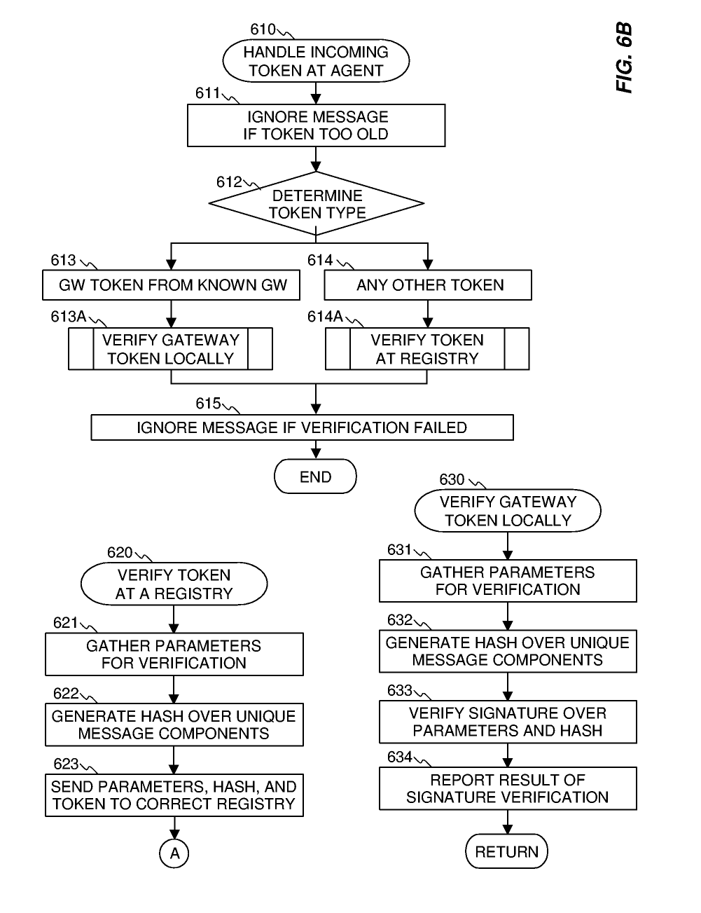

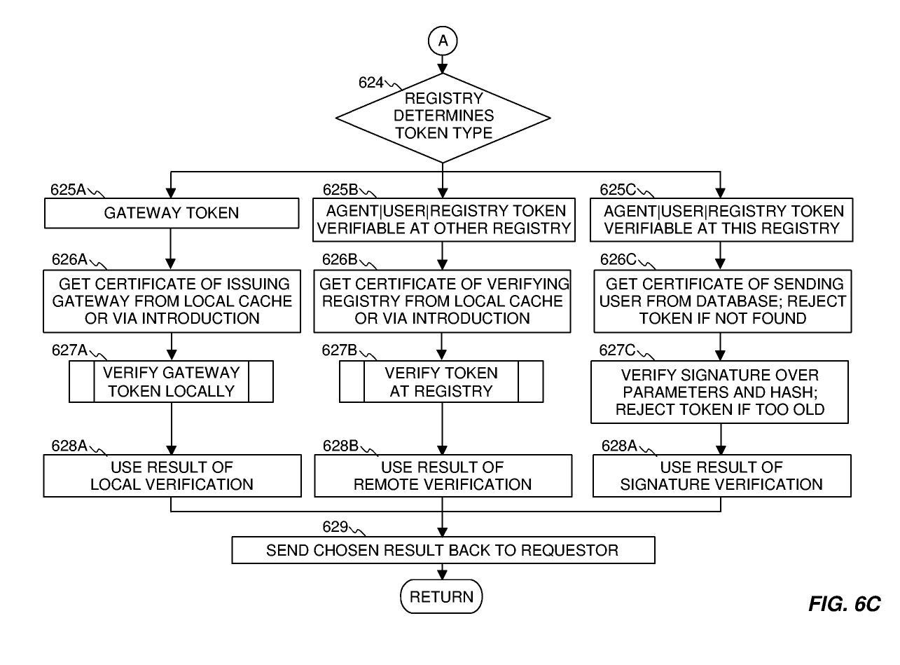

At least one AntiSpam Gateway 150 sits between End-to-End Messaging Infrastructure 101 and one or more Protected Messaging Infrastructures 103. Using Interface 153, an AntiSpam Gateway 150 receives messages directed to users of a Protected Messaging Infrastructure 103 from End-to-End Messaging Infrastructure 101, then decides whether the message should be relayed into Protected Messaging Infrastructure 103 via Interface 155. Using Interface 155, an AntiSpam Gateway 150 also receives messages sent by users of a Protected Messaging Infrastructure 103 to other users of End-to-End Messaging Infrastructure 101. Note that Interfaces 153 and 155 are functionally equivalent both to one another and to Interface 123, using the same standard message transfer protocols. For incoming messages, Information Security component 151 of AntiSpam Gateway 150 makes its decision by verifying any authentication Token in the message, using a procedure which is described in the context of FIG. 6 below. That procedure uses communication between AntiSpam Gateway 150 and one or more Registries 120; Interface 154 to Packet Network 102 provides the corresponding connectivity. Note that Interface 154 is functionally equivalent to Interface 124. For outgoing messages, Information Security component 151 of AntiSpam Gateway 150 authenticates the senders of those messages, then adds an authentication Token to each message. In both directions, if the authentication decision is affirmative, Messaging Relay component 152 of AntiSpam Gateway 150 effects the relaying of the message. In a preferred embodiment, an implementation of Information Security component 151 is derived from an implementation of Information Security component 121 of the ArmorPost Trusted Courier 120, and Messaging Relay component 152 is any of several commonly available message-transfer-agent (MTA) application programs, such as the popular sendmail.

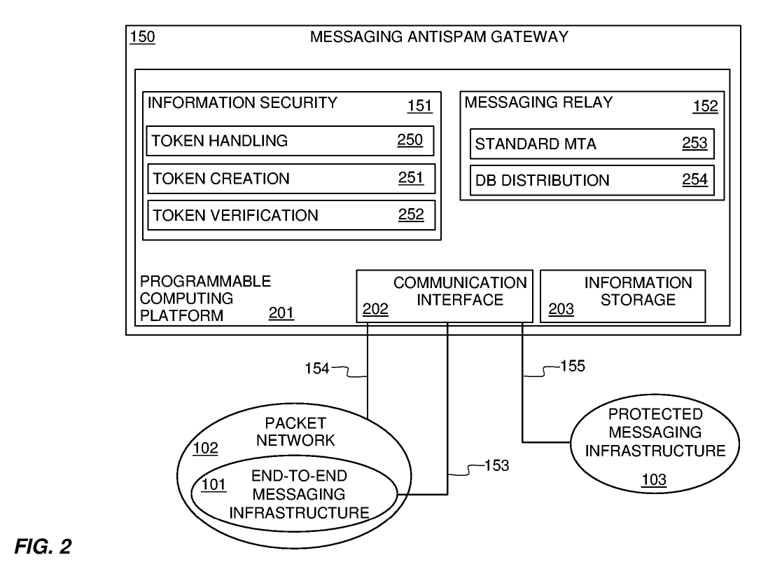

AntiSpam Gateways 150 and User Registries 120 are related to one another in the sense that the users of a particular Protected Messaging Infrastructure 103, served by one or more particular Messaging AntiSpam Gateways 150, are registered in and provided account management services by a particular User Registry 120. More detail on this relationship is provided in the descriptions of FIG. 2 and FIG. 3.

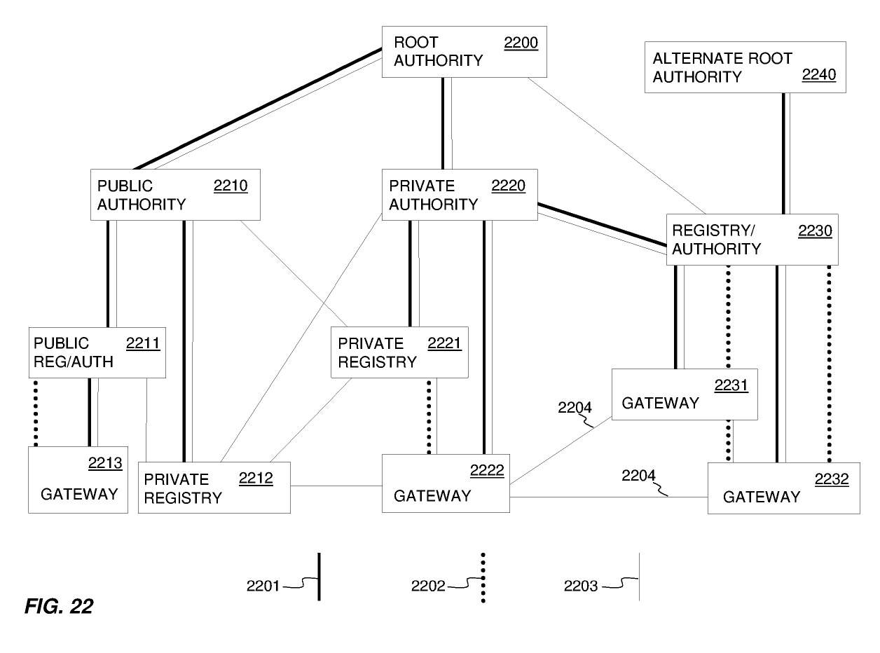

Messaging Spam Prevention System 100 also includes one or more Network Authorities 160, which control distribution of cryptographic key certificates. Each Network Authority 160 is responsible for certifying Registries 120 and Gateways 150 within its scope; more detail on this concept is provided in the description of FIG. 22. A Network Authority 160 contains an Information Security component 161 whose primary function is to perform the certifications cited above. Secondary functions include providing authenticated, encrypted communication between itself and entities with which it communicates: Registries 120, Gateways 150, and other Authorities 160. Network Authority 160 also contains an Introduction Management component 162. This component is responsible for distributing the encryption key certificates it controls to authenticated requestors, and obtaining certificates from other Network Authorities on behalf of the Registries and Gateways it serves. To support the communication needs of those two components, Network Authority 160 also features an Interface 164 to Packet Network 102; this interface is substantially equivalent to Interfaces 124 and 154.

Further detail on Messaging AntiSpam Gateway 150 is found in FIG. 2. In a preferred embodiment, an implementation of Information Security component 151 is derived from an implementation of Information Security component 121 of the ArmorPost Trusted Courier 120, due to similarities in their performance requirements and the fact that both handle the cryptographic algorithms associated with creating and verifying authentication Tokens. However, the differences are significant. First, note that Messaging AntiSpam Gateway 150 contains no Account Management module similar to the one in the Trusted Courier and Registry 120. Instead it contains a Database Distribution module 254, which holds a subset of user account information from the corresponding User Registry 120, along with certain messages that may be queued within the Gateway according to the procedures described later. This is a very important attribute due to the possible placement of multiple AntiSpam Gateways 150 at the boundaries of a Protected Messaging Infrastructure 103, in support of a variety of network topologies. Each such AntiSpam Gateway 150 is generally responsive to the entire subscriber base of Protected Messaging Infrastructure 103, and multiple such AntiSpam Gateways would generally not be able to provide unified account management functionality for users. Therefore, a User Registry 120 does so, distributing only the information needed by AntiSpam Gateways 150, and retrieving from Gateways 150 the information stored there as requested by a user. Second, AntiSpam Gateway 150 does not have any modules for handling Background signalling, since those messages move directly between a Registry 120 and an ArmorPost Agent 110, bypassing both Protected Messaging Infrastructure 103 and AntiSpam Gateway 150.

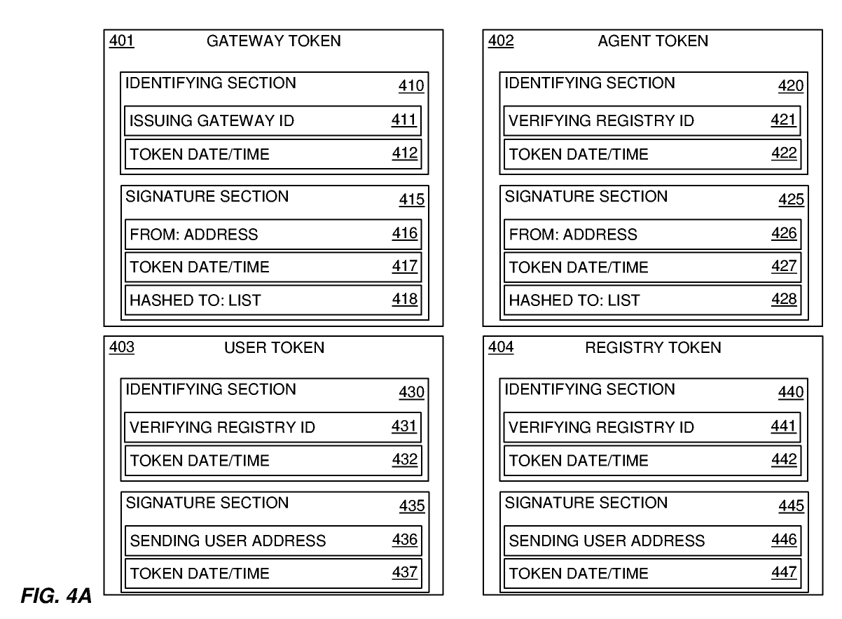

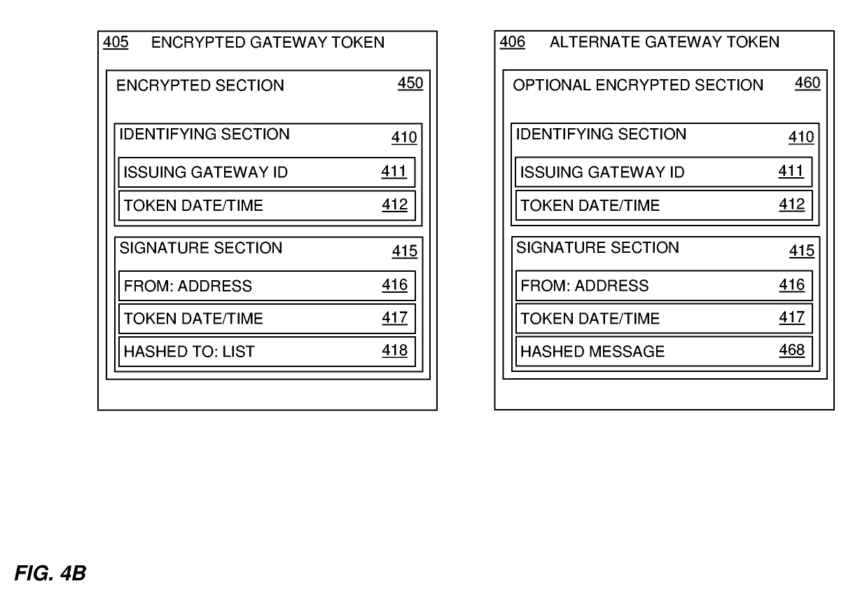

Within Information Security component 151, Token Handling module 250 is responsible for detecting authentication Tokens in incoming messages, and placing authentication Tokens in outgoing messages, according to the various conventions for Token inclusion described in the context of FIG. 4. Token Creation module 251 is responsible for generating Tokens as needed for outgoing messages, according to the procedures described in the context of FIG. 4. If a Token is present in an incoming message, Token Verification module 252 is responsible for establishing its authenticity according to the procedures described in the context of FIG. 6.

If an authentication Token is verified successfully, the message in which it arrived can be relayed to its recipient or recipients in Protected Messaging Infrastructure 103. If an authentication Token is created successfully, the message into which it is placed can be relayed to its recipient or recipients in End-to-End Messaging Infrastructure 101. Messaging Relay component 152 is responsible for this activity. In a preferred embodiment the main relaying function may be implemented as any of several commonly available message-transfer-agent (MTA) application programs, such as the popular sendmail. This embodiment is shown in FIG. 2 as Standard MTA module 253. Messaging Relay component 152 also includes a Database Distribution module 254, which is responsible for managing certain user data in cooperation with a corresponding User Registry 120. Data received from Registry 120 would generally include only that which is useful in identifying users of Protected Messaging Infrastructure 103; other data may be distributed as described in subsequent procedures. Data held within Gateway 150 and sent to Registry 120 on request would generally include only headers of messages queued according to procedures described later in this specification. Detailed protocols for exchanging this information are omitted here, as they are well known to those skilled in the art and implemented using common standards.

In a preferred embodiment, AntiSpam Gateway 150 is designed to operate as a network element that permanently serves a particular Protected Messaging Infrastructure 103. Its components are therefore housed in a specific Programmable Computing Platform 201. Platform 201 is chosen to provide highly reliable operation and flexible scalability. Candidates satisfying such requirements are well-known to those skilled in the art, and are available from major vendors such as SUN, HP, Motorola, Intel, and many others. Platform 201 also includes a Communication Interface 202 for connecting to a network. This is typically implemented using two or more standard Ethernet links, which are well known to those skilled in the art. Additionally, Platform 201 provides an Information Storage medium 203 for holding data required by components Information Security 151 and Messaging Relay 152, including configuration data such as message routing and Token-verification routing information, and user data distributed to Database Distribution module 254. This is typically implemented as a magnetic “hard disk” module. Platform 201 and its subsystems are preferably implemented using standard components that are commonly available and well known to those skilled in the art.

In an alternate embodiment, AntiSpam Gateway 150 may be implemented adjacent to or integrated with an ArmorPost Agent Client 110 in an end user's environment, such that Protected Messaging Infrastructure 103 is not a sizable network but instead a single mailbox.

Detail of a User Registry 120 can be found in FIG. 3. Structurally, it is substantially similar to a Trusted Courier 120 from ArmorPost, with the addition of two modules specific to the needs of Messaging Spam Prevention System 100. Specifically, Account Management component 122 is extended by Database Distribution module 323 and, optionally, Webmail Proxy module 324. For descriptions of the rest of the components and modules in User Registry 120, refer to ArmorPost and its description of Trusted Courier 120.

Database Distribution module 323 is responsible for providing relevant excerpts of the User Database 322 to those AntiSpam Gateways 150 which serve the same network as Registry 120. This module is also responsible for retrieving data stored in those same Gateways 150, such as message headers, when requested by a user via External Website module 321. Registry 120's Database Distribution module 323 can be considered the master of counterpart Database Distribution modules 254 in one or more AntiSpam Gateways 150.

While the foregoing texts describes a Registry 120 and multiple corresponding Gateways 150 as distinct elements, an alternate embodiment may combine one of each into a single computing platform. This embodiment would be suitable for relatively small and localized instances of Protected Messaging Infrastructure 103. Its structure is readily evident to those skilled in the art by combining the modules and components shown in FIGS. 2 and 3, and so is not shown separately.

User Registry 120 may optionally include a Webmail Proxy module 324 to provide support for Proxy Clients 140. Users of webmail services, who have completed at least enough of Registration to establish an account, may log in at Registry 120 via External Website 321 of Account Management component 122 and use Webmail Proxy 324 to send and receive authenticated messages. Webmail Proxy 324 wraps each user's remote webmail interface, collecting the user's incoming messages, verifying authentication Tokens before presenting them, and generating authentication Tokens on outgoing messages from the user. Webmail Proxy 324 may also provide proxy access to standard messaging servers by wrapping the SMTP, POP3, and IMAP protocols on the user's behalf.

FIG. 4 depicts several forms the authentication Token may take. Each form contains an Identifying Section, which provides information needed to verify the Token and to judge its timeliness with respect to the message carrying it. Each form also contains a Signature Section, which contains a cryptographic signature over certain identifying data. This signature ensures the Token contents cannot be tampered without being detected, and upon verification proves that the Token was issued by the identified issuer; depending on the Token form, verification of the signature may also prove that the Token is associated with the message carrying it. The following paragraphs describe each Token form in detail.

Gateway Token 401 is placed in an outgoing message by a Messaging AntiSpam Gateway 150 or a Registry 120's Webmail Proxy 324, and in outgoing VoIP signalling by a Multimedia AntiSpam Gateway 1950. Gateway Token 401 contains an Identifying Section 410, which carries an Issuing Gateway Identifier 411 and a Token Date/Time 412. Issuing Gateway Identifier 411 is preferably the domain name associated with the AntiSpam Gateway 150/1950 or Registry 120 that created the Gateway Token 401, although it may take any form that is effective in identifying the Token's creator. Token Date/Time 412 notes the exact time and date at which the particular Gateway Token 401 was created. Gateway Token 401 also contains a Signature Section 415, which contains a cryptographic digital signature certifying the authenticity of both the message to which the Token is attached and the AntiSpam Gateway 150/1950 or Registry 120/Webmail Proxy 324 that issued the Gateway Token 401. The cryptographic signature occupying Signature Section 415 may be generated using any of numerous suitable algorithms well-known to those skilled in the art. In a preferred embodiment, the popular RSA algorithm for asymmetric encryption and message authentication may be used, with the relevant key pair belonging to the AntiSpam Gateway 150/1950 or Registry 120/Webmail Proxy 324 that issues the particular Gateway Token 401. The data items used as input when creating the cryptographic signature are shown as components of Signature Section 415, and are chosen to bind the Token to both the message and its sender. From: Address 416 is the messaging or multimedia address used by the sender of the message/signal in which Gateway Token 401 is placed; its presence indicates that AntiSpam Gateway 150/1950 or Registry 120/Webmail Proxy 324 has authenticated the message sender/caller and certifies the From: Address 416 as valid. Token Date/Time 417 is substantially identical to Token Date/Time 412 in Unencrypted Section 410; its presence links Unencrypted Section 410 to Signature Section 415. Finally, Hashed To: List 418 represents the primary recipients of the message or signal to which the Token is attached; it links Signature Section 415 and Gateway Token 401 itself to the message. A cryptographic (one-way) hash function is applied to the list of To: addresses in the message to create this data element, thereby normalizing the size of the signed input and providing privacy of correspondents in certain Token Verification scenarios (described later). Note that an alternate embodiment, shown as Alternate Gateway Token 460, may use the entire message body as input to this hash function, producing Hashed Message field 468 instead of Hashed To: List 418, in order to bind the Token to the message or signal more strongly. This reduces the potential value in capturing and replaying a Token further, although at the expense of additional processing to hash the entire message. A balance may be struck as well, using some lesser portion of the message body in the hash.

Agent Token 402 is generated and placed in an outgoing message by an ArmorPost Agent Client 110. This Token form is structurally similar to the previous one, but with two significant differences. First, its Identifying Section 420 contains Verifying Registry Identifier 421. This element names the Registry 120 at which the sending user is registered. Only this Registry 120 will be able to verify Agent Token 402 because while Registries 120 and AntiSpam Gateways 150 may learn one another's public keys through the Introduction protocol described later, as noted in ArmorPost the keys used by an Agent 110 are known only to its Courier 120, which translates in the present invention to the keys used by an ArmorPost Agent Client 110 being known only to its Registry 120. As with Issuing Gateway Identifier 411, Verifying Registry Identifier 421 is preferably the domain name associated with the appropriate Registry 120, although it may take any form that is effective in identifying the Token's verifier. Second, the cryptographic signature in Signature Section 425 of Agent Token 402 is produced using the key pair belonging to ArmorPost Agent Client 110, which can only be verified by the Registry 120 at which the sending user is registered due to the design of key distribution in ArmorPost. The remaining elements of Agent Token 402 are the same as their counterparts in Gateway Token 401. Token Date/Time 422 is substantially identical in usage and form to Token Date/Time 412, while From: Address 426, Token Date/Time 427, and Hashed To: List 428 are used as input to create Signature Section 425 in the same way that From: Address 416, Token Date/Time 417, and Hashed To: List 418 are used as input to create Signature Section 415. Agent Token 402 is appropriate for applications in which Agent Client 110 is a tightly-coupled implementation.

User Token 403 is generated by an ArmorPost Agent Client 110, and placed in a file so that the user can attach it to an outgoing message. User Token 402 is appropriate for applications in which Agent Client 110 is a loosely-coupled implementation. Its Identifying Section 430 contains a Verifying Registry Identifier 431 and Token Date/Time 432 which are identical to the fields of the same name in Agent Token 402. However, though Token Date/Time 432 represents the creation time of User Token 403, this time is independent of any message timestamp. User Token 403 can have been created recently with respect to a message, but Token Date/Time 432 is unlikely to match exactly with the timestamp of the message to which it is attached. At best, if an ArmorPost Agent Client 110 is configured to generate a new one every 5-10 minutes, User Token 403 will be no older than 5-10 minutes before the message to which it is attached. The Signature Section 435 of User Token 403 contains a cryptographic signature generated from the key pair belonging to the ArmorPost Agent Client 110, just as in Signature Section 425 of Agent Token 402. However, the data elements used as input in forming the cryptographic signature in Signature Section 435 are different. The first difference is subtle: Sending User Address 436 is a valid messaging address associated with the user, but it is not necessarily the same address as appears in any particular message to which User Token 403 is attached. This occurs because the user may have multiple valid addresses, and when sending a message from any specific one of them may attach a User Token 403 that is formed from another specific one of them. Since ArmorPost Agent Client 110 is loosely-coupled in this scenario, it is unable to attach the User Token 403 automatically or generate User Token 403 in conjunction with sending a message. Therefore, Sending User Address 436 may not match the message From: address. For the same reason, Token Date/Time 437 does not match the message timestamp, though it does match Token Date/Time 432. The second difference, which is also driven by not being bound to a message, is the absence of a Hashed To: List in Signature Section 435. Thus the User Token 403 certifies only that the Token itself was created by a valid ArmorPost Agent Client 110. It is possible to forge this Token by capturing and replaying it within the timeframe of the generation period, so in a preferred embodiment this window is configured to be as short as possible. New User Tokens 403 may be generated almost continuously if the user's computer is idle, or less frequently if it is actively in use.

Registry Token 404 is generated by a Registry 120 on behalf of a user with a Standard Client 130—that is, one who cannot utilize an ArmorPost Agent Client 110 or a Proxy Client 140—who is also not protected by an AntiSpam Gateway 150. Such a user has no mechanism that generates Tokens autonomously. Therefore, the user may login at the correct Registry 120 and have it generate a Registry Token 404. The user may then download this Token and manually place it in each outgoing message. Structurally, Registry Token 404 is substantially identical to User Token 403, lacking in particular the ties to a specific message that Gateway Token 401 and Agent Token 402 offer, and requiring in particular that verification be performed at the Registry 120. Again, however, subtle differences appear. First, because it is a time-consuming action to acquire a Registry Token 404, a user is likely to do so only occasionally, and reuse the Token in many messages over a substantial span of time. Therefore, Token Date/Time 442 and the matching Token Date/Time 447 will generally by separated from the timestamp of a particular message by a long time. An embodiment may balance the need for user action against the risk of exposure to the user by allowing Registry Tokens 404 to be valid as long as 6-12 months. Another embodiment may allow users to choose the valid lifetime of their Registry Tokens 404 according to their own judgment of and sensitivity to the action vs. risk balance. Second, the cryptographic signature in Signature Section 445 of Registry Token 404 is generated and verified using the key pair assigned by Registry 120 for communication with a particular user. That is, the Registry Token 404 is signed by Registry 120 with a per-user key created during ArmorPost Registration, not by a key generated by an Agent 110 within the user's own environment. Thus Registry Token 404 certifies that the Token itself was created by a valid Registry 120 on behalf of a valid user, but it does not link in any way to the message carrying it or to the user's environment. Further, because its valid lifetime is significantly longer than that of a User Token 403, the potential for capture and replay is significantly higher. In a preferred embodiment, all commercially reasonable effort should be made to provide systems that support either Gateway Tokens 401 or Agent Tokens 402, and transition users off systems that only support either User Tokens 403 or Registry Tokens 404.

Encrypted Gateway Token 405 is a variation on Gateway Token 401, in which the entire contents of the Token are encrypted but otherwise identical in both structure and usage to those of Gateway Token 401. Using asymmetric encryption, such as the public-key technology used throughout this disclosure, only the particular AntiSpam Gateway 150/1950 receiving the particular Token 405 (in a message or multimedia signalling unit) would be able to decipher Encrypted Section 450 and verify Signature Section 415. Other encryption techniques may be used as well; for example, a shared secret symmetric encryption approach might permit a single Encrypted Gateway Token 405 to be received and verified by any number of AntiSpam Gateways 150/1950, User Registries 120, and ArmorPost Agent Clients 110.

Finally, Alternate Gateway Token 406 offers yet another variation on this theme. It provides the option for a sending AntiSpam Gateway 150/1950 to choose encrypted or clear contents through Optional Encrypted Section 460. If encrypted, Identifying Section 410 will be unrecognizable, so a verifying entity will first attempt to decrypt the Token 406 before attempting to verify it. This token form also uses a hash of the entire message/signalling unit, Hashed Message 468, instead of hashing only the To: list.

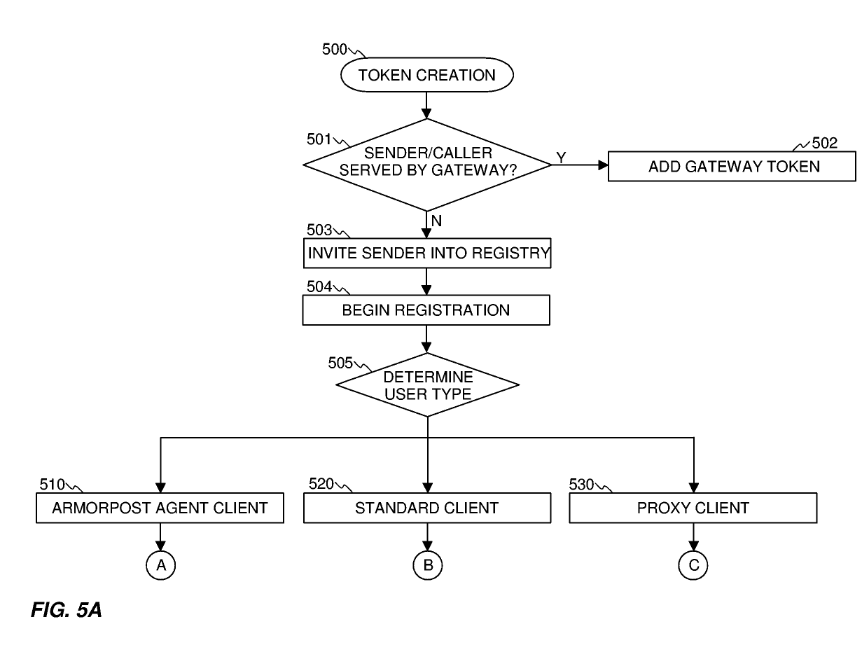

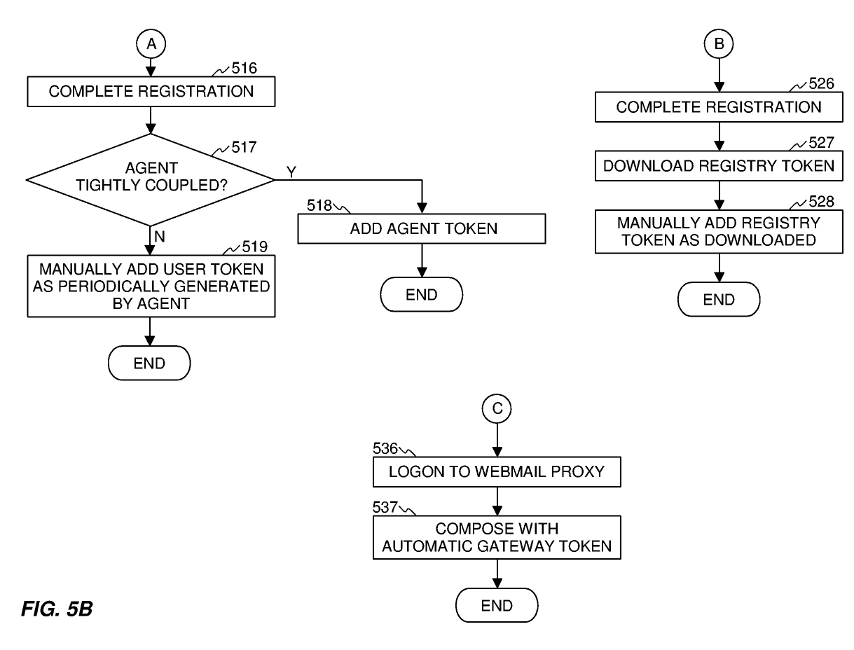

In FIGS. 5 and 6 we find the methods of Token processing which operate in both the Messaging Spam Prevention System 100 and the Multimedia Spam Prevention System 1900. FIG. 5 covers the first, that of creating authentication Tokens and placing them in outgoing messages/signalling units on behalf of message senders/callers. FIG. 6 covers the second, that of detecting and verifying an authentication Token in a message/signalling unit that arrives at an AntiSpam Gateway 150/1950 or ArmorPost Agent Client 110.

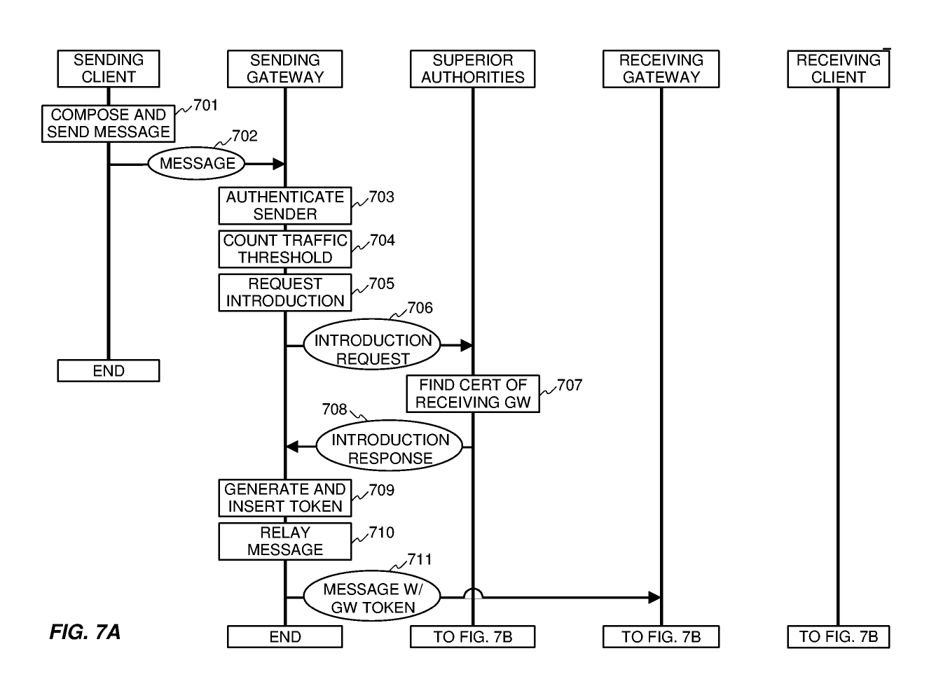

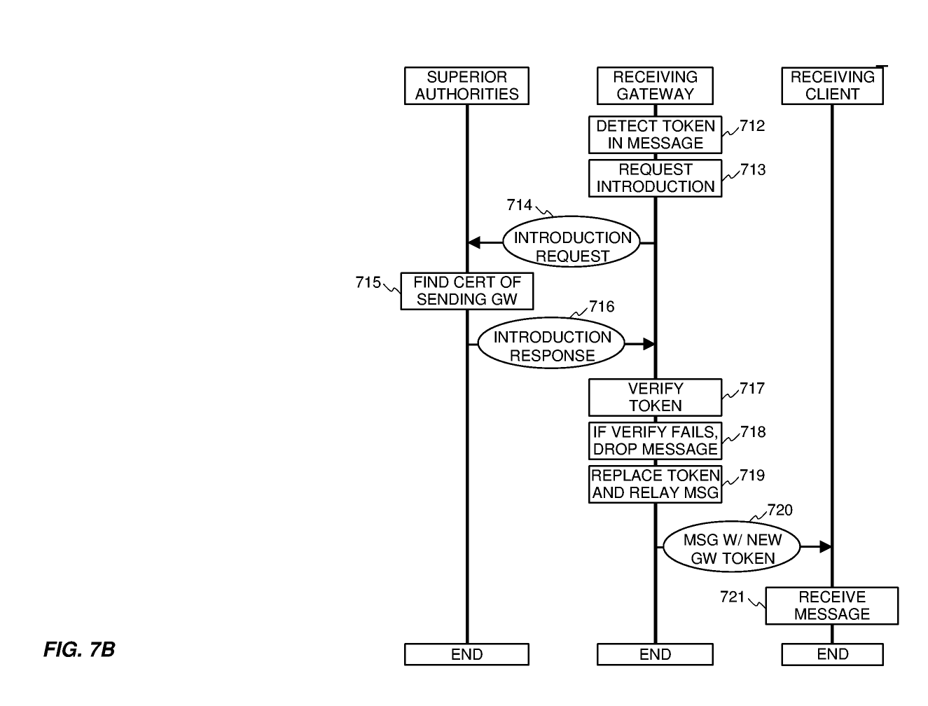

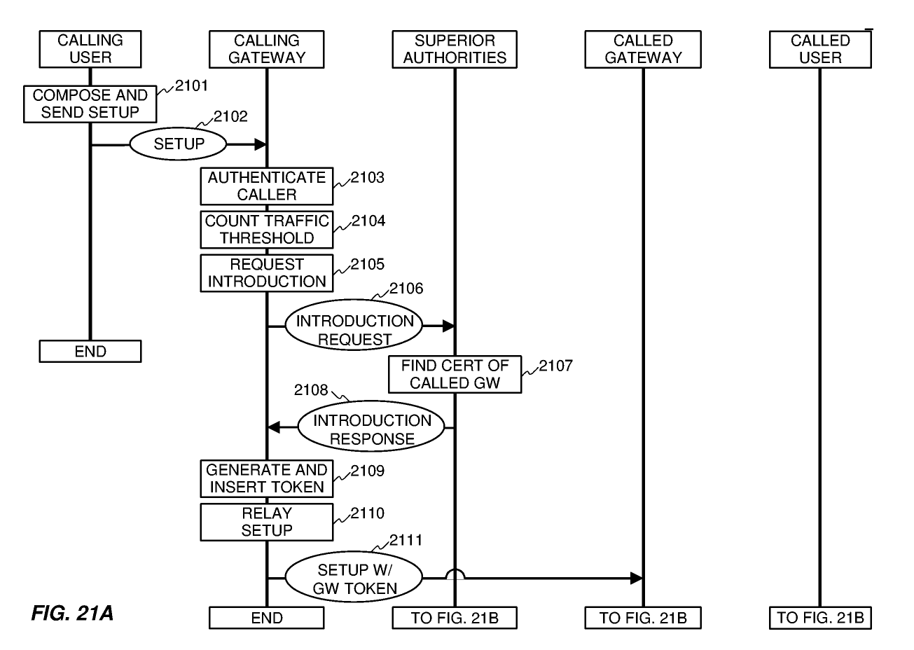

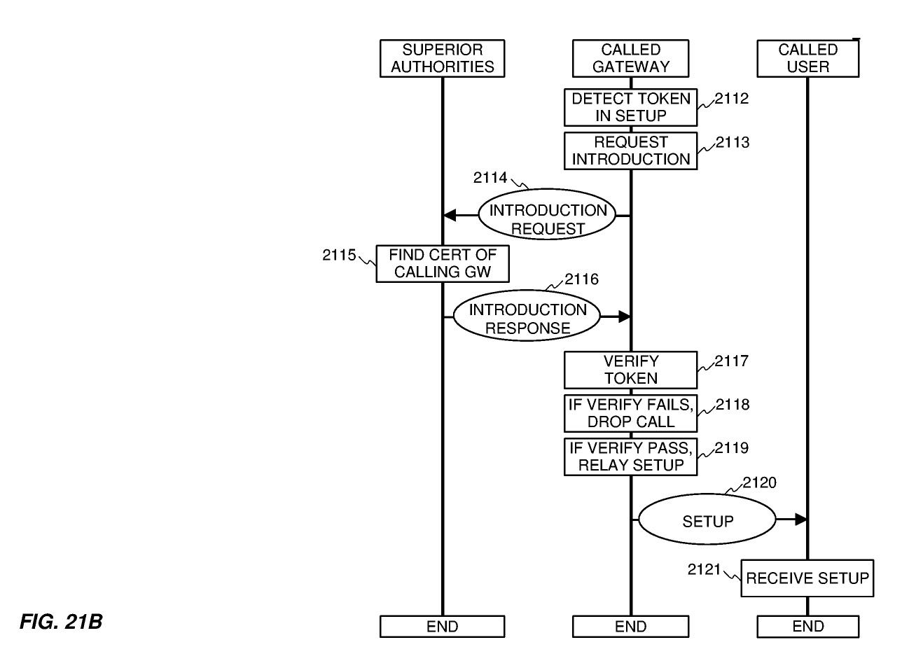

The Token Creation process 500 in FIG. 5 begins at step 501 with a determination whether the sender or caller is served by an AntiSpam Gateway 150/1950. If so, each time a user of Protected Messaging Infrastructure 103 or Protected Multimedia Signalling Infrastructure 1903 attempts to send a message or place a call, the message/signalling unit passes through AntiSpam Gateway 150/1950, which in turn generates a Gateway Token and, as shown in step 502, adds it to the message/signalling unit as a header. The generated Gateway Token may take the form of either Gateway Token 401, Encrypted Gateway Token 405, or Alternate Gateway Token 406, depending on configuration deployed at the sending AntiSpam Gateway 150/1950 and on whether an appropriate encryption certificate can be acquired for a receiving AntiSpam Gateway 150/1950 (see FIGS. 7 and 21 for detail on certificate acquisition, known here as Introduction). As described above, the Gateway Token contains in particular an identifier naming AntiSpam Gateway 150/1950, and a cryptographic signature linking the sender/caller, the message/signalling unit, and the Gateway itself. Generation of the signature and assembly of the Token as described takes place using conventional means well known to those skilled in the art. No action is required on the user's part, so the method may end here, although for messaging users with complex needs the remaining branches may also be executed.

If the message sender is not served by an AntiSpam Gateway 150, the method continues at step 503 with an Invitation to join a Registry 120 as described in ArmorPost in the context of its FIG. 4. This sets the stage for a message sender to begin generating or acquiring authentication Tokens for outgoing messages. In step 504, Registration begins, processing as shown in FIG. 5 of ArmorPost through step 507. At that point, the user has created an account in Registry 120, but not installed an ArmorPost Agent. Step 505 determines the capabilities of the registering user with respect to the environment in which that user operates. In the preferred embodiment this determination is integrated with the Registration Form processed at steps 505 and 506 in FIG. 5 of ArmorPost. Depending on the capabilities so determined, the process branches.

Branch 510 is taken by users who are able to complete installation of an ArmorPost Agent, thereby becoming an ArmorPost Agent Client 110. Step 516 completes the Registration as described in ArmorPost FIG. 5 steps 508-522. At step 517, a determination is made based on an implementation attribute of the ArmorPost Agent so established. If the ArmorPost Agent is tightly coupled internally as described in ArmorPost, such that it can automatically act upon incoming and outgoing messages, at step 518 it generates an Agent Token 402 for each outgoing message and add it to the message as a header. As described above, Agent Token 402 contains in particular an identifier naming Registry 120, and a cryptographic signature linking the sender, the message, and the Registry. Generation of the signature and assembly of the Token as described takes place using conventional means well known to those skilled in the art. No additional action is required on the user's part, so the method may end here. On the other hand, if the ArmorPost Agent that results from Registration is loosely coupled internally, such that it can act autonomously but cannot act automatically on incoming and outgoing messages, it will, as shown in step 519, periodically generate a User Token 403 and make it available for placement in outgoing messages. Again, generation of the signature and assembly of the Token as described takes place using conventional means well known to those skilled in the art. Since automatic inclusion is not possible in this case, the User Token 403 would be included in the message manually by the user prior to sending. This manual inclusion may take the form of a header or an additional block of text in the message body, and may require specific user action for each message or be at least partly automatic, depending on the capabilities of the user's Messaging Client 112. Many such application programs are available to users, and the possible mechanisms are various, as is well known to those skilled in the art.

Branch 520 is taken by users who cannot complete installation of an ArmorPost Agent, whether due to lack of privilege or for any other reason, and who therefore operate a Standard Client 130. It may also be taken by users who have completed installation of an ArmorPost Agent, but who for some reason are operating without it, such as when borrowing a different computer, and therefore choose to operate a Standard Client 130. At Step 526, the ArmorPost Registration concludes with an active account but without downloading and installing an ArmorPost Agent in the user's current environment. To acquire an authentication Token, at step 527 the user logs on to the website of Registry 120, requests that it generate a current Registry Token 404, and downloads the resulting Token either as a file or as text copied from the webpage display. At the same time, the issuing Registry 120 records the date and time of issuance so that previously-issued Registry Tokens 404 may be invalidated. As for the other Token types, generation of the signature and assembly of the Token as described take place using conventional means well known to those skilled in the art. The user then at step 528 adds the Registry Token 404 to any outgoing messages that are sent during the Token's validity period. As with step 519, this manual inclusion may take the form of a header or an additional block of text in the message body, and may require specific user action for each message or be at least partly automatic, depending on the capabilities of the user's Messaging Client 112. Many such application programs are available to users, and the possible mechanisms are various, as is well known to those skilled in the art.

Whether a user completes ArmorPost Registration via branch 510 or 520, under certain circumstances the user's normal (Agent or Standard) Client environment is not available, such as when away from the computer system on which it is installed. Further, for certain messaging environments, particularly web-based email, it is desirable to provide a web-based interface that a registered user may access from any computer. Branch 530 can be taken by a user in this situation, by using a Proxy Client 140 at step 536 to log on to the website of Registry 120 and access its Webmail Proxy 324. Once so logged in and thereby authenticated, the user may at step 537 compose a message, to which Webmail Proxy 324 attaches a Gateway Token 401 as an additional block of text in the message body. Webmail Proxy 324 then sends the message via the user's designated mail service, acting for and as the user in interactions with said mail service.

In FIG. 6, the various methods of Token Verification are described. A message carrying an authentication Token may arrive at either an AntiSpam Gateway 150/1950 or at an ArmorPost Agent Client 110; different procedures are followed at the two elements.

A Messaging AntiSpam Gateway 150, a Multimedia AntiSpam Gateway 1950, or a Webmail Proxy 324 receiving a message carrying a Token performs Procedure 600, which begins at step 601 by decrypting the Token, if necessary, using the receiving Gateway's own certificate or the system's shared secret as described above. Next, for all Token types, the Gateway at Step 602 compares the Token Date/Time field in the corresponding Identifying Section with the message or signalling unit date (which normally includes both date and time) as well as the current date and time. If the Token is older than either the message or the current time by a significant duration, which depends upon the Token type as described above in the context of FIG. 4, the message/call may be discarded or rejected. Continuing to step 603, the incoming Token is examined to determine its type; subsequent processing is specific to each type of authentication Token. Branch 604a is taken if it is a Gateway Token 401, Encrypted Gateway Token 405 (which at this point is substantially identical to Gateway Token 401), or Alternate Gateway Token 406. In that case, at step 605a the receiving AntiSpam Gateway 150/1950 or Registry 120/Webmail Proxy 324 uses the Issuing Gateway Identifier 411 to locate a certificate for the sending AntiSpam Gateway 150/1950 or Registry 120/Webmail Proxy 324. If none can be found locally, the receiving Gateway or Registry has not been Introduced to the sending Gateway or Registry, so an Introduction is requested from the Network Authority 160 that is superior to the receiving AntiSpam Gateway 150/1950 or Webmail Proxy 324. The Introduction process follows the principle of providing the certificate of one node, for signature validation by another, via the chain of Network Authorities trusted by the node requiring the certificate. For details of the Authority topology and Introduction protocol, refer to the description of FIG. 22. Suffice to say here that in a preferred embodiment, a series of special DNS queries directed through the tree of Network Authorities is used to retrieve the certificate, followed by a validation of the retrieved certificate by verifying its Certificate Authority signatures in the chain of trust up to the Root Network Authority before using the certificate. With a certificate now available for the sending Gateway 150/1950 or Registry 120/Webmail Proxy 324, the receiving Gateway 150/1950 or Webmail Proxy 324 may now, in step 606a, verify the Gateway Token. To do so, Procedure 630 is used. Upon its completion, the result of the verification is used at step 607 to decide whether the message should be relayed or dropped.

An ArmorPost Agent Client 110 receiving a message carrying a Token performs Procedure 610, which for all Token types begins at step 611 by comparing the Token Date/Time field in the corresponding Identifying Section with the message date (which normally includes both date and time) as well as the current date and time. If the Token is older than either the message or the current time by a significant duration, which depends upon the Token type as described above in the context of FIG. 4, the message may be discarded. Continuing to step 612, the incoming Token is examined to determine its type; subsequent processing is specific to each type of authentication Token. Step 613 is executed if the incoming Token is a Gateway Token 401/406, and the Issuing Gateway Identifier 411 names an AntiSpam Gateway 150 or Webmail Proxy 324 that is known to the ArmorPost Agent Client 110. In this case, at step 613a that Gateway or Registry's certificate is passed to Procedure 630 to verify the incoming Token locally. Step 614 is executed if the incoming Token is a Gateway Token 401/406 and its Issuing Gateway Identifier 411 names an AntiSpam Gateway 150 or Webmail Proxy 324 that is not known, or if the incoming Token is of any other type. In this case, a remote Token Verification is needed, so Procedure 620 is used in step 614a to pass the Token and relevant portions of the message to ArmorPost Agent Client 110's Registry 120 for verification. Whether step 613 or step 614 was executed, at step 615 the result of the verification is used to decide whether the message should be presented or discarded.

Procedure 620 verifies any type of Token by querying a superior or specified Registry 120. It may be performed on behalf of any system element that cannot verify a particular Token, including an ArmorPost Agent Client 110, an AntiSpam Gateway 150, a Registry 120, or a Webmail Proxy 324. The procedure begins at step 621, in which the Date: value, From: address, and To: list (or in the alternate embodiment, the partial or full message body) are extracted from the message carrying the Token being verified. Step 622 transforms the To: list or message body using a one-way cryptographic hash function so that the verification request being sent to a remote Registry 120 does not unnecessarily reveal the message to a third party. Note that in some situations Procedure 620 is used recursively. In such an event, step 621 of the inner Procedure 620 extracts the message Date: and From: address from the query message received as part of the outer Procedure 620, while the inner step 622 extracts the To: list or message body already hashed from that received query. At step 623, then, the verification inputs acquired in the two previous steps, along with the Token itself, are sent in a query message to the appropriate Registry 120. If Procedure 620 is used in the context of Procedure 610, then that Registry 120 is the one at which the requesting ArmorPost Agent Client 110 is registered. If Procedure 620 is being used in the context of Procedure 600, or recursively from Procedure 620, then the appropriate Registry 120 is the one named in the Verifying Registry Identifier field of the current Token.

Upon arrival of the query message at the appropriate Registry 120, that Registry 120 at step 624 examines the received Token and determines its type, which governs the path taken by subsequent processing. Branch 625a is taken if the Token is a Gateway Token. At step 626a, a certificate for the AntiSpam Gateway 150 named in the Issuing Gateway Identifier 411 field of Gateway Token 401/406 is acquired. If the current Registry 120 has been introduced to that Gateway 150 already, the certificate may be in a local cache; otherwise, an Introduction is requested from this Registry 120's superior Authority 160, which if necessary requests it in turn up the hierarchy to the Root Authority. Once the Introduction is complete, step 627a uses the Issuing Gateway 150's certificate to verify the Gateway Token 401/406 by executing Procedure 630, described below. The result of that procedure is reported as the result of this one at step 628a.

Branch 625b is taken for other types of Token that are verified at another Registry 120. That is, if the Token being verified is an Agent Token 402, User Token 403, or Registry Token 404, and the Verifying Registry Identifier field names a different Registry 120 than the current one, this branch is chosen. The first step, 626b, is to locate a certificate for the other Registry 120. If the two Registries 120 have already been Introduced, this certificate may be available in a local cache; if not the current Registry 120 requests the Introduction from its superior Registry 120, as before iterating the request through the hierarchy to the Root Registry if necessary. Once the Introduction is complete, step 627b recurses on Procedure 620 to request Token verification from the remote Registry 120. Step 628b reports the result of the inner Procedure 620 as the result of the current, outer, Procedure 620.

Branch 625c is taken for any Agent, User, or Registry Token verifiable at the current Registry 120; that is, if the Verifying Registry Identifier field names this Registry. In that case, the certificate of the user for whom the Token was created, as identified by the From: address in the verification request, should be available in the local user database at step 626c; if not, the Token is rejected. In step 627c, the Token Date/Time value from the Token being verified is compared against the current date and time. If the Token is too old, it is rejected. If the Token is a Registry Token 404, the Token Date/Time 442 is also compared against the date and time at which the last Registry Token 404 was issued by Registry 120 back in step 527 of FIG. 5. If the Token is older than the most recently issued Token, it is rejected. Note that in both of these date comparisons, some number of extra days' leeway may be granted to allow for delays in message delivery. This extra lifetime may be set administratively by the Registry 120, or the user may be allowed to set it. Assuming the date checks pass, the cryptographic signature in the Token's Signature Section is verified using the input data in the verification request, the user's certificate located in step 626c, and the Token itself. The specific arrangement of data provided to the verification algorithm is as described in the context of FIG. 4, which depicts the contents of each Token type. The specific algorithm used for signature verification may vary according to the implementation, although in a preferred embodiment it is the well-known RSA signature technique using asymmetric keys. At step 628c, the result of the signature verification is reported as the result of the Token verification.

Regardless of which branch is taken through Procedure 620, at step 629 the result of the verification is returned to the requester in a message.

Procedure 630 verifies a Gateway Token 401/406 directly within either an AntiSpam Gateway 150/1950, a Registry 120, a Webmail Proxy 324, or an ArmorPost Agent Client 110. It may be called as a subroutine from Procedures 600, 610, and 620 as appropriate and as previously described. The procedure begins with step 631, in which the From: address, Date: value, and To: list (or in the alternate embodiment, the full or partial message body) are extracted from the message carrying the Gateway Token being verified. At step 632, the To: list or message body is transformed using a cryptographic one-way hash function, the result of which should match what was used in creating the Token. Note that Procedure 630 may be used either directly upon receipt of a message carrying a Gateway Token, or as part of Procedure 620 in response to a verification request. In the latter case, the verification input data acquired in steps 631 and 632 are pulled directly from the request instead of from the Token-bearing message; the To: list or message body is already in hashed form. Step 633 uses the input data as shown in FIG. 4 and the Issuing Gateway's certificate acquired prior to beginning Procedure 630 to verify the cryptographic signature in the Gateway Token's Signature Section 415. The specific algorithm used for signature verification may vary according to the implementation, although in a preferred embodiment it is the well-known RSA signature technique using asymmetric keys. In step 634, the procedure reports the result of step 633's signature verification as the result of Procedure 630.

The next section describes FIGS. 7-12, which put Token processing in the context of message flow scenarios. The primary discriminants among these figures are whether the sender and recipient are served by a Messaging AntiSpam Gateway 150 and, if the sender is not so served, whether the sender is a registered user of a Registry 120. The combinations yield six separate scenarios, each of which is depicted in its own diagram.

In FIG. 7 both the sender and the recipient of a message are served by an AntiSpam Gateway 150. The figure depicts a separate Gateway for each of sender and recipient, but the scenario also applies if both are served by the same Gateway. The scenario begins in step 701 with the sender composing and sending a message. It traverses the sending service provider's infrastructure in step 702, arriving at the sender's AntiSpam Gateway 150. Step 703 shows the sending Gateway authenticating the sender of the message; note that this may be implemented in a cooperative fashion with the remainder of the sender's service provider network infrastructure, and generally uses authentication techniques that are well known by those skilled in the art. In step 704 the message is counted against the sender's traffic allocation. This is a significant attribute of the present invention. Prior art systems generally take the step of authenticating the sender, but do not prevent senders from generating excessive traffic. Spam tends to be sent in very large quantities; enforcing a traffic limit of, for example, 50 messages per day for each user can prevent a great deal of spam traffic. Message counting is critical in preventing spam: without it, a valid Token might be used innumerable times before its expiration, thereby allowing an automatic process to send spam that appears to be valid. The message counting is intended to limit traffic for each sender to a message rate that is both humanly possible and insufficient for spammers' purposes. If the message would cause the sender to exceed the allotted traffic volume, it is dropped or rejected. The message may also be queued pending a notification to and corresponding confirmation from the sender that the excess messages are intended. This approach could be used in situations where the sender is known not to be an intentional spammer, such as an authenticated user of an enterprise network. In such cases, the occasional excess traffic might be expected and admitted upon confirmation, but detection of unintended excess traffic is used to prevent clandestine spamming by zombies installed via an infectious vector (virus, worm, trojan horse, or other malware).

If the message is allowed to go through, at step 705 the Gateway decides whether encryption is required, either on the Token to be generated, on the message relay transaction to come, or both. If so, and no encryption key certificate is already known for the destination Gateway, an Introduction is requested by sending an Introduction Request message, Step 706, to the superior Network Authority 160 for this Gateway 150. At Step 707, Authority 160 retrieves the destination Gateway's certificate, either from its own database or by recursively requesting Introduction via higher level Authorities, depending on whether it is the Authority for the destination Gateway or not; for more detail on this procedure refer to the description of FIG. 22. The certificate is returned to the sending Gateway in Step 708, the Introduction Response message.

At Step 709, then a Gateway Token 401, 405, or 406 is generated, depending on the Gateway operator's preferences as previously described, and added to the message as a header. In step 710 the message is relayed to the recipient's service provider. Step 711 depicts the message, with its Gateway Token, in transit between the two service providers' networks. This transfer operation may be encrypted or unencrypted, depending on Gateway operators' preferences and, optionally, per-user configuration data. If encryption is to be applied, the receiving Gateway's certificate retrieved during Introduction, and the sending Gateway's certificate, are used in the standard way by the Transport Layer Security (TLS) protocol, which is well known to those skilled in the art.

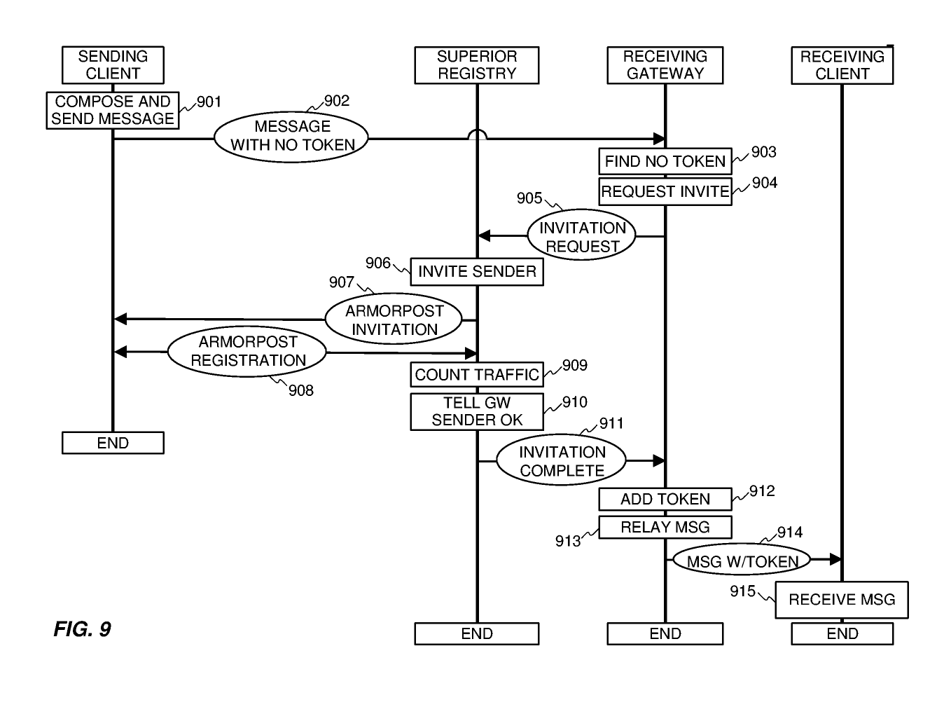

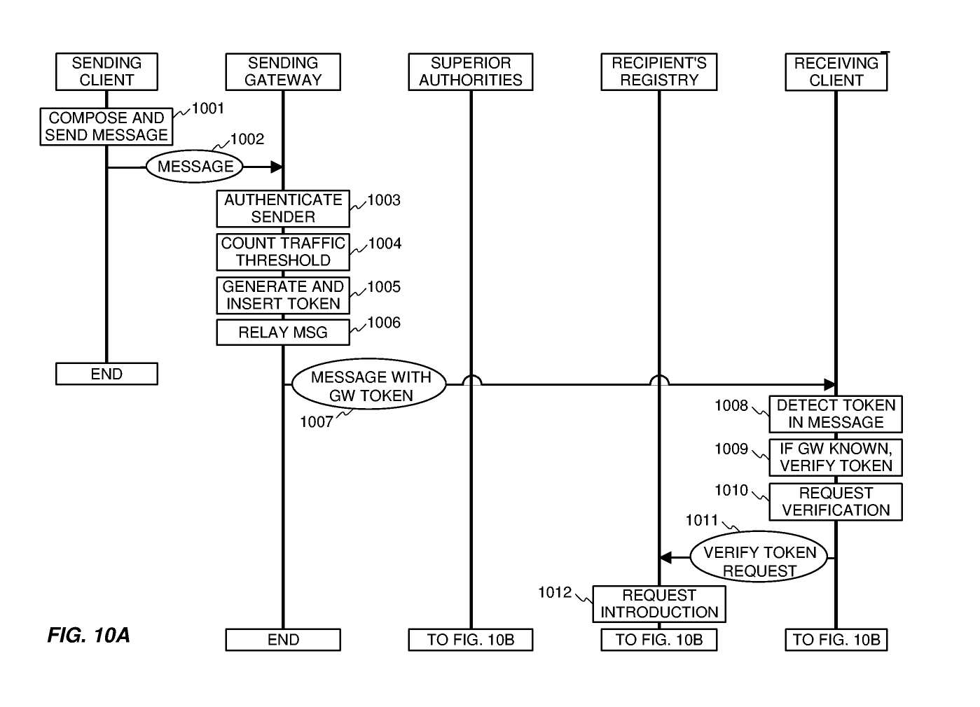

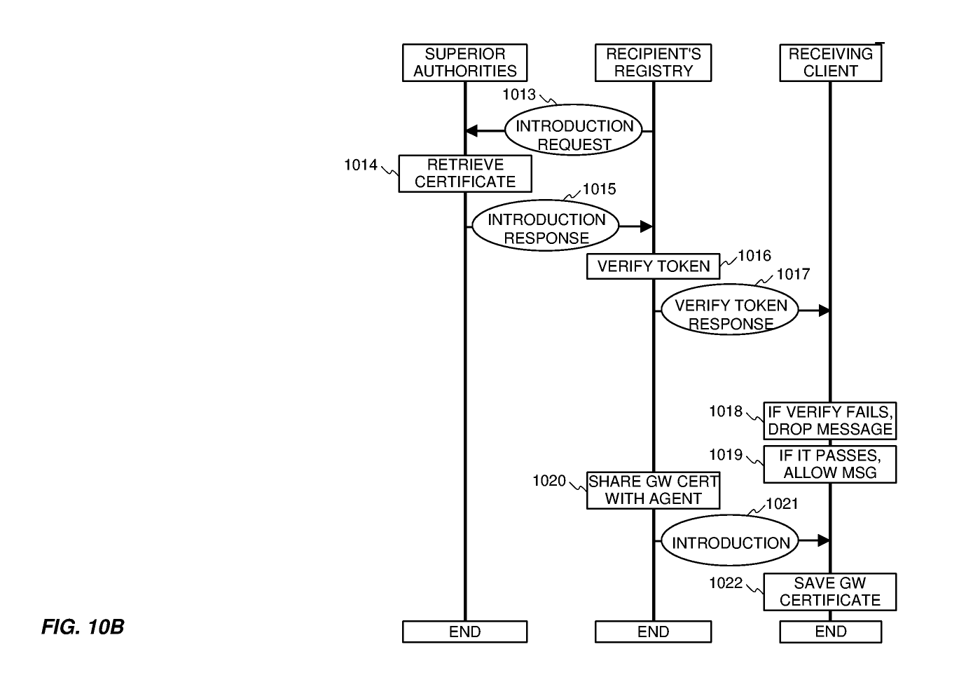

The message arrives at the AntiSpam Gateway 150 protecting the recipient's service provider's network, and at step 712, the incoming message is scanned for the presence of an authentication Token. Since in this scenario one was placed in the message by the sending AntiSpam Gateway 150, it will be detected; the alternative scenario, in which no Token would be detected, is shown in FIG. 9. To verify the Token, a certificate noting the public key of the sending Gateway is required. If the receiving Gateway has previously been introduced to the sending Gateway, this certificate may be found in a local memory buffer that is used to retain introduction data. Otherwise, at step 713 an Introduction is requested. Step 714 shows this Introduction Request in transit to the superior Authority 160; the request may be forwarded up the hierarchy as far as necessary, even to the Root Authority. The Authority 160 at which the sending Gateway 150 is known retrieves its certificate in step 715, and sends it back to the receiving Gateway 150 that requested it in step 716. For more detail on the Introduction protocol, refer to the description of FIG. 22. Back at the receiving AntiSpam Gateway 150, with the certificate for the sending AntiSpam Gateway 150 now available, the Gateway Token may be verified in step 717, as previously described in Procedure 600. At step 718, if the verification fails, the message may be dropped because its sender is inauthentic. At step 719, if the verification passes, the message may be relayed to the recipient. Prior to relaying, however, the original Gateway Token from the sending Gateway 150 is replaced by a new Gateway Token from the receiving Gateway 150. This prevents a recipient with an ArmorPost Agent Client 110 from reverifying the original Gateway Token; it instead verifies the new Gateway Token locally. If the old Token were simply removed, a recipient ArmorPost Agent Client 110 would trigger an invitation to the sender, which would also be inappropriate since the message and sender have already been verified at the AntiSpam Gateways 150. Note that this implies awareness at ArmorPost Agent Client 110 of the certificates used by any and all AntiSpam Gateways 150 that may guard it; a mechanism for discovering these certificates is shown as part of FIG. 10. Alternatively, if receiving AntiSpam Gateway 150 is aware that none of its users are ArmorPost Agent Clients 110, but instead are all Standard Clients 130, it may omit replacing the token. At step 720 the message, with or without a new Token, moves to the messaging client of the recipient, which in step 721 receives it to conclude the scenario.

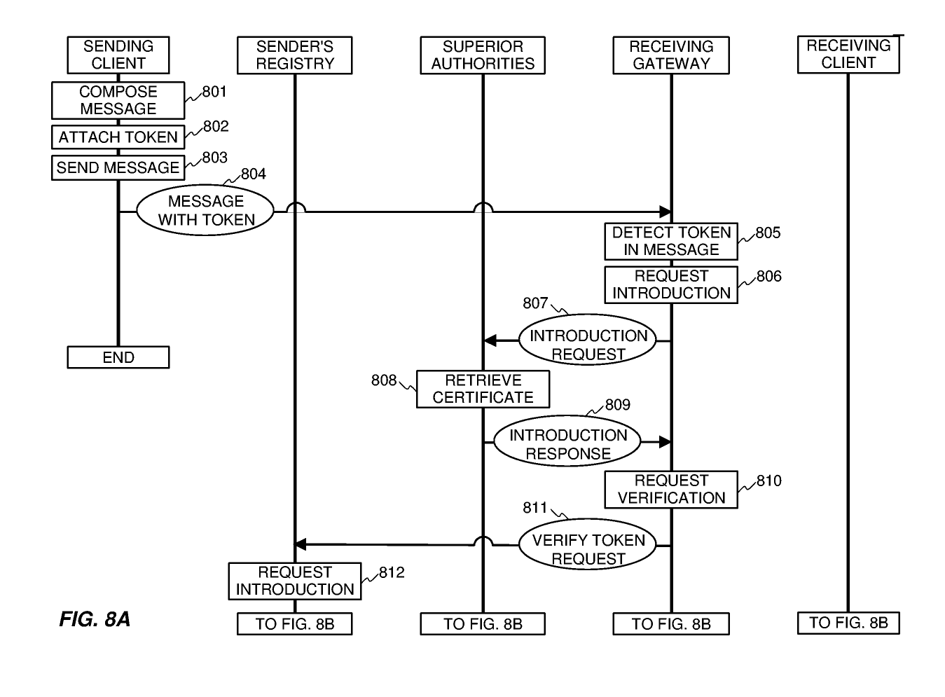

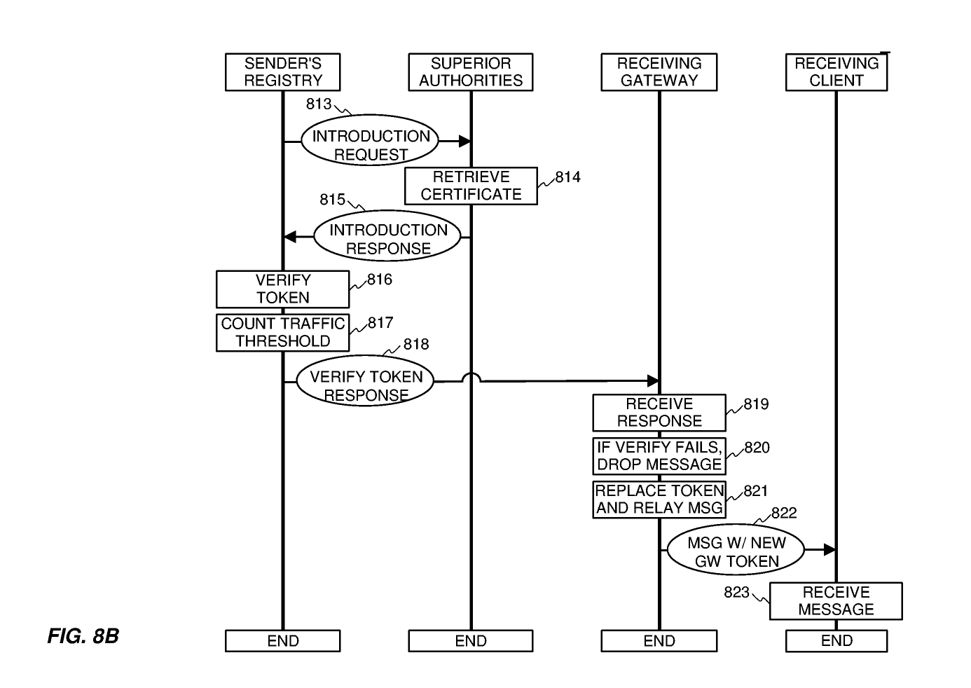

In FIG. 8, the sender of the message is registered to a Registry 120, and is not served by an AntiSpam Gateway 150, while the recipient is served by an AntiSpam Gateway 150. The scenario begins at step 801 with the sender composing a message. At step 802 an authentication Token is attached to the message. In this scenario, the sender may or may not have an ArmorPost Agent Client 110. Therefore the Token may be attached either manually or automatically, and may be of any type from FIG. 4 except one of the Gateway Tokens. At step 803, the message is sent, and step 804 depicts the message with its Token in transit toward the recipient. The message arrives at the receiving AntiSpam Gateway 150 protecting the recipient's service provider; in step 805 that element receives it and detects the Token that is in the message. In step 806, the Registry 120 named by the Verifying Registry Identifier field is determined, and if the receiving AntiSpam Gateway 150 has not yet been Introduced to the verifying Registry 120, an Introduction is requested. The Introduction signalling in steps 807-809 is substantially identical to that in steps 714-716 above. Note that the certificate retrieved at this point is not usable for verifying the Token directly. Instead, it is used to authenticate the Registry 120 that responds when requesting that it verify the Token, which takes place in step 810 using Procedure 620 from FIG. 6. Signalling that occurs during execution of Procedure 620 is depicted in steps 811-818. First a Verify Token Request message, containing the verification input data as described previously and the Token itself, is sent from the receiving AntiSpam Gateway 150 to the verifying Registry 120 in step 811. The certificate of the verifying Registry, obtained during Introduction, is used to authenticate that the server to which Gateway 150 connects is indeed the correct Registry 120. At step 812, the verifying Registry determines whether it has been Introduced to the requesting Gateway, and if not requests an Introduction from its own Authority hierarchy. Steps 813-815, which are substantially identical to steps 807-809 and steps 714-716, show this Introduction. Once the requesting Gateway's certificate is available, it can be authenticated as a permitted requester of Token verification. Assuming that authentication succeeds, at step 816 the verifying Registry 120 continues with branch 625c of Procedure 620 to verify the presented Token. If the Token verification is successful, at step 817 the verifying Registry increments the sending user's traffic count. If the message with which the verified Token is associated causes the permitted traffic level to be exceeded, or if the Token verification failed, the Token is rejected. Otherwise, the Token is approved. This result is returned to the requesting Gateway 150 in a Verify Token Response message at step 818. Step 819 shows the Gateway receiving this response. The remainder of the scenario, steps 820-823, proceed similarly to steps 718-721 in FIG. 7.

FIG. 9 depicts the scenario in which the sender has neither registered with a Registry 120, nor had the good fortune to be served by an AntiSpam Gateway 150, while the recipient is so served. As usual, the sender composes and sends a message at step 901. In this situation, though, the resulting message, shown in transit toward the recipient in step 902, has no authentication Token in it of any type. This Tokenless message arrives at the AntiSpam Gateway 150 protecting the recipient's service provider's network, which in step 903 receives it and detects that there is no Token. In step 904, the Gateway 150 stores the message for future use, and requests its own Registry 120 to Invite the sender of the message to register for antispam service. This request is made in step 905 via an Invitation Request message that contains the headers from the saved message. These headers are used to determine what address should be Invited. They may also be arranged for presentation to the recipient user upon logging in at Website 321 of Registry 120. Note that, as described for Trusted Couriers in U.S. patent application Ser. No. 10/709,952 by the present inventors (referred to as ArmorPost Networking) the recipient's Registry 120 may not be permitted to invite this sender due to lack of scope. In that situation, which is not depicted in FIG. 9, the recipient's Registry 120 would defer the Invitation to a Registry 120 associated with its superior Network Authority 160; this deferral may be repeated up the hierarchy until reaching a Registry that is permitted to make the Invitation to the sender. When a Registry 120 that may perform the Invitation is reached, it can at step 906 prepare an Invitation for the message sender. To ensure that the sender will only respond to the Invitation if it resulted from a message actually sent by the sender, the text of the invitation message preferably includes the recipient's address and the original message subject. It is also possible that no Registry in the network is enabled to perform Invitation. This could occur during early stages of deployment, before Agent Client 110 and/or Webmail Proxy module 324 have been implemented. In this case, alternative processing not depicted in FIG. 9 and generally known to those skilled in the art could be used. For example, the incoming message may be treated as suspect and placed in a queue, perhaps with other such messages, while the recipient user is notified that one or more suspect messages are available for examination via External Website module 321. Such “gray list” processing may also offer the opportunity for the recipient user to create a “white list” of senders from whom no Token is expected but messages should be delivered anyway.

Steps 907 and 908 depict in short the Invitation and Registration procedures which are described in detail in ArmorPost. If the invited user does not complete Registration, the Gateway and Registries involved in the process may after an appropriate duration discard the original message. On the other hand, if in the interim the recipient logs in at the Registry and, seeing the message header information, decides the sender is legitimate, the message may be released to the recipient prior to completion of the Registration. When Registration is complete, Registry 120 in step 909 increments the traffic counter for the newly registered sender, and in step 910 informs the recipient Gateway that the sender is valid by sending an Invitation Complete message in step 911. If the Invitation Request had been deferred to a different Registry than the one directly affiliated with the recipient Gateway, this Invitation Complete message propagates back through the hierarchy to the originating Registry, and thence to the Gateway. When informed that the message sender is valid, the recipient Gateway 150 may at step 912 generate a Gateway Token and add it to the message, for the reasons previously explained. The message is then relayed to the recipient in step 913; it is shown in transit, carrying the newly assigned Token, in step 914. Also as previously explained, in certain circumstances a Gateway Token may not be generated and added to the message at this point. Finally, in step 915 the recipient's messaging client receives the message and handles it as normal.

FIG. 10 depicts the scenario in which the sender is served by an AntiSpam Gateway 150, and the recipient does not but instead is registered and has an ArmorPost Agent Client 110. Many aspects of this scenario are similar to the previous ones, although Token handling in an ArmorPost Agent Client 110 differs in some subtle ways from Token handling in an AntiSpam Gateway 150. The scenario begins, as usual, with the composition of a message by the sender. Steps 1001-1006 are in fact substantially identical to steps 701-704 and 709-710, since both this scenario and the FIG. 7 scenario share the attribute that the sender is served by an AntiSpam Gateway 150. Therefore, the sender is authenticated, the message is counted against the sender's traffic allowance, and a Gateway Token 401 or 406 is added to the message. Gateway Token 405, and the Introduction and encryption steps 705-708 from FIG. 7, are not used here because the recipient is not served by a Gateway. At step 1007, the message with its Token is shown in transit to the recipient. Since the recipient is not served by an AntiSpam Gateway 150, the ArmorPost Agent Client 110 receives the message at step 1008, and determines that it carries a Gateway Token. It is possible that the sending Gateway 150, named in the Issuing Gateway Identifier field 411 of Gateway Token 401/406, is known to the receiving ArmorPost Agent Client 110. If so, at step 1009 the sending Gateway's certificate is used to verify the Token locally using Procedure 630 from FIG. 6. If not, ArmorPost Agent Client 110 at step 1010 uses Procedure 620 to request verification from its Registry. Steps 1011 through 1017 detail the signalling used during that Procedure, and are similar to steps 811-818. The Verify Token Request message, containing the verification input data and the Token, are conveyed to Registry 120 in step 1011. The Registry at step 1012 examines the Issuing Gateway Identifier 411 in Gateway Token 401/406 and determines whether it already has a certificate for verifying that Gateway's Tokens. If not, an Introduction is requested. Steps 1013-1015 carry out the Introduction, and are substantially identical to steps 807-809 or 813-815. Once the Registry and Gateway are Introduced, at step 1016 the Registry verifies the Token using Procedure 630. The result of the verification is returned to the requesting ArmorPost Agent Client 110 in step 1017. Whether the Token was verified locally at step 1009, or remotely in steps 1010-1017, if the verification failed the message is dropped at step 1018. If the verification succeeded, the message is allowed to pass into the user's view at step 1019. Optionally, at step 1020 the user's Registry 120 may choose to forward the sending Gateway's certificate to the user's ArmorPost Agent Client 110, so that future Tokens from that Gateway may be verified there directly. This is shown as an Introduction message from Registry 120 to ArmorPost Agent Client 110 at step 1021; the certificate is saved at step 1022

FIG. 111 depicts the scenario in which both sender and recipient are registered users with ArmorPost Agent Clients 110, and neither is served by an AntiSpam Gateway 150. Again, the flow is similar to the flow in previous scenarios. Steps 1101-1104 are substantially identical to steps 801-804, except that the message with its Agent Token 402 makes it all the way to the recipient's client rather than stopping off at a Gateway first. At step 1105, the client receives the message and detects the Token it carries. Seeing that it's an Agent Token 402, which can only be verified by the Registry 120 at which the sender is registered, ArmorPost Agent Client 110 at step 1106 initiates Procedure 620 to request verification from its own Registry 120. The signalling required to execute Procedure 620 is shown in steps 1107-1122, beginning with the Verify Token Request message in step 1107. In step 1108, the recipient's Registry determines whether it has been Introduced to the sender's Registry; if not, Introduction is requested from its superior Authority. The same Introduction process as previously described is shown in steps 1109-1111. With the sender's Registry's certificate now available, a second Procedure 620 is commenced at step 1112. At this point, steps 1113-1120 are substantially identical to steps 811-818 as previously described. This concludes the second, or inner, Procedure 620, and at step 1121 the verification result is forwarded by the sender's Registry to the recipient's Registry. Step 1122 conveys the verification result from the recipient's Registry to the recipient's ArmorPost Agent Client, concluding the first, or outer, Procedure 620. As before, if the verification failed, the message is dropped at step 1123. If the verification succeeded, the message is allowed into the user's view at step 1124.

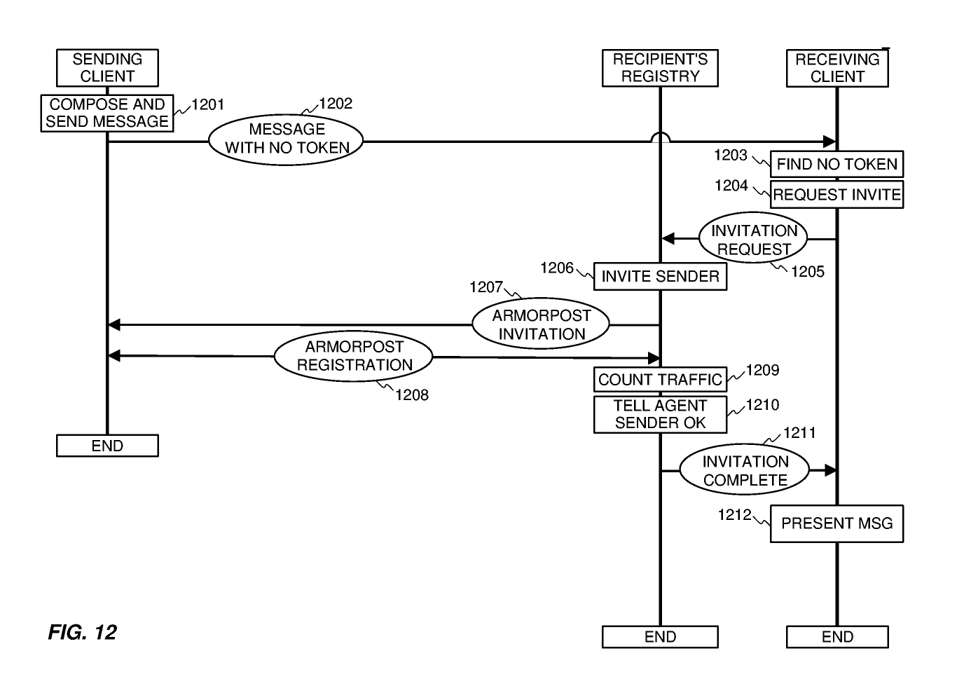

FIG. 12 depicts the scenario in which the sender is neither registered at a Registry 120 nor served by an AntiSpam Gateway 150, and the recipient, who is registered, uses an ArmorPost Agent Client 110 instead of being served by an AntiSpam Gateway 150. This scenario is nearly identical to the one in FIG. 9, except that the ArmorPost Agent Client 110 acts to request the sender be invited, rather than having an AntiSpam Gateway 150 to do so. That is, steps 1201-1204 are substantially identical to steps 901-904, except that steps 1203-1204 take place in ArmorPost Agent Client 110 where steps 903-904 take place in an AntiSpam Gateway 150. Similarly, steps 1205-1211 are substantially identical to steps 905-911 except that they are initiated by the ArmorPost Agent Client 110 instead of an AntiSpam Gateway 150. Once the Registry 120 reports that the sender is valid via the Invitation Complete message in step 1211, the client may present the message in step 1212.

Note that the foregoing six scenarios are representative of the possible scenarios that may occur in Messaging Spam Prevention System 100. Numerous additional scenarios may be constructed from elements of these by those skilled in the art.

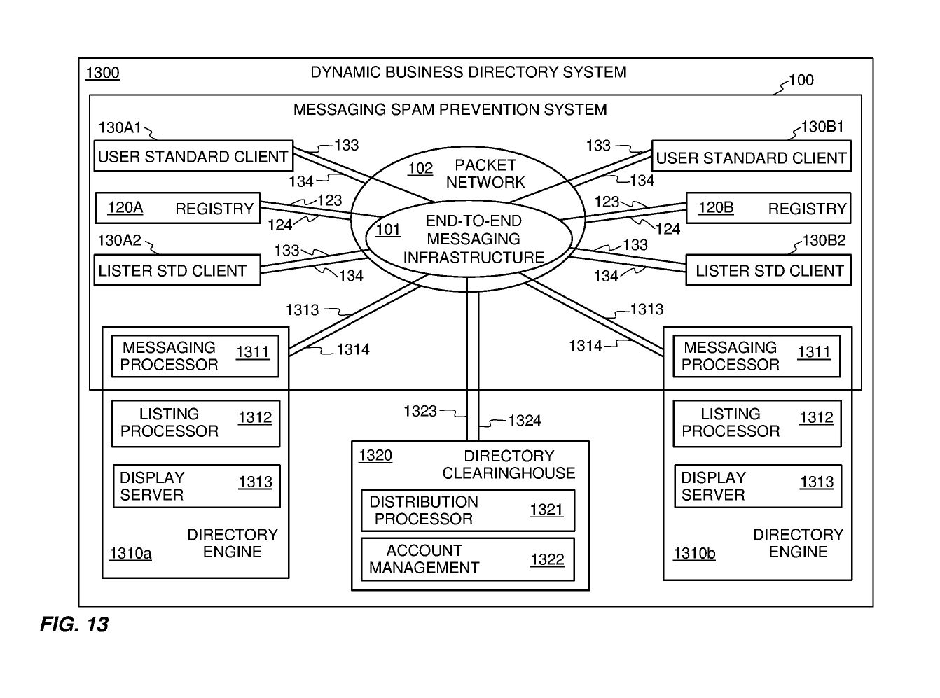

The Dynamic Business Directory System 1300 depicted in FIG. 13 overlays the Messaging Spam Prevention System 100. This overlay approach allows the Dynamic Business Directory System and its users to depend upon the spam-free environment. In addition to the multiple Registries 120 and Standard Clients 130 comprising Messaging Spam Prevention System 100, the Packet Network 102 and End-to-End Messaging Infrastructure 101 upon which both Messaging Spam Prevention System 100 and Dynamic Business Directory System 1300 are constructed, and the interfaces among them, two new kinds of element are shown.

First, Directory Engines 1310 provide the mechanism whereby directory listings are created, stored, and presented to users. Generally, a Directory Engine 1310 is affiliated with a Registry 120, both being owned and/or operated by a common organization so that business synergies may be realized between the two services. Referring to the definitions of Public and Private Registry derived from ArmorPost Networking, it is reasonable to expect that a Directory Engine 1310's corresponding Registry 120 will usually be a Public one, again because of the business goals the two systems working together satisfy: attracting users to interact with advertisers.

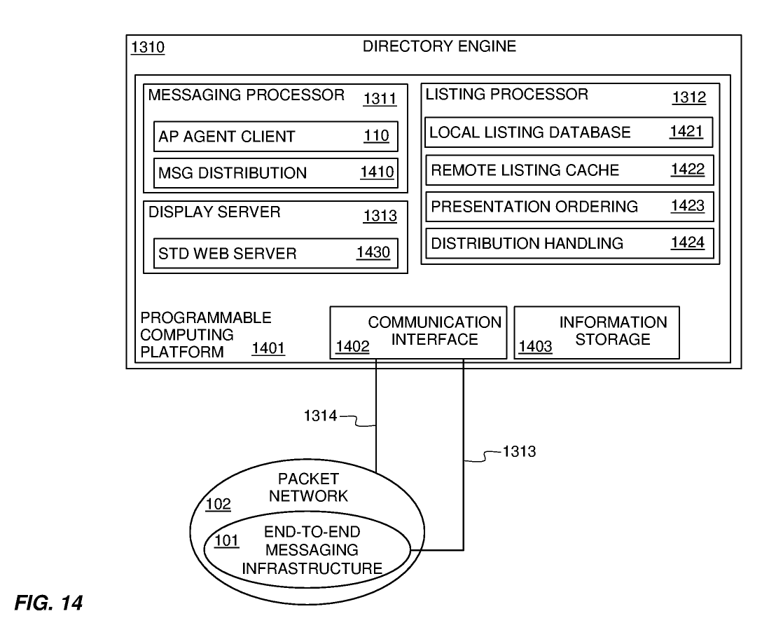

Directory Engine 1310 consists of three primary components. First is Messaging Processor 1311. This component is responsible for message-based interactions with users, represented by User Standard Clients 130a1 and 130b1 in Spam Prevention System 100, and businesses whose advertisements are listed with the Directory Engine, represented by Lister Standard Clients 130a2 and 130b2. As shown in the figure, Messaging Processor 1311 is both a component of Directory Engine 1310 and a participant in Spam Prevention System 100. As will be seen in FIG. 14, this is effected by an ArmorPost Agent Client 110 that is embedded as a module of Messaging Processor 1311, making it possible to exchange spam-free messages with ordinary clients associated with both users and advertisers. Thus Messaging Processor 1311 may offer a mediated communication path between users and advertisers as well. The second of Directory Engine 1310's components is the Listing Processor 1312, which is responsible for managing advertiser's listings. Both local listings belonging to advertisers who are direct customers of the local Directory Engine, and remote listings belonging to advertisers who are customers of other Directory Engines, are stored here. Finally, Display Server 1313 is responsible for presenting listings to users as they request information about advertisers. Thus Listing Processor 1312 and Display Server 1313 together offer a universal advertising medium allowing users to discover information about businesses of all sorts. This medium is in some respects similar to a so-called “Yellow Pages” directory, which is a well-known concept. Further, the ability of multiple Directory Engines 1310 to share their listings with one another, thus providing users of every Directory access to a common view from all Directories, may be considered analogous to a real estate “Multiple Listing Service,” which is also a well-known concept. The combination of these two ideas, and application of them to a networked environment, provides a unique opportunity to revitalize commercial communication using electronic messaging as a safe medium. Of course, without interconnect these capabilities cannot be made available broadly. Therefore, Interface 1313 provides message-based interconnect with other elements via End-to-End Messaging Infrastructure 101, and Interface 1314 provides packet-level interconnect for all other types of communication via Packet Network 102.

The second additional element appearing in Dynamic Business Directory System 1300 is the Directory Clearinghouse 1320. While there may be multiple Directory Engines 1310, the system includes only a single Clearinghouse. It may be affiliated with the Root Authority, although that is not required. The Directory Clearinghouse's role is to interconnect the various Directory Engines so that their listings may be shared, but without revealing to any one Directory Engine which other Directory Engine actually owns a particular listing. The latter feature is intended to prevent an environment in which Directory operators poach advertisers from one another. Thus listings are relayed among the Engines by the Clearinghouse, and transactions affecting the business of presenting listings are cleared through the Clearinghouse. Such transactions may include reporting the number of viewings a listing has enjoyed, the number of mediated communications requested by users at a particular Directory Engine, and mediated communications themselves. This architecture carries the potential to enable numerous additional transaction types, representing numerous alternative business models, the nature of which cannot be anticipated by the present inventors. Note that the practice of sharing a listing without revealing which Directory Engine owns it leads to running all mediated communication between an advertiser at one Directory Engine and a user at another through the Clearinghouse. This may pose a challenging operational environment at the Clearinghouse, so in an alternate embodiment the Directory Engines may be allowed to relay mediated communications amongst one another directly. This alternate embodiment would not prevent Directory Engine operators from knowing one another's advertisers, and therefore does not prevent poaching. However, poaching does not actually require knowledge of what Directory operator owns a particular listing for a particular advertiser, so making this information available does not necessarily hurt anything. Directory Clearinghouse 1320 consists of two primary components. Distribution Processor 1321 is responsible for providing the transaction clearing and inter-Directory communication capabilities described above, while Account Management component 1322 records the relationship with each Directory Engine 1310. Interface 1323 provides message-based interconnect with other elements via End-to-End Messaging Infrastructure 101. Interface 1324 provides packet-level interconnect for all other types of communication via Packet Network 102.

Additional detail of Directory Engine 1310 can be seen in FIG. 14. Messaging Processor component 1311 is shown here as comprising an ArmorPost Agent Client 110 for the purpose of participating in the Spam Prevention System 100 as an authenticated sender of valid messages. There is also a Message Distribution module 1410, which is responsible for storing and managing the distribution of mediated communications. When a user wishes to make an inquiry to an advertiser without revealing the user's own messaging address, this module handles the mapping between the user and the inquiry, so that any response from the advertiser may be relayed to the user. Also, when a user chooses to subscribe to bulletins from a particular advertiser or set of advertisers in a classification, Message Distribution module 1410 is responsible for recording the fact and managing the distribution of bulletins to users. In the embodiment that hides Directory Engine identities from one another for each advertiser, all bulletins also go to the Clearinghouse; in the alternate embodiment this module also records which other Directory Engines currently have users requesting a particular bulletin. Note that user addresses are never revealed outside the Directory Engine and associated Registry, protecting both the users' privacy and the Directory Engine operator's subscriber base.

The next component of Directory Engine 1310 is the Listing Processor 1312, which provides the heart of the present invention's unique functionality with respect to Dynamic Business Directory System 1300. The first of its modules is the Local Listing Database 1421, which manages the listings of advertisers with whom the operator of a particular Directory Engine 1310 has a direct relationship. This constitutes the master data view of those listings. Remote Listing Cache 1422 manages the listings held by other Directory Engines 1310. These listings are available for presentation to and interaction with users, but not for local management. Presentation Ordering module 1423 is responsible for collating all listings, both local and remote, into result lists according to user requests. For example, if a user indicates an interest for all advertisers of a certain category within a certain region, this module selects and orders the listings for presentation. Several criteria may be offered for selection, in a manner similar to a search engine or related technology. Within a result set, the presentation order is influenced heavily by feedback from previous users viewing the same advertisers. When users provide positive feedback on an advertiser, or choose to receive additional communications from an advertiser via messaging, that advertiser's position in the presentation order is improved. Various approaches are possible to weigh these and other dynamic attributes in ordering results, and the Presentation Ordering module 1423 is intended to be extensible so that additional attributes and weights may be added to the system over time. It is this responsiveness to user feedback and viewing traffic that makes the Dynamic Business Directory System 1300 dynamic. Note that, as previously observed, the behavior of Presentation Ordering module 1423 in selecting and ordering listings is conceptually similar to the behavior of an Internet search engine. The particular methods cited above for selecting and ordering, however, are quite different from those used in prior art search engines. For example, the well-known and highly-regarded Google Page-Rank approach weighs and orders each result according to its relative popularity or relevance by counting the number of other pages that point to it. This is a relatively slow-changing criterion, though not quite static, as the Google servers are obliged to “crawl” the network capturing and analyzing every we page in the network. The ability to respond rapidly to changes in a result's relevance according to this criterion is limited by the pace at which the network crawl can take place; with the sheer size of the network this is clearly less than dynamic. In the present invention, on the other hand, local user feedback can be acted on immediately, and remote user feedback is delayed only by its propagation through the Directory Clearinghouse. An implementation of the present invention may choose to report transactions that affect presentation ordering in batches spaced at regular intervals in order to optimize the traffic posed by the transactions against the value of the changes, or to report each one immediately for processing in real time. This function is allocated to Distribution Handling module 1424, which is responsible for interactions with the Directory Clearinghouse 1320 and, to the extent allowed within a particular implementation, other Directory Engines 1310.

Display Server 1313 takes care of the user interface aspects of Directory Engine 1310. In that capacity it presents instructions and options to users, accepts their requests for information, and in turn presents the listings that result from these requests. As the general environment for this system is the modern Internet, web-based technology may be suitably applied. Therefore, the sole module of Display Server 1313 is a Standard Web Server 1430, appropriately programmed with the specific attributes required to present and accept as described above. Because this technology is quite flexible, as is well-known to those skilled in the art, the specific style of presentation may be easily varied to suit the business, cultural, or other needs of the Directory Engine's operator.

In a preferred embodiment, Directory Engine 1310 is designed to operate as a network server. Its components are therefore housed in a specific Programmable Computing Platform 1401. Platform 1401 is chosen to provide highly reliable operation and flexible scalability. Candidates satisfying such requirements are well-known to those skilled in the art, and are available from major vendors such as SUN, HP, Motorola, Intel, and many others. Platform 1401 also includes a Communication Interface 1402 for connecting to a network. This is typically implemented using two or more standard Ethernet links, which are well known to those skilled in the art. Additionally, Platform 1401 provides an Information Storage medium 1403 for holding data required by the functional components, including in particular configuration data such as Clearinghouse and Registry addresses, and listing data. This is typically implemented as a magnetic “hard disk” module. Platform 1401 and its subsystems are preferably implemented using standard components that are commonly available and well known to those skilled in the art.

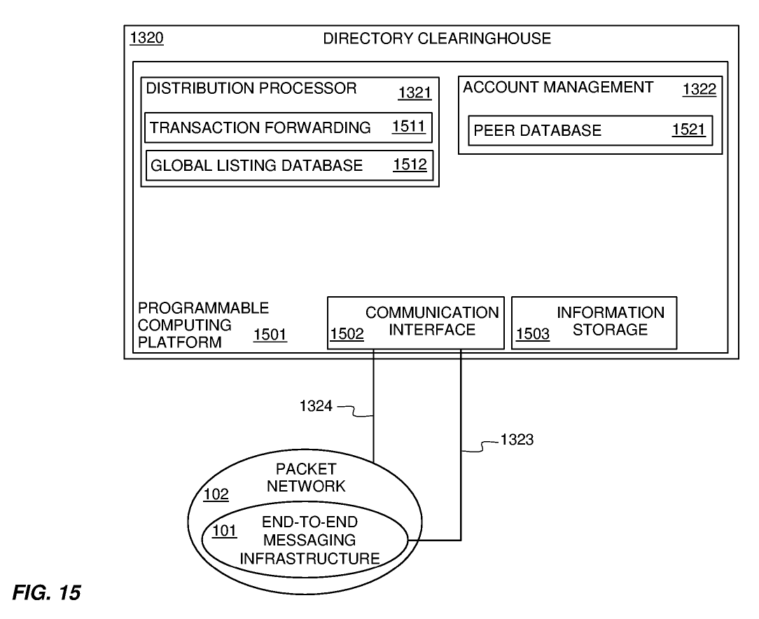

Additional detail of Directory Clearinghouse 1320 can be seen in FIG. 15. Its two primary components, Distribution Processor 1321 and Account Management 1322 are shown with their respective modules. Within Distribution Processor 1321 are Transaction Forwarding module 1511 and Global Listing Database 1512. Transaction Forwarding module 1511 is responsible for accepting attribute transactions on individual listings or groups of listings, from a Directory Engine 1310, and forwarding these transactions to other Directory Engines 1310. At the same time, each transaction is reflected in the Global Listing Database 1512 so that a consistent view of the data used in presentation ordering can be maintained and, if necessary restored to Directory Engines that lose it for any reason. Note that Global Listing Database 1512 may or may not store the actual listings themselves. A profile of the listing will generally suffice, so for reasons of storage economy and bandwidth optimization the detailed listing data may be omitted. Account Management component 1322 features a Peer Database module 1521. Its role is to track the business relationships between the operator of the Clearinghouse and the various operators of Directory Engines. Peer Database 1521 may also track business relationships among operators of Directory Engines to the extent that details of those relationships affect the process of clearing transactions and distributing listings. Many different kinds of business relationship and money flow are conceivable; both Peer Database 1521 and Transaction Forwarding module 1511 are intended to provide a flexible platform to support a variety of approaches. As with other elements previously described, Directory Clearinghouse 1320 is generally operated as a network server. Its components are therefore housed in a specific Programmable Computing Platform 1501, which is similar in structure and purpose to Platform 1401 as previously described.

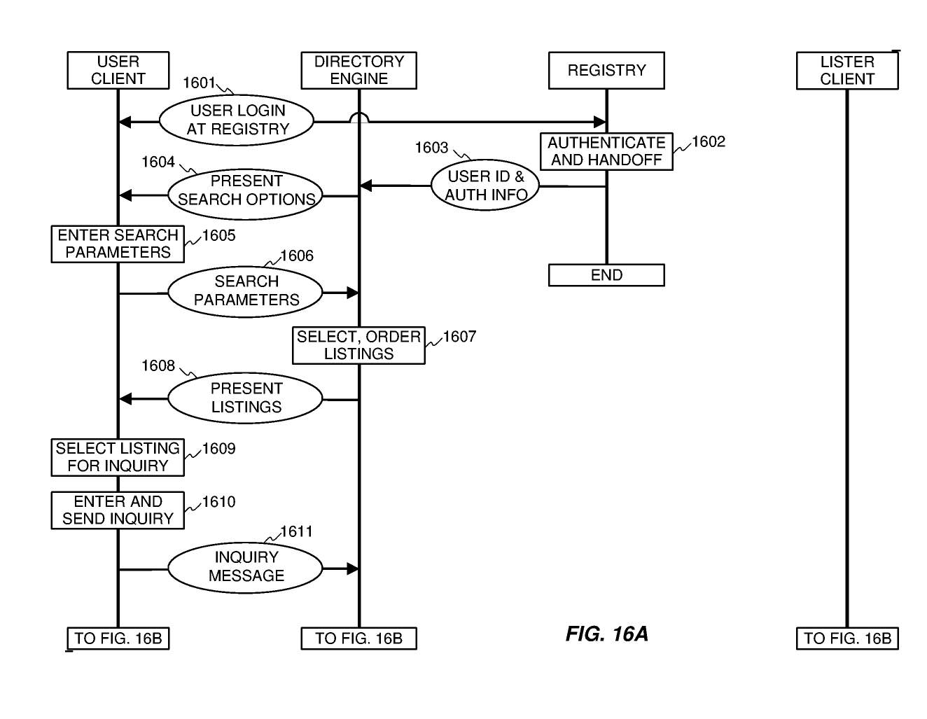

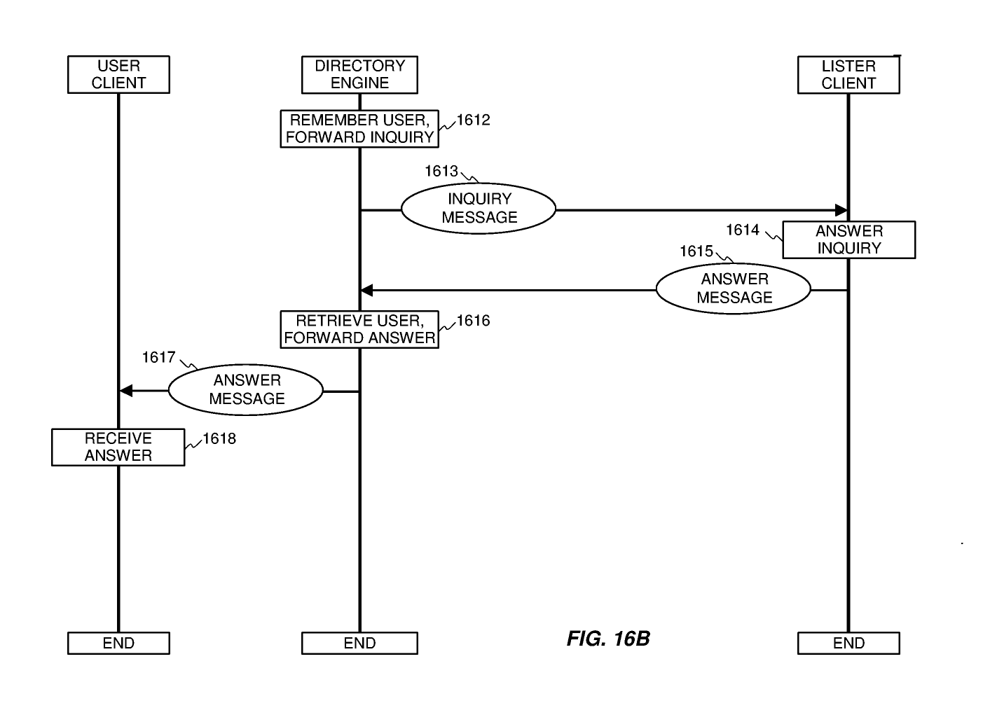

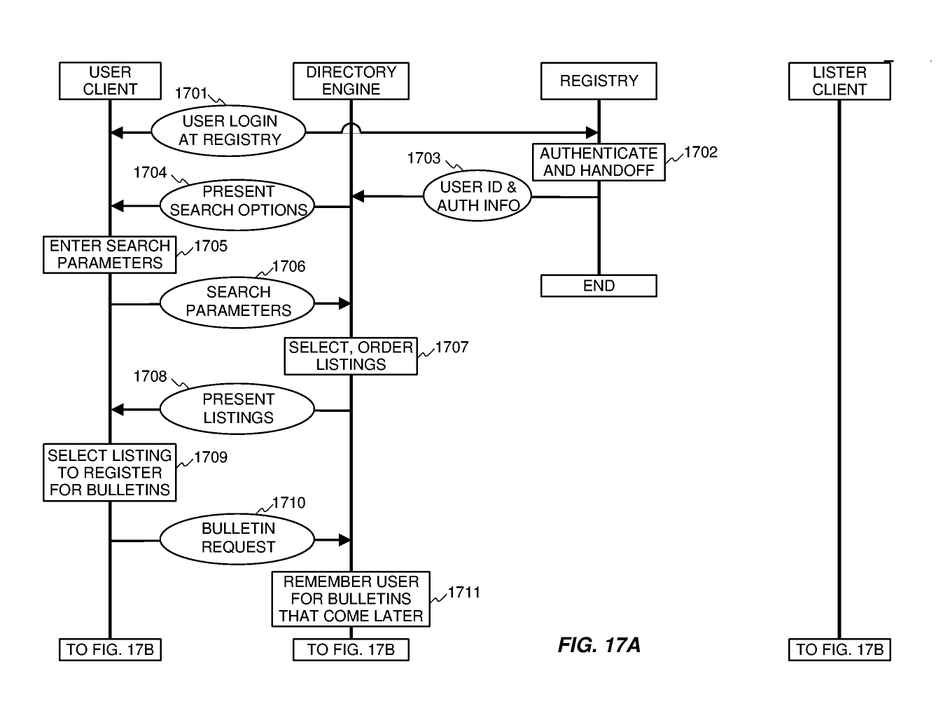

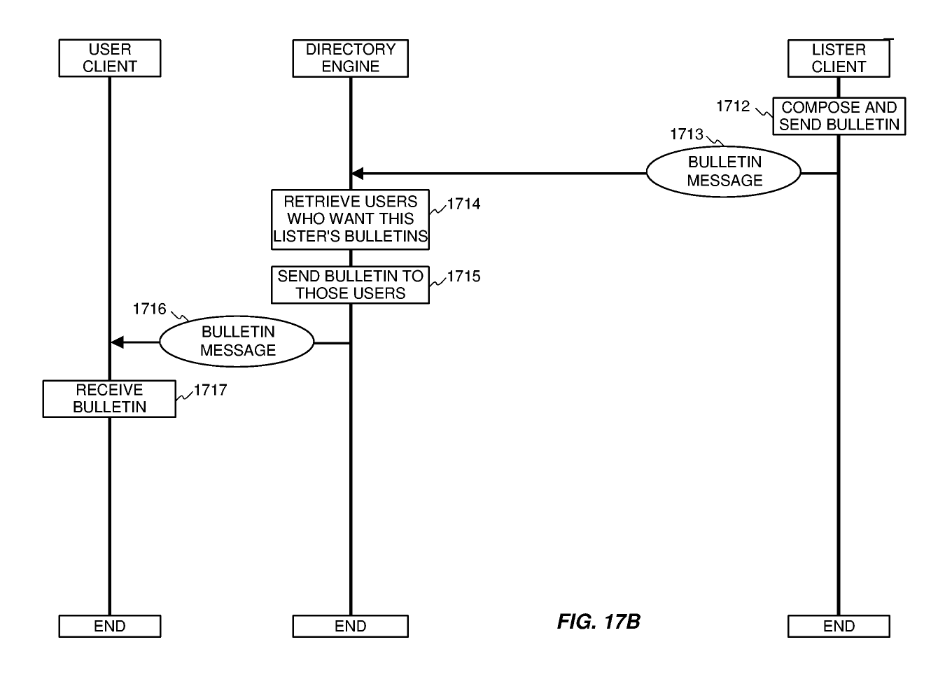

FIGS. 16 and 17 depict procedures used by the Dynamic Business Directory System 1300 to offer mediated communication between users and advertisers. First, in FIG. 16 we find a process whereby a user may make an inquiry to an advertiser, and receive a response without having revealed the user's address to the advertiser. This is analogous to looking up a business in a telephone directory and calling to ask a question, such as the price of a particular item or whether it is in stock. The caller making the inquiry generally does not provide a name, nor does the advertising business generally capture the caller's phone number for future use. Similarly, in the present invention the user sending the inquiry sends it through the Directory Engine, which by the nature of Spam Prevention System 100 can assure the advertiser that the inquiring user is valid without revealing that user's address. The advertiser may answer the inquiry using the same mechanism, thereby completing the cycle. This process is termed here an interactive mediated communication. FIG. 17 then depicts the process whereby a user may subscribe to advertising bulletins offered by a particular advertiser. Again, the user's addresses are not revealed to the advertiser in order to maintain user privacy and remove the temptation to provide the address to other advertisers for direct contact that may not be desired by the user (which would be spam). The advertiser sends the bulletin to the Directory Engine instead, which in turn forwards it to the users who have requested it. Again, by the nature of Spam Prevention System 100, the various participants are known to be valid, verifiable entities. Therefore, should any abuse occur the abuser can be known and appropriate action may be taken.

The interactive mediated communication process shown in FIG. 16 begins at step 1601 with the user logging in at the Website 321 of the appropriate Registry 120. Numerous technologies exist for authenticating the user upon attempting to log in, including the ubiquitous username and password which may be considered as minimal. In addition, since Spam Prevention System 100 has provided a cryptographic identity certificate to each user who completes Registration, that certificate may be used for login authentication at this point. The protocols for taking advantage of this certificate are well-known to those skilled in the art, though they have been used only rarely in prior art systems because those systems do not have the thorough certificate distribution capabilities of Spam Prevention System 100. Note also that, in an alternate embodiment, the user login may be implicitly derived from a mail server or access server to which the user authenticates for other reasons, thereby avoiding the need for a separate explicit login visible to the user. The Registry authenticates the user in step 1602, and hands off the web session to the affiliated Directory Engine 1310. The user's identity and authentication parameters, along with account information that may be pertinent to the services provided by Directory Engine 1310, such as advertiser bulletin subscriptions or other advertising-related preferences, are passed to it in step 1603. In step 1604, the Directory Engine then presents to the user a portal page that includes search options used to choose listings the user desires to view. The format of this presentation may vary from operator to operator, but in general it would be similar to an internet search engine or online “yellow pages” directory.

At step 1605, then, the user enters parameters for the search, such as a business category, a geographical region, a quality rating, or other criteria as may be made available by the Directory Engine's operator. These parameters are conveyed to Directory Engine 1310 in step 1606, and in step 1607 it selects the matching listings and orders them for presentation according to the relative values of their order-affecting attributes. These may include the total number of viewings for each listing by users in this and other Directory Engines, the number of users subscribed to bulletins from each advertiser, the feedback ratings provided by users who have previously viewed these listings, and others that may be added to the system over its life. Thus ordered, the selected listings are presented to the requesting user in step 1608.

If appropriate to the user's needs, at step 1609 the user may select one or more listings in order to make inquiries to their advertisers. Upon making such a selection, at step 1610 the user will be able to compose and send the inquiry as an ordinary electronic message via the user's accustomed messaging software, which may be a Webmail Proxy 324 provided by Registry 120. The inquiry is addressed to the Directory Engine 1310's ArmorPost Agent Client 110, with the advertiser's identity encoded in the address used. For example, if the advertiser to whom the inquiry is directed is Joe's Garage, which uses the domain name joesgarage.biz, and the Directory Engine is provided by Barking Pumpkin Records on the domain name barkingpumpkin.com, the inquiry may be addressed to joesgarage.biz@barkingpumpkin.com. This message is transmitted in step 1611 to Directory Engine 1310, which in turn saves the inquirer's address, generates a new sender address specific to this inquiry but not revelatory of the inquirer's address, changes the recipient's address to the one specified in the listing data for the intended advertiser, and forwards the inquiry to the advertiser at that address. If the inquiring user's address is frank@barkingpumpkin.com, that address would be stored and replaced with, for example, inquiry42@barkingpumpkin.com in the subsequent message, while the recipient might become inquiries@joesgarage.biz. This transformed message is shown in transit to the advertiser's Lister Standard Client 130 in step 1613.

Upon receipt of the inquiry, the advertiser at step 1614 may reply to the message, thereby creating another message containing the answer to the inquiry. This message goes back in step 1615 to the Directory Engine 1310, which retranslates the reply address to the original user's address in step 1616, and relays the answer message to the original sender in step 1617. The process concludes in step 1618 when the user receives the advertiser's response.

Note that throughout this procedure, the participants rely upon one another's addresses to be valid. This is accomplished through the construction of Dynamic Business Directory System 1300 on the Spam Prevention System 100, which provides the necessary assurance. Note further that, though not shown, it is also possible to overlay the Dynamic Business Directory System on the Private Email System of ArmorPost so that mediated communications may also be carried in complete privacy as appropriate.

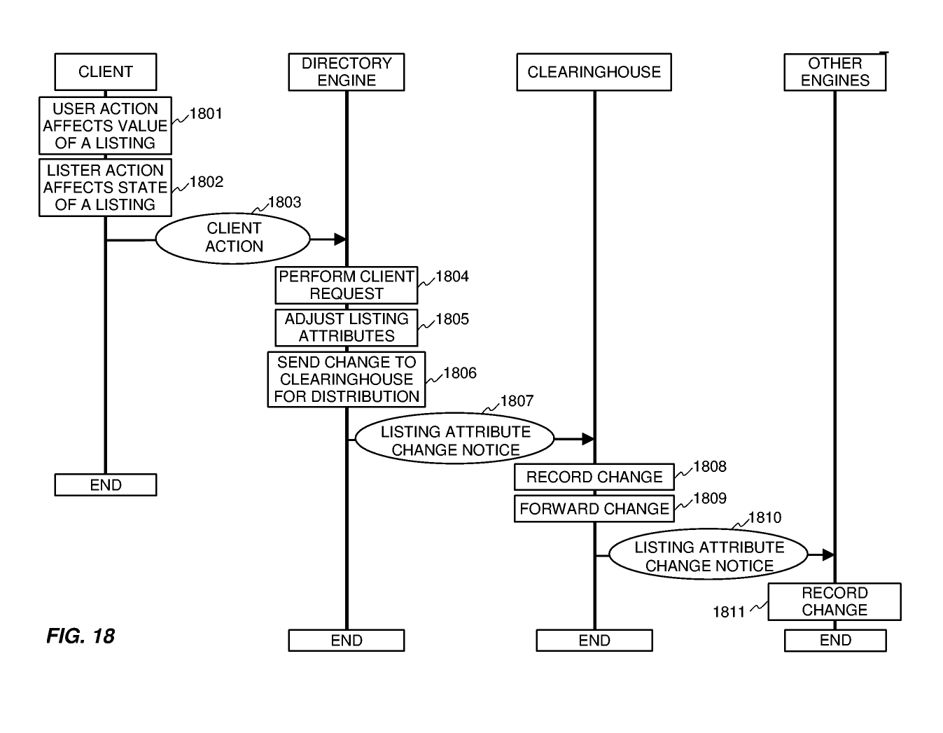

FIG. 17 depicts subscription to and reception of mediated advertising bulletins. The first few steps, 1701-1708, are substantially identical to the opening steps 1601-1608 of FIG. 16; in both, a user logs in at the appropriate Registry 120, enters search parameters, and is presented with an ordered set of listings that match those parameters. At step 1709, the user decides that one or more of the listings is appealing, and chooses to register for additional information the advertiser may provide such as, for example, a periodic or occasional announcement of bargain prices. The bulletin request is conveyed in step 1710 to Directory Engine 1310, which in step 1711 saves the user's address as a recipient of future bulletins from the advertiser corresponding to the selected listing. Note that, if the listing is not local to this Directory Engine 1310, the act of subscribing a user to the bulletins of this advertiser is a state change that must be propagated to the Directory Engine 1310 at which the listing originates. Refer to FIG. 18 for details of that procedure.

At some later time, an advertiser with a listing in Directory Engine 1310 composes and sends a bulletin at step 1712, using the messaging capabilities of Spam Prevention System 100. This message, shown in transit at step 1713, is sent to the Directory Engine at an address reserved for such bulletins. Directory Engine 1310 receives the message and, in step 1714, retrieves the list of addresses for users who are subscribed to receive such bulletins from this particular advertiser. Note that it is possible to have several different kinds of bulletins, and a user may have subscribed to some kinds but not others from this advertiser. It is also possible that a user may have subscribed to all or certain kinds of bulletin from all advertisers of a particular category. Each of these possible combinations is checked to form the list of users who should receive this particular bulletin. Note further that users in other Directory Engines 1310 may have subscribed to these bulletins; those users are not known here, but their Directory Engines are, the current one having been informed of subscriptions as noted in step 1711. In step 1715, then, Directory Engine 1310 sends a copy of the bulletin to each of these users and remote Directory Engines; the copy for the specific user in this scenario is shown in transit at step 1716, and being received in step 1717.

As users view listings, make inquiries of advertisers, subscribe to bulletins from advertisers, and provide feedback on advertisers and their listings (not depicted or described further here, as the concept and technology are reasonably well known among those skilled in the art), Directory Engine 1310 is counting these transactions so that they may be used in determining each corresponding listing's presentation order as described previously, noting as well which transactions affect local listings and which affect remote listings. As advertisers join the service and add listings, or as they leave the service and delete listings, and as they make changes to their listings, these transactions, too, are recorded in Directory Engine 1310. Dynamic Business Directory System 1300 is a distributed, cooperative system in which every Directory Engine 1300 may present listings to its users that all Directory Engines 1300 have collected. The transactions that affect these listings, therefore, are propagated around the network as they occur. As previously noted, this may take place immediately upon completion of each transaction, or periodically in batches. Either way, FIG. 18 depicts a propagation procedure.

Beginning at either step 1801 or step 1802, a user or an advertiser takes action on a listing that is in step 1803 conveyed to the corresponding Directory Engine 1310. For a user, such action may include subscribing to a bulletin, sending an inquiry, or even simply viewing a listing; in short, any action that may affect the value of a listing. For a lister, such action may include creating, deleting, or changing any attribute of a listing so that its state is affected. The Directory Engine in step 1804 performs the client's requested action, and in step 1805 adjusts the stored attributes of the corresponding listing or listings accordingly. After these local steps are taken, the transaction details are then formatted for propagation through the network in step 1806, and sent to Directory Clearinghouse 1320. This information is shown in transit as a Listing Attribute Change Notice in step 1807. The Clearinghouse 1320 receives the Change Notice and records it in Global Listing Database 1512 in step 1808. Note that if the change is to the content of the listing, the details of the change may be ignored by the Clearinghouse. Now at step 1809 Directory Clearinghouse 1320 forwards the Change Notice to other Directory Engines 1310 in the network, as listed in Peer Database 1521. Step 1810 shows the Listing Attribute Change Notice in transit to another Directory Engine, which receives it and records the change in step 1811. Care is taken when recording propagated changes not to include those changes in the next Change Notice sent out by the receiving Directory Engine, so that only the changes caused by its own users are sent out by any particular Directory Engine. Note also that the Directory Engine 1310 at which a listing originates may take additional action on receipt of a Change Notice regarding that listing; for example, certain transactions may be considered billable events that result in collecting money from the corresponding advertiser. Also, as previously mentioned, capacity concerns may drive an implementation of Dynamic Business Directory System 1300 to bypass Clearinghouse 1320 for most or all transactions, in which embodiment this procedure would use a series of direct exchanges to enmesh the data among all Directory Engines 1310.

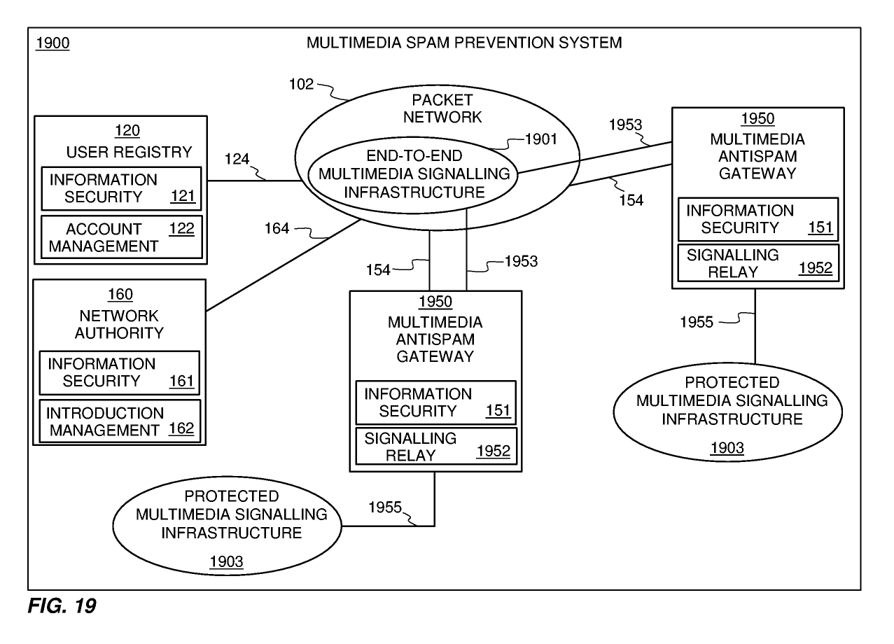

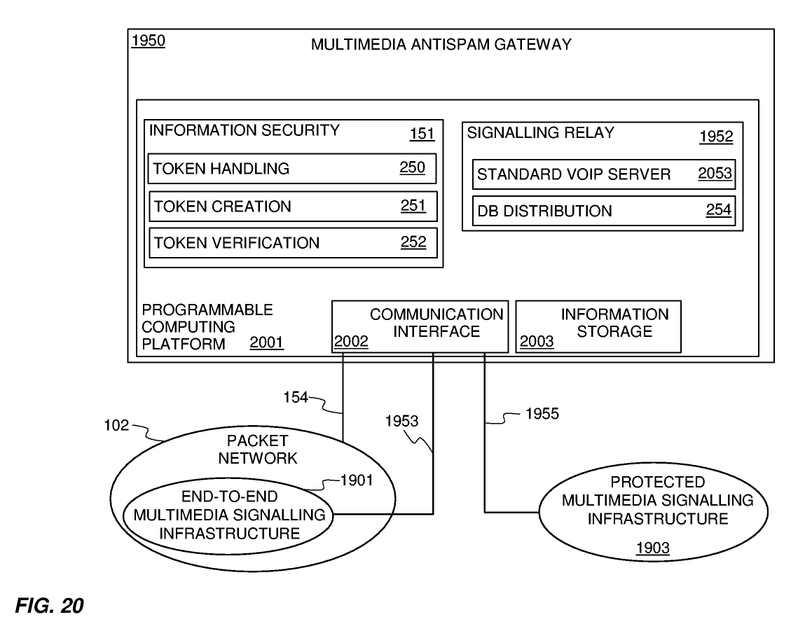

FIG. 19 depicts Multimedia Spam Prevention System 1900, which is similar to Messaging Spam Prevention System 100 in many respects, and rests on many of the same principles, but is designed to support authenticated multimedia session establishment rather than authenticated messaging. End-to-End Multimedia Signalling Infrastructure 1901 represents the multimedia signalling backbone to which the Spam Prevention capability is added. This Infrastructure can be any system that allows users or automatic programs to establish multimedia sessions with one another. It is preferably a Voice Over Internet Protocol (VoIP) or videoconferencing service built around the Internet-standard Session Initiation Protocol (SIP), but may also be implemented on the International Telecommunications Union (ITU) H.323 suite of standards. In either case, the standard network topology features user terminals which exchange media streams directly with one another, supported by signalling servers which handle user terminal discovery and session negotiation. It is in the signalling transactions where the potential for multimedia spam appears and can be prevented, because end to end media streams may only exist in the context of negotiated signalling sessions. The techniques applicable to messaging previously described are therefore generally applicable to multimedia signalling. Note that in the remainder of this disclosure, only the signalling protocols, procedures, and network topology are addressed. Media streams and the network topology supporting them are neither shown nor discussed, and no constraints on media stream connectivity are implied by the constraints described on signalling connectivity.

As in System 100, Packet Network 102 forms the foundation for communication among elements of System 1900, including End-to-End Multimedia Signalling Infrastructure 1901 and the signalling units exchanged thereon, but also supporting other non-signalling interactions such as web browsing. This element is preferably an Internet-based network, and may be the Internet itself, another network like it, or a composite of networks using multiple interworking technologies.

Connected to Packet Network 102 is at least one User Registry 120 (also referred to as simply Registry 120); this is the same User Registry 120 that appears in System 100, and has substantially the same functionality, omitting those functions that are specific to the messaging service provided in System 100. In System 1900, Registry 120 is primarily a repository and user interface for access to information about multimedia sessions offered but rejected by associated Multimedia AntiSpam Gateways 1950. Users' interaction with System 1900 takes place via standard elements within a Protected Multimedia Signalling Infrastructure 1903.

At least one Multimedia AntiSpam Gateway 1950 sits between End-to-End Multimedia Signalling Infrastructure 1901 and one or more Protected Multimedia Signalling Infrastructures 1903. Using Interface 1953, an AntiSpam Gateway 1950 receives signalling for sessions directed to users of a Protected Multimedia Signalling Infrastructure 1903 from End-to-End Multimedia Signalling Infrastructure 1901, then decides whether the session signalling should be relayed into Protected Multimedia Signalling Infrastructure 1903 via Interface 1955. Using Interface 1955, an AntiSpam Gateway 1950 also receives session signalling sent by users of a Protected Multimedia Signalling Infrastructure 1903 to other users of End-to-End Multimedia Signalling Infrastructure 1901. Note that Interfaces 1953 and 1955 are functionally equivalent to one another, using the same standard session signalling protocols (for example, SIP or H.225/H.245). For incoming calls, Information Security component 151 of AntiSpam Gateway 1950 (same function and therefore same label as in System 100) makes its decision by verifying any authentication Token in the signalling unit, using the procedure described in the context of FIG. 6 above. That procedure features communication between AntiSpam Gateway 1950 and one or more Registries 120; Interface 154 to Packet Network 102 provides the necessary connectivity. Note that Interface 154 is functionally equivalent to Interface 124, and is substantially the same as the element of the same name and label in System 100. For outgoing calls, Information Security component 151 of AntiSpam Gateway 1950 authenticates the session initiator, then adds an authentication Token to each signalling unit. In both directions, if the authentication decision is affirmative, Signalling Relay component 1952 of AntiSpam Gateway 1950 effects the relaying of the signalling unit. In a preferred embodiment, Signalling Relay component 1952 is standard and commonly available VoIP switching software, such as an implementation of a SIP Proxy server.

As in System 100, AntiSpam Gateways 1950 and User Registries 120 are related to one another in the sense that the users of a particular Protected Multimedia Signalling Infrastructure 1903, served by one or more particular Multimedia AntiSpam Gateways 1950, are registered in and provided account management services by a particular User Registry 120. As previously described, the primary interaction supports database distribution for the purpose of offering users an interface mechanism for examining call history. Other Registry functionality related to Clients and non-Gateway Tokens in System 100 does not apply in System 1900.

As in System 100, Multimedia Spam Prevention System 1900 also uses Network Authorities 160 to control distribution of cryptographic key certificates. The functionality of a Network Authority 160 is not service-specific, so the same ones are used in both systems.

Further detail on Multimedia AntiSpam Gateway 1950 is shown in FIG. 20. Information Security component 151 is substantially identical to Information Security component 151 in Messaging AntiSpam Gateway 150, and performs the same procedures as described previously. Similarly, Database Distribution module 254 is substantially identical here as well, except that it is used in Signalling Relay component 1952 rather than Messaging Relay component 152. Here, it is used to convey information about call history, particularly rejected calls. Similar to the way traffic measurements are used in Messaging Spam Prevention System 100, this call history data is used here for session rejection based on traffic levels.

Within Information Security component 151, Token Handling module 250 is responsible for detecting authentication Tokens in incoming signalling units, and placing authentication Tokens in outgoing signalling units, according to the various conventions for Token inclusion described in the context of FIG. 4. Token Creation module 251 is responsible for generating Tokens as needed for outgoing signalling units, according to the procedures described in the context of FIG. 4. If a Token is present in an incoming signalling unit, Token Verification module 252 is responsible for establishing its authenticity according to the procedures described in the context of FIG. 6.

If an authentication Token is verified successfully, the signalling unit in which it arrived can be relayed to its recipient or recipients in Protected Multimedia Signalling Infrastructure 1903. If an authentication Token is created successfully, the signalling unit into which it is placed can be relayed to its recipient or recipients in End-to-End Multimedia Signalling Infrastructure 1901. Signalling Relay component 1952 is responsible for this activity. In a preferred embodiment the main relaying function may be implemented as any of several commonly available VoIP signalling (SIP Proxy) application programs, such as the popular sipX suite. This embodiment is shown in FIG. 20 as Standard VoIP Server module 2053. Signalling Relay component 1952 also encompasses Database Distribution module 254, previously described.

In a preferred embodiment, Multimedia AntiSpam Gateway 1950 is designed to operate as a network element that permanently serves a particular Protected Multimedia Signalling Infrastructure 1903. Its components are therefore housed in a specific Programmable Computing Platform 2001. Platform 2001 is chosen to provide highly reliable operation and flexible scalability. Candidates satisfying such requirements are well-known to those skilled in the art, and are available from major vendors such as SUN, HP, Motorola, Intel, and many others. Platform 2001 also includes a Communication Interface 2002 for connecting to a network. This is typically implemented using two or more standard Ethernet links, which are well known to those skilled in the art. Additionally, Platform 2001 provides an Information Storage medium 2003 for holding data required by components Information Security 151 and Signalling Relay 1952, including configuration data such as call routing and Token-verification routing information, and user data distributed to Database Distribution module 254. This is typically implemented as a magnetic “hard disk” module. Platform 2001 and its subsystems are preferably implemented using standard components that are commonly available and well known to those skilled in the art.

FIG. 21 depicts the Setup stage of a multimedia session establishment transaction. A separate Gateway is shown for each of calling and called user, but the scenario also applies if both are served by the same Gateway. The scenario begins in step 2101 with the caller composing and sending a Setup signalling unit to establish a new session. It traverses the sending service provider's infrastructure in step 2102, arriving at the caller's AntiSpam Gateway 1950. Step 2103 shows the calling Gateway authenticating the caller; note that this may be implemented in a cooperative fashion with the remainder of the caller's service provider network infrastructure, and generally uses authentication techniques that are well known by those skilled in the art. In step 2104 the session is counted against the caller's traffic allocation. This is a significant attribute of the present invention. Prior art systems generally take the step of authenticating the caller, but do not prevent callers from generating excessive traffic. Spam tends to be sent in very large quantities; enforcing a traffic limit of, for example, 50 sessions per day for each user can prevent a great deal of spam traffic. Session counting is critical in preventing spam: without it, an automatic process would be able to initiate countless sessions that are all authenticated. The session counting is intended to limit traffic for each caller to a rate that is both humanly possible and insufficient for spammers' purposes. If the session would cause the caller to exceed the allotted traffic volume, it is dropped or rejected. Traffic counts may also be made available to calling users through the appropriate Registry 120 and its External Website module 321. Excessive traffic may indicate the presence of a zombie infection, which may otherwise go undetected.

If the Setup is allowed to proceed, at step 2105 the Gateway decides whether encryption is required, either on the Token to be generated, on the signal relay transaction to come, or both. If so, and no encryption key certificate is already known for the destination Gateway, an Introduction is requested by sending an Introduction Request message, Step 2106, to the superior Network Authority 160 for this Gateway 1950. At Step 2107, Authority 160 retrieves the destination Gateway's certificate, either from its own database or by recursively requesting Introduction via higher level Authorities, depending on whether it is the Authority for the destination Gateway or not; for more detail on this procedure refer to the description of FIG. 22. The certificate is returned to the sending Gateway in Step 2108, the Introduction Response message.

At Step 2109, a Gateway Token 401, 405, or 406 is generated, depending on the Gateway operator's preferences as previously described, and added to the signalling unit as a header. In step 2110 the signal is relayed to the recipient's service provider. Step 2111 depicts the signal, with its Gateway Token, in transit between the two service providers' networks. This transfer operation may be encrypted or unencrypted, depending on Gateway operators' preferences and, optionally, per-user configuration data. If encryption is to be applied, the receiving Gateway's certificate retrieved during Introduction, and the sending Gateway's certificate, are used in the standard way by the Transport Layer Security (TLS) protocol, which is well known to those skilled in the art.

The Setup signal arrives at the AntiSpam Gateway 1950 protecting the called user's service provider's network, and at step 2112, the incoming signal is scanned for the presence of an authentication Token. Since in this scenario one was placed in the message by the calling AntiSpam Gateway 1950, it will be detected. The alternative scenario, in which no Token would be detected, is not shown as it represents standard behavior; a configuration option in the called Gateway may allow an operator to choose to reject all Tokenless (unauthenticated) sessions if desired. To verify the Token, a certificate noting the public key of the calling Gateway is required. If the called Gateway has previously been introduced to the calling Gateway, this certificate may be found in a local memory buffer that is used to retain introduction data. Otherwise, at step 2113 an Introduction is requested. Step 2114 shows this Introduction Request in transit to the superior Authority 160; the request may be forwarded up the hierarchy as far as necessary, even to the Root Authority. The Authority 160 at which the calling Gateway 1950 is known retrieves its certificate in step 2115, and sends it back to the called Gateway 1950 that requested it in step 2116. For more detail on the Introduction protocol, refer to the description of FIG. 22. Back at the called AntiSpam Gateway 1950, with the certificate for the calling AntiSpam Gateway 1950 now available, the Gateway Token may be verified in step 2117, as previously described in Procedure 600. At step 2118, if the verification fails, the session may be dropped because its initiator is inauthentic. Alternatively, the session may be allowed to proceed after adding an indication that the caller is suspect. The called user's terminal may interpret this indication to produce a distinctive ringing or other alternate alerting signal to the user. Called Gateway 1950 may also record the suspect caller's identity and make it available for the called user to examine, possibly to accept future sessions offered without Token. This behavior is directly analogous to the “gray list” and “white list” processing previously described for the Messaging Antispam Gateway 150. At step 2119, if the verification passes, the Setup signal may be relayed to the called user. Prior to relaying, however, the Gateway Token from the calling Gateway 1950 is removed to reduce the likelihood of a replay or known-plaintext attack on the keys caused by unnecessary exposure of Tokens. Finally, at step 2120 the Setup signal, back in its original form, moves to the multimedia signalling client of the called user, which in step 2121 receives and processes it. Note that additional signals are usually needed to complete the session establishment beyond this initial signal. These are not shown, as their handling can be inferred by those skilled in the art. It will either be substantially identical to the Setup signal's handling, in either the reverse direction or the same direction depending on the direction of the signal's flow, or it will simply be the standard message handling without the processing described here, depending on whether the operators of Protected Multimedia Signalling Infrastructures 1903 desire authentication of every signal within the establishment transaction or only the initial one.

FIG. 22 provides a schematic summary of various topologies in the arrangement of Network Authorities 160, User Registries 120, and AntiSpam Gateways 150 or 1950, as they may relate to one another in Spam Prevention Systems 100 and 1900.

This figure depicts several distinct organizational roles a Network Authority 160 or User Registry 120 might play in the network, along with three distinct inter-element relationships. The organizational roles represent different sets of constraints on certain significant behaviors, which make each particular role suitable for certain types of organization. The relationships pertain to how these elements interact with one another to form networks. Note that these relationships represent meaningful interactions, not direct communication links. All communication takes place via Packet Network 102. Also note that the various forms of Client in System 100, and the Protected Infrastructures 103 and 1903 of Systems 100 and 1900 respectively, are not shown in this diagram but are instead implied.

The Authority Network's purpose is to facilitate trustworthy communication among its members. The Introduction process described in other paragraphs uses this network to distribute encryption/authentication certificates to communicating entities so that they can both authenticate one another and protect their communications with one another from other entities. This leads directly to the purpose of Relationship 2201, which is between an entity (Gateway, Registry, or Authority) and an Authority which certifies the authenticity of the entity by signing its encryption/authentication certificate. In order for every entity to trust Tokens, Introductions, and encrypted message/signalling relay from every other entity, there exists a network of certificate authenticity in which every Agent, Gateway, Registry, and Authority participates. This network is depicted in FIG. 22 as a directed graph, with the certification relationships flowing generally downward. Each Gateway has exactly one Relationship 2201 superior, while an Authority or Registry may have multiple Relationship 2201 superiors and many Relationship 2201 inferiors. No peer Relationships 2201 may exist, as there is no meaning within a certification hierarchy for such peering. Thus the entities form a conventional Certificate Authority tree via their Relationships 2201 with one another. At the top of this tree is Root Authority 2200, which acts as the root Certificate Authority for the entire network. Conventional Public-Key Infrastructure technologies and techniques, well-known to those skilled in the art, are used to form this tree.

One or more Alternate Root Authorities 2240 may also exist. Note how combination Registry/Authority 2230 has two Relationship 2201 superiors. This indicates that an element may actually be certified by multiple Authorities. One way to use that feature might be to arrange for a Gateway, or set of Gateways through a common Authority, to use multiple certificates and apply multiple Tokens on each message or signalling unit it authenticates. Each certificate might have different assertions associated with it, requiring different levels or types of scrutiny and verification to obtain. For example, a certificate signed by Root Authority 2200 might guarantee good behavior as a messaging or multimedia service provider, while one signed by Alternate Root Authority 2240 might certify specific off-network business practices. Thus, multi-Authority capability may support multiple reputation services that certify different aspects or attributes of the organizations operating Gateways, Registries, and Authorities. Another usage of this capability might be to provide for redundancy. For example, if a particular Authority were to go out of business or suffer a network failure, a service provider with a Registry could protect its own ability to continue operating by having established a Relationship 2201 with an additional Authority.

Public Authority 2210 and Private Authority 2220 represent Authorities 160 that are operated by different classes of organization, and which have different constraints on their service domain. A Public Authority is permitted to serve any domain (user, enterprise, ISP, etc.) without constraints, while a Private Authority is permitted to serve only those Authorities, Registries, and Gateways that are within its domain namespace. Public combination Registry/Authority 2211 and Private Registry 2221 exhibit similar restraints on their ability to Invite users who may or may not be registered in another Registry (see FIG. 9, FIG. 12, and their descriptions). For example, a Private Registry in a particular Internet Domain Name would only serve Users whose addresses are also in that same Internet Domain Name. Typically, a Public node would be operated by a major ISP or carrier, while a Private node would be operated by an Enterprise or small ISP. For example, Public Authority 2210 might belong to a major ISP serving numerous users and enterprises in multiple domains, while Private Registry 2212, which subtends it in the CA hierarchy, might be a particular Enterprise that is a customer of that ISP but operates its own Registry for security reasons. As another example, Private Authority 2220 might belong to a very large enterprise that requires multiple Registries and Gateways for effective coverage of its network. Note that Root Authority 2200 is a Public Authority; a particular Alternate Root Authority 2240 may be Public or Private. Additional constraints are possible as well. For example, during Introduction as previously described, a particular Authority may choose to ignore or reject queries from arbitrary entities, accepting them only from a set of entities with whose operators the Authority's operators have a pre-existing business relationship. Such a constraint set would create something akin to a closed user group, reflecting in the technology a particular coalition that exists in the business. Gateways, Registries, and Authorities may participate in zero, one, or more such constraint sets. Constraint sets may also be either static or dynamic.

Also depicted in FIG. 22 is the relationship among a Registry 120 and those Gateways 150/1950 that are bound to it as protectors of a particular Protected Infrastructure 103/1903. These entities share data via their respective Database Distribution modules 254 (Gateway) and 323 (Registry). This relationship has been described previously, but is shown here as Relationship 2202 for completeness. Note how Gateways 2231, 2232, and 2213 have both 2201 and 2202 Relationships to combined Registry/Authority nodes 2231 and 2211, while Gateway 2222 is linked by Relationship 2201 to Authority 2220 and separately by Relationship 2202 to Registry 2221. This shows how the Registry and Authority elements may be combined with one another or left distinct depending on operator convenience. Also note that Registry 2212 is shown with no Gateways in its purview. Such a Registry would support only Agents, which are not shown here.

While the Relationship 2201 hierarchy is appropriate for certificate authentication, it is not necessarily optimal for message flow and multimedia signalling flow. Relationship 2204 represents the opportunity for direct inter-Gateway flow of Tokens attached to messages and multimedia signalling, as well as direct inter-Gateway encrypted relays. For such traffic to flow, the entities involved should have exchanged encryption/authentication certificates with one another so that information privacy and authenticity are ensured. These certificates are governed by the certificate authenticity hierarchy formed of Relationships 2201, so every participating node may be assured of the others by validating the certificates up to a common Authority (if necessary, as high as the Root Authority 2200). The certificate exchange process is called Introduction, and its dynamic form was briefly described in the context of FIG. 7 and others. Similarly, Token Verification transactions and even Introduction itself are not necessarily optimally conveyed only between Relationship 2201 pairs. Relationship 2203 represents the opportunity for direct inter-node communication for Token Verification and Introduction. Initial Relationships 2203 are automatically formed in parallel with every Relationship 2201 as a corollary to the initial certificate authentication process, as well as in parallel with every Relationship 2202 as a corollary to the establishment of a Registry and its Gateways. Additional Relationships 2203 and 2204 form through Introduction as demanded by the traffic flow, and may appear anywhere. Any node may be Introduced to any other node, forming a traffic mesh according to the demand. Thus an optimal network is formed dynamically.

Introduction is the process of acquiring an encryption/authentication certificate for another node at a node that needs it. Relationships 2203/2204 (they're really the same thing) are established through this process. Introduction takes one of three forms. The first, Manual Introduction, takes place through configuration procedures upon installation of a node. It is normally used only when establishing a Gateway's relationship to a Registry that is not also an Authority. Manual configuration techniques are well-known to those skilled in the art, and are not further detailed here. The second Introduction form is called Registration, and takes place as an automatic process when installing a Gateway, Registry, or Authority. This process is substantially the same as the ArmorPost Agent Registration process described in ArmorPost, and is not repeated here. The new node's administrator acts as the Agent's user in that procedure. The new node itself contains the registering Agent, while the pertinent Authority runs the Courier side of the procedure. Both of these Introduction forms provide the initial Relationship 2203 between a new node and its parent.

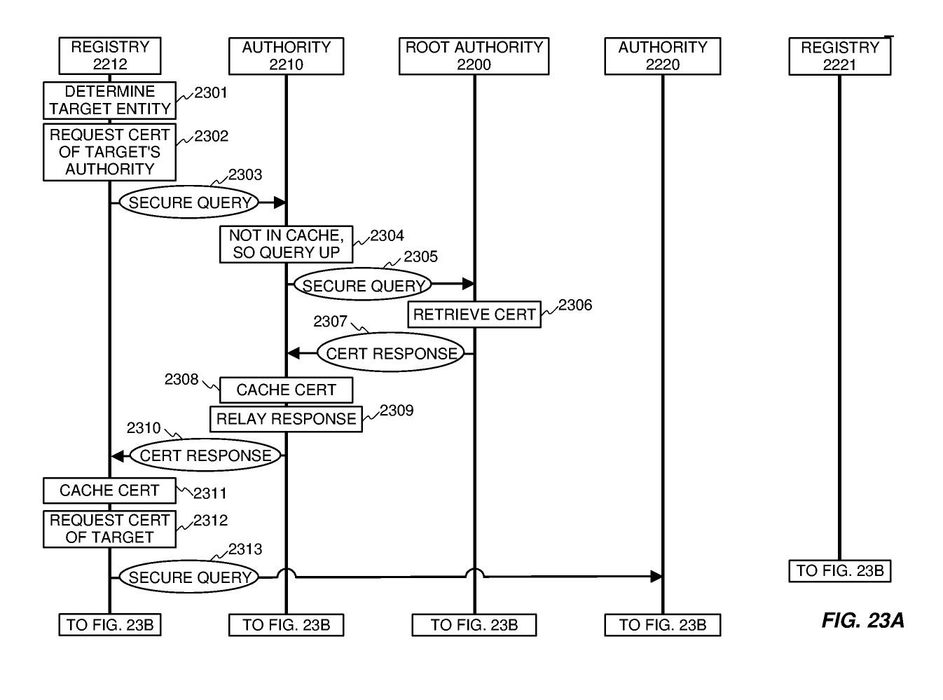

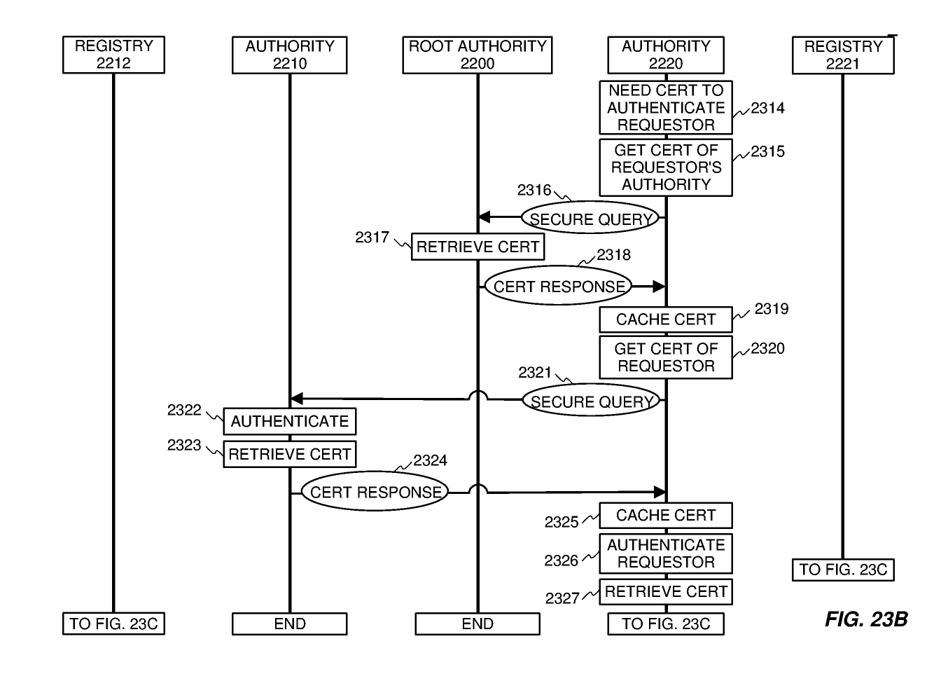

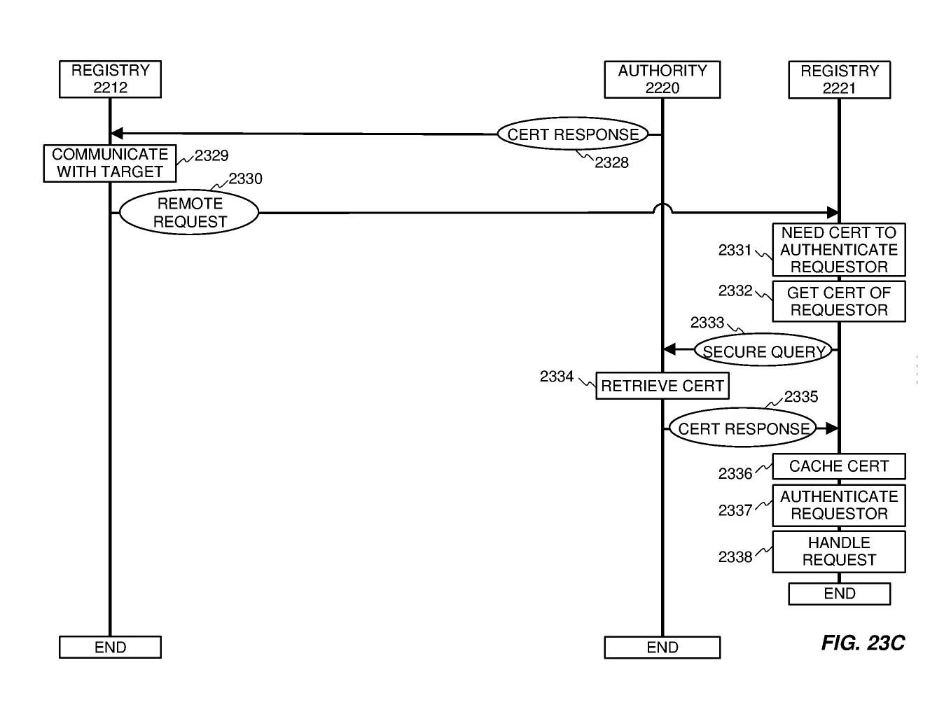

Dynamic Introductions, depicted in brief in FIG. 7 and in detail in FIG. 23, are the third type. They occur after the initial Relationships 2203 are established, and are usually simply called Introductions without the qualifier. These Introductions use an inter-node query protocol to retrieve a certificate from the database of its issuer. That is, rather than trusting a node to share its correct certificate, the certificate is obtained from its Authority instead. Further, Dynamic Introduction can take place only via existing Relationships 2203, so the first query from a node goes to its own Authority, which is initially the only one it trusts. As trusted nodes provide Introductions, additional nodes become trusted, and over time an optimal network of Relationships 2203 forms on demand.

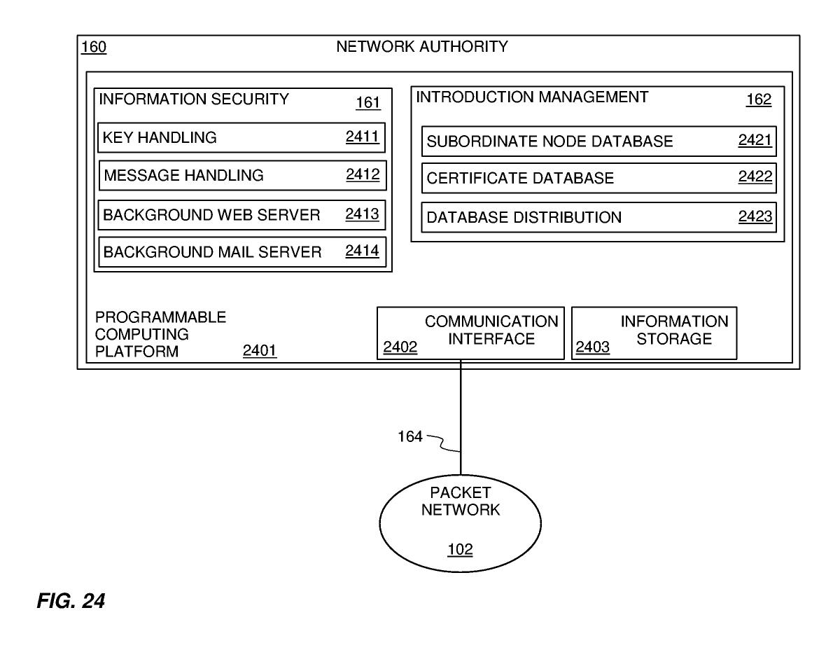

In a preferred embodiment, each Authority keeps the certificates of its subordinate Authorities, Registries, and Gateways in a domain name server (refer to the description of FIG. 24 for structural detail of an Authority). The naming hierarchy is separate from the Internet's Domain Name hierarchy for hostname to IP address translation. This one is rooted in the Root Authority 2200, used only for representing the Authority Network, and not exposed publicly to Internet hosts outside the Authority Network. Note that a public form of a Gateway's Authority Network name, rooted in the public name of the Root Authority but providing the same information about placement in the Authority Network hierarchy, may in general be made available in the routing data for that Gateway's Protected Infrastructure 103/1903, to provide for interoperability between End-to-End Infrastructure 101/1901 and the AntiSpam Gateway 150/1950. For example, the MX record in DNS for a Protected Messaging Infrastructure 103 may name the public form of Messaging AntiSpam Gateway 150's Authority Network name so that other Gateways 150 can know that they are dealing with a Gateway.

Each Authority stores in its name server a record of subordinate Authorities, which are implemented in the preferred embodiment as ordinary sub-domain delegations, and certificates of subordinate nodes, which can use the standard CERT record. Additional hierarchies may exist as well, rooted in corresponding Alternate Root Authorities 2240. The Introduction protocol itself is prefereably a secured implementation of the DNS query protocol. Security may be provided by IPSec or SSL tunneling between Introduced nodes, such that queries on this separate DNS hierarchy are only permitted over encrypted sessions from authenticated nodes via tunnels established by certificate exchange.

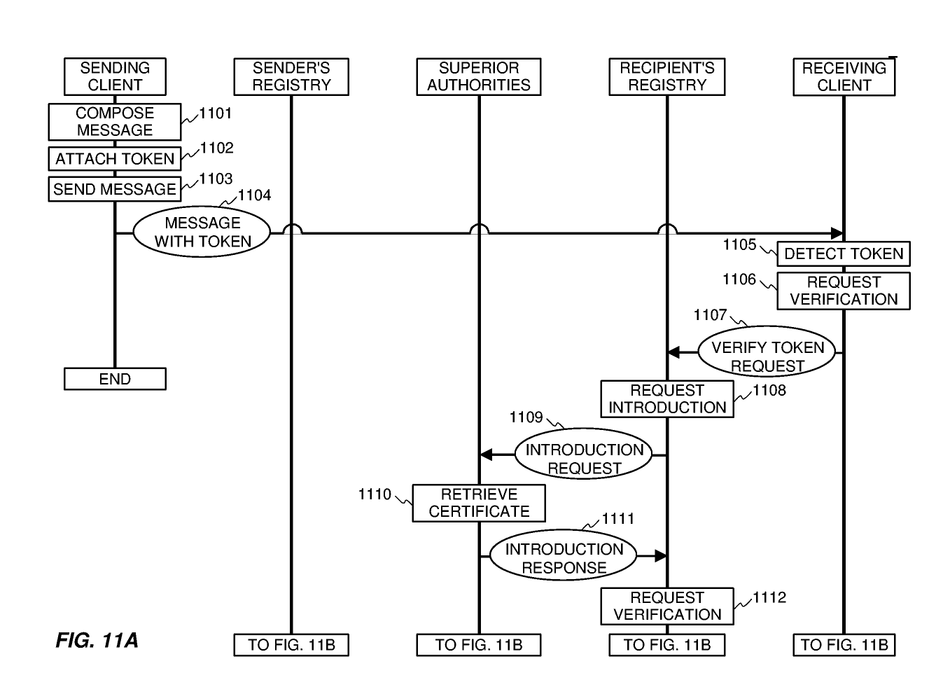

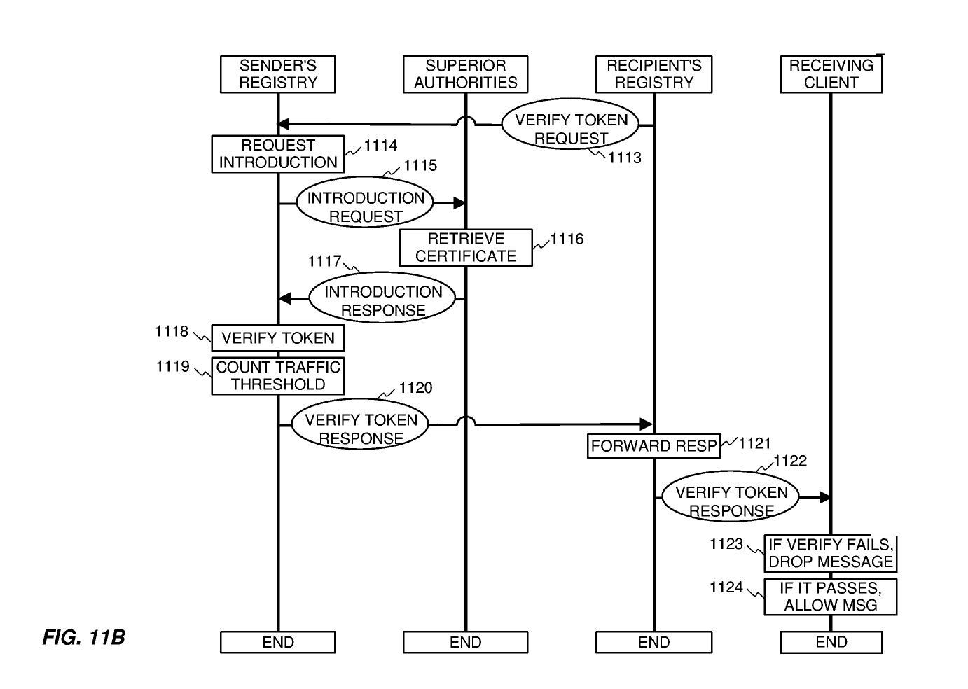

An example Dynamic Introduction sequence is depicted in FIG. 23. Suppose Registry 2212 requires Introduction to Registry 2221 (see FIG. 22 for the entities involved in this example) in order to request verification of a Token issued by one of its Agents (see FIG. 11 for the overall scenario). Having made this determination in Step 2301, Registry 2212 would in Step 2302 securely query Authority 2210 for the certificate of Registry 2221's Authority, Authority 2220. Step 2303 shows the query in transit securely; as previously noted, well-known secure tunnel technologies such IPSec or SSL may be used here. At Step 2304, if Authority 2210 also has not yet established a Relationship 2203 with Authority 2220, it may in turn securely query Root Authority 2200 for that certificate via Step 2305. Since in this example Authority 2220 is directly subordinate to Root Authority 2200, the cert will be in its database, retrieved at Step 2306, and returned in the response shown as Step 2307. In the preferred embodiment this is a DNS query, so the result is cached for future use at Step 2308, thus establishing half of a Relationship 2203 between Authorities 2210 and 2220. Authority 2210 may then at Step 2309 return the certificate of Authority 2220 to Registry 2212 in the response shown as Step 2310. Again, the result is cached at Step 2311. Now, Registry 2212 can attempt at Step 2312 to query Authority 2220 for the certificate of Registry 2221, using the secure query shown as Step 2313. However, upon receiving the query Authority 2220 decides at Step 2314 that it should first authenticate Registry 2212, so at Step 2315 it queries Root Authority 2200 for the certificate of Authority 2210 using the secure query shown as Step 2316. Since in this example Authority 2210 is directly subordinate to Root Authority 2200, the requested cert will be in its database, retrieved at Step 2317, and returned in the response shown as Step 2318. At Step 2319, Authority 2220 caches the cert of Authority 2210 for future use. At Step 2320 Authority 2220 queries Authority 2210 for the certificate of Registry 2212, using the secure query shown as Step 2321. Since Authority 2210 already knows the certificate of Authority 2220 from its previous query, it can authenticate Authority 2220 at Step 2322, retrieve the requested certificate from its database at Step 2323, and provide it to the requester in the response shown as Step 2324. Upon receiving and caching it at Step 2325, Authority 2220 can authenticate the query from Registry 2212 at Step 2326, and give it the certificate of Registry 2221 retrieved from its database in Step 2327, using the response shown as Step 2328. Now Registry 2212 can request the Token Verification from Registry 2221, shown generically at Step 2329 and in transit at Step 2330. However, at Step 2331 Registry 2221 should first authenticate Registry 2212, and so at Step 2332 queries Authority 2220 for the appropriate certificate using the secure query shown as Step 2333. Since the previous Introduction stages have populated caches everywhere, Authority 2220 can at Step 2334 retrieve the correct certificate from its database and return it to Registry 2221 in the response shown as Step 2335. Now at Step 2336, Registry 2221 can cache the received certificate, and at Step 2337 it can authenticate Registry 2212. Finally, Step 2338 shows Registry 2221 handling the communication from Registry 2221. This elaborate sequence establishes trust among all participating parties. Having been Introduced once, the sequence is not required for subsequent communications until cache expiry forces a repeat. Note that choosing cache lifetime is a matter for network engineering, and requires a balance between system performance and the risk of certificate revocation, a practice well known by those skilled in the art.

Detail of a Network Authority 160 can be found in FIG. 24. Structurally, it is substantially similar to a User Registry 120. In particular, Information Security component 161 contains essentially the same modules as Information Security component 121 of Registry 120, with Key Handling module 2411, Message Handling module 2412, Background Web Server 2413, and Background Mail Server 2414 providing substantially the same functions as the like-named modules 311, 312, 313, and 314 of Registry 120; recall that those are in turn substantially the same as corresponding modules in Trusted Courier 120 of ArmorPost. This reflects the usage of the same Registration protocol in all three network elements; in the case of the Network Authority, it is registering Gateways, Registries, and other Authorities that are subordinate to it. Message Handling module 2412 is also charged here with securing inter-node communication that occurs during Introduction, as described above. Note also that the Registry's Account Management component is replaced here by the Authority's Introduction Management component 162. This component is responsible for storing certificates of Registered subordinate nodes and sharing them during Introductions. It also maintains the hierarchy of subordinate nodes, particularly the delegations to subordinate Authorities. To that end, two different but related databases, and a database distribution module are provided. Subordinate Node Database module 2421 identifies subordinate nodes and delegation to subordinate Authorities. Certificate Database module 2422 securely stores issued certificates. Database Distribution module 2423 is responsible for serving those delegations and certificates in response to the Introduction protocol. In a preferred embodiment, this is an ordinary DNS server implementation, such as BIND or djbdns.

As usual, in a preferred embodiment Network Authority 160 is designed to operate as a network server. Its components are therefore housed in a specific Programmable Computing Platform 2401. Platform 2401 is chosen to provide highly reliable operation and flexible scalability. Candidates satisfying such requirements are well-known to those skilled in the art, and are available from major vendors such as SUN, HP, Motorola, Intel, and many others. Platform 2401 also includes a Communication Interface 2402 for connecting to a network. This is typically implemented using two or more standard Ethernet links, which are well known to those skilled in the art. Additionally, Platform 2401 provides an Information Storage medium 2403 for holding data required by the functional components. This is typically implemented as a magnetic “hard disk” module. Platform 2401 and its subsystems are preferably implemented using standard components that are commonly available and well known to those skilled in the art.

While much of the foregoing text describes Registry 120 and Network Authority 160 as distinct elements, in many instances it may be appropriate to deploy them side by side. In particular, large and mid-sized service provider or enterprise networks with multiple Gateways are likely to want both, and combining them may provide sufficient performance economically. The structure of such an embodiment would be readily evident to those skilled in the art by combining the modules and components shown in FIG. 24 and FIG. 3, and so is not shown separately.

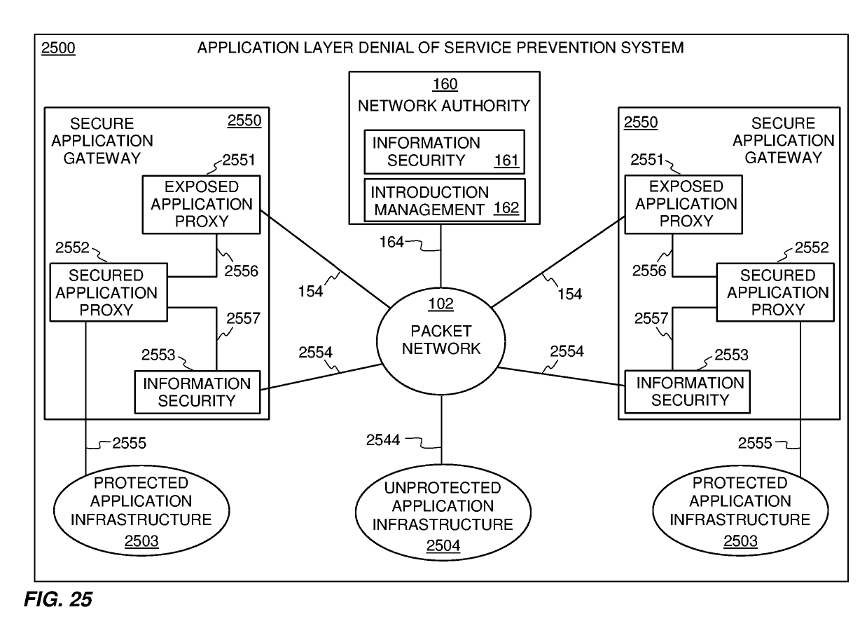

FIG. 25 depicts Application Layer Denial of Service (DoS) Prevention System 2500. Several major elements make up this system. First, Packet Network 102 forms the foundation for all communication among elements. This element is preferably an Internet-based network, and may be the Internet itself, another network like it, or a composite of networks using multiple interworking technologies. Connected to Packet Network 102 is at least one Network Authority 160. This entity is substantially the same, with substantially the same role, as the Network Authority 160 already described in previous paragraphs. Network Authority 160 attaches to Packet Network 102 via a packet transfer interface 164, which may take any available form as is well known to those skilled in the art.

The applications contemplated for protection by the elements of System 2500 are traditionally provided by a variety of clients, servers, and network arrangements that are well known to those skilled in the art. These arrangements are represented in System 2500 by Unprotected Application Infrastructure 2504, which in turn attaches to Packet Network 102 via a packet transfer interface 2544 that is substantially similar to other packet transfer interfaces already described. Included in Unprotected Infrastructure 2504 may be, for example, mail servers for messaging, SIP proxies for multimedia communications such as VoIP, and web servers for transaction-oriented services and hypertextual information services.

System 2500 includes one or more Protected Application Infrastructures 2503, and one or more Secure Application Gateways 2550, each pair of which is connected via a packet transfer interface 2555 that is substantially similar to other packet transfer interfaces already described. Protected Infrastructures 2503 comprise well-known clients, servers, and network arrangements for providing the contemplated applications, and may be substantially identical to Unprotected Infrastructure 2504. They are, however, shown as separate entities because instead of attaching directly to Packet Network 102, where Unprotected Infrastructure 2504 is exposed to both desirable and potentially damaging network traffic, each one is protected by a Secure Application Gateway 2550, which provides mechanisms whereby its Protected Infrastructure 2503 handles only desirable traffic and is protected from Denial of Service attacks.

Each Secure Application Gateway 2550 attaches to Packet Network 102 via two distinct packet transfer interfaces 154 and 2554. Though distinct from one another, they are substantially similar both to one another and to other packet transfer interfaces previously described, excepting obviously their network addresses. Interface 154 is intended to carry the packet traffic to which Protected Infrastructure 2503 would be exposed if it were unprotected; that is, standard network application traffic and malicious DoS traffic as would be experienced by Unprotected Infrastructure 2504 via interface 2544. Interface 2554 is intended to carry only secured network application traffic among Protected Infrastructures 2503 via Gateways 2550. However, in general interface 2554 will be presented with malicious traffic by nefarious entities in Packet Network 102, just as interface 154 is. The aforementioned intent is therefore strictly enforced via the DoS-prevention methods described in the paragraphs which follow.

Secure Application Gateway 2550 comprises three primary modules, which are outlined here and described in detail below. Interface 154 attaches within Gateway 2550 to an Exposed Application Proxy module 2551. This module presents to Packet Network 102 as if it were the corresponding application entity or entities in Protected Infrastructure 2503. For example, if a Gateway 2550 is added to the network in front of an existing Infrastructure 2503, it may use exactly the same network addresses as Infrastructure 2503 had been using. Thus, peer application infrastructures across Packet Network 102 may continue to interact with said Infrastructure 2503 without change. Similarly, interface 2555 attaches within Gateway 2550 to a Secured Application Proxy 2552. This module presents to Protected Infrastructure 2503 as if it were Packet Network 102, again allowing a Gateway 2550 to be added to the network in front of an existing Infrastructure 2503, which in turn can continue interacting with peers across Packet Network 102 without change. Finally, interface 2554 attaches within Gateway 2550 to Information Security module 2553, which is designed to provide encrypted communication with other Gateways 2550 and to ignore incoming packets that are not from other Gateways 2550. These three modules interact with one another in restricted ways to ensure that traffic flowing through Information Security module 2553 is given priority over traffic flowing through Exposed Application Proxy 2551 when passing it back to Protected Infrastructure 2503 via Secured Application Proxy 2552. These controlled interactions take place on interface 2556 between Secured Application Proxy 2552 and Exposed Application Proxy 2551, and on interface 2557 between Secured Application Proxy 2552 and Information Security module 2553. Note how Exposed Application Proxy 2551 and Information Security module 2553 do not interact directly; Secured Application Proxy 2552 controls the flow of traffic.

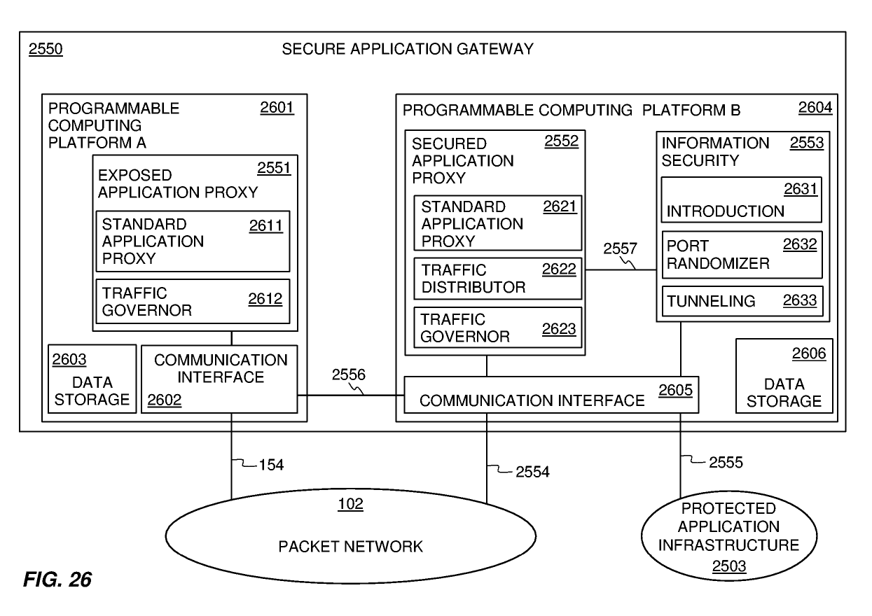

Further detail on Secure Application Gateway 2550 is found in FIG. 26. Gateway 2550 is designed to operate as a network element that permanently serves a particular Protected Application Infrastructure 2503, so its functional modules operate in the context of a computing platform. In a preferred embodiment, two such platforms are used, so that the processing of protected traffic is not affected by the potential load from arbitrary traffic. Programmable Computing Platform A 2601 is assigned the arbitrary traffic handled by Exposed Application Proxy 2551, while Programmable Computing Platform B 2604 handles the protected traffic running through Secured Application Proxy 2552 and Information Security module 2553. Platforms 2601 and 2604 are chosen to provide highly reliable operation and flexible scalability, and are preferably integrated into a single package. They may be implemented as two or more general-purpose processors, or as a combination of general-purpose processors and specialized network processors depending on performance requirements at a particular installation. Candidates satisfying such requirements are well-known to those skilled in the art, and are available from many vendors. Each platform includes its own Data Storage and Communication Interface components as shown in the figure. Communication Interfaces 2602 and 2605 may be implemented using two or more standard Ethernet links, which are well known to those skilled in the art. Communication Interface 2605 may also include an Ethernet switch, another well-known technology, to facilitate the transfer of application signalling between Exposed Application Proxy 2551 and Protected Application Infrastructure 2503 as appropriate via interface 2556. Data Storages 2603 and 2606 are typically implemented as magnetic “hard disk” modules, but may be implemented using any appropriate storage medium. Platforms 2601 and 2604, and their components, are preferably implemented using standard products that are commonly available and well known to those skilled in the art.

Exposed Application Proxy 2551 comprises a Standard Application Proxy 2611 and a Traffic Governor 2612. Standard Application Proxy 2611 provides the usual capabilities of such software, well known to those skilled in the art, as appropriate for the application being handled. For example, for the messaging application this would be an Internet-facing mail server (messaging transport agent, or MTA) whose job is to screen incoming mail and provide a controlled source for outgoing mail according to the needs of Protected Infrastructure 2503. In the preferred embodiment this is a Messaging AntiSpam Gateway 150, but other popular and well-known MTAs with typical features such as spam filtering and authentication may also be used. Similarly, for a multimedia application this could be an ordinary SIP Proxy, but the preferred embodiment is a Multimedia AntiSpam Gateway 1950. Suitable well-known proxies are also available for other applications.

Traffic Governor 2612 serves to throttle the flow of arbitrary incoming traffic into Protected Infrastructure 2503. It cooperates with Traffic Governor 2623 (described below) to ensure that incoming traffic allowed through by Standard Application Proxy 2611 is queued whenever necessary so that protected traffic flowing through Secured Application Proxy 2552 has precedence on interface 2555. Any of several known mechanisms may be used to effect this flow control. In a preferred embodiment, Standard Application Proxy 2611 may be configured such that incoming messages are queued after being approved, and the queue is only transmitted on interface 2556 to Protected Infrastructure 2503 when explicitly commanded by Secured Application Proxy 2552. The explicit command may be implemented using the SMTP ETRN protocol, or any other suitable mechanism. In an alternate embodiment, Secured Proxy 2552 may keep interface 2556, through which arbitrary traffic must flow if it is to reach Protected Infrastructure 2503, disabled except when such traffic is permitted. A combination of these two techniques may also be used. A predetermined schedule, a lack of protected traffic at any time, or some combination of these may be used to trigger the enabling of interface 2556 and/or the processing of the queue.

Secured Application Proxy 2552 comprises a Standard Application Proxy 2621, a Traffic Distributor 2622, and a Traffic Governor 2623. Standard Application Proxy 2621 is similar to Standard Application Proxy 2611, in that it draws upon existing or previously described technology. However, where Proxy 2611 provides screening of what may be considered “wild” incoming transactions against plainly malicious intent, Proxy 2621 instead screens outgoing transactions from Protected Infrastructure 2503, ensuring, for example, that they do not exceed allowable per-user numbers or that they interact only with permitted correspondents. No screening is required on incoming messages here, because they are protected by Information Security module 2553, both at this Gateway 2550 and its correspondent Gateways 2550, as will be described later. Here again, in the preferred embodiment this is a Messaging AntiSpam Gateway 150 or Multimedia AntiSpam Gateway 1950, or another suitable well-known proxy, according to the application being transacted.

Traffic Distributor 2622 exists to route transaction signalling among the various entities within Gateway 2550. Incoming protected traffic arriving from Information Security module 2553 on interface 2557 is given to Proxy 2621 for processing, as is outgoing traffic from Protected Infrastructure 2503. Incoming traffic already processed by Proxy 2621 is passed out interface 2555 to Protected Infrastructure 2503. Outgoing traffic from Proxy 2621 is offered first to Information Security module 2553, via interface 2557, so that it may determine whether a particular destination is protected by another Gateway 2550. If there is no Gateway 2550 at the other end, Traffic Distributor 2622 passes the traffic instead to Exposed Application Proxy 2551 via interface 2556 for transmission into Packet Network 102 via interface 154.

Traffic Governor 2623 is the secure-side counterpart to Traffic Governor 2612. Its job is to decide when the level of protected traffic is low enough that approved incoming arbitrary traffic can be released into Protected Infrastructure 2503. As previously described, this decision may be based on a predetermined schedule, a lack of protected traffic at any time, or some combination of these. Lack of traffic may be detected by tracking the length of any traffic queues managed by Proxy 2621, or by monitoring the bandwidth utilization on interface 2555, or by any of several other means which are well known to those skilled in the art. Also as previously described, in a preferred embodiment the arbitrary traffic is commanded to be released using an explicit command via interface 2556, or in an alternate embodiment Traffic Governor 2623 may keep interface 2556 disabled except when such traffic is permitted. A combination of these two techniques may also be used.

Information Security module 2553 provides the cryptographic functions required to protect outgoing application traffic and to guard Secured Application Proxy 2552 from “wild” incoming traffic. It comprises an Introduction component 2631, a Port Randomizer 2632, and a Tunneling component 2633.

Introduction component 2631 manages the Introduction protocol, described in the context of FIG. 23 above, by which Network Authorities 160 deliver cryptographic key certificates to Gateways 2550. Key certificates are used for transaction data encryption, correspondent authentication, and transport layer port selection as described below. Note that, due to synchronization requirements driven by the needs of Port Randomizer 2632, for System 2500 the Authority Network described in the context of FIG. 22 above is enhanced, using standard capabilities well known to those skilled in the art, to provide Network Time Protocol services down through the tree. This way every Gateway 2550 is operating with the same view of the time.

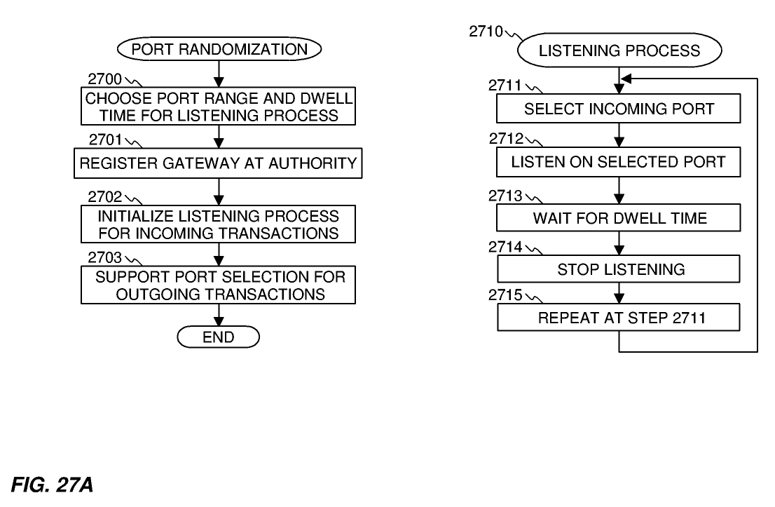

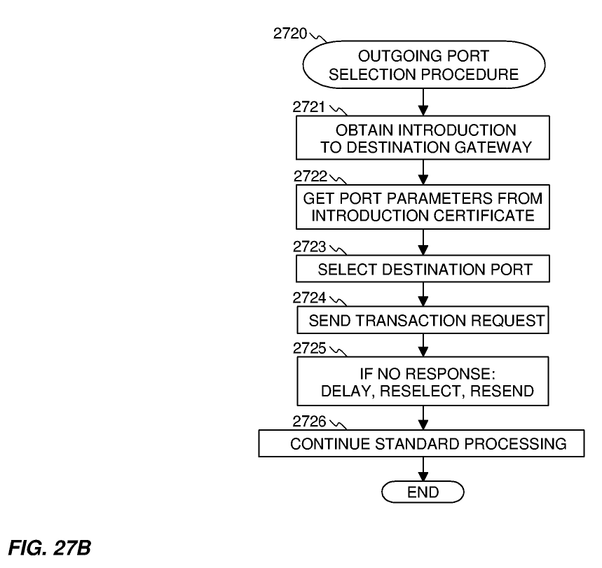

Port Randomizer 2632 is responsible for dynamically selecting the incoming port to which Gateway 2550 listens for incoming protected traffic, as well as identifying the port at a destination Gateway 2550 to which outgoing protected traffic should be sent. The procedure Port Randomizer 2632 follows is described below in the context of FIG. 27. Because this process effectively blocks all incoming packets, of any application or protocol, which are not synchronized to the sequence chosen by Port Randomizer 2632, it is in essence a firewall process. In an alternate embodiment, Port Randomizer 2632 may be duplicated in or delegated to a separate firewall router network element, such as are well known to those skilled in the art, thereby further improving the protection provided by the total network beyond that offered by Gateway 2550 alone.

Finally, Tunneling component 2633 provides encryption and authentication of application data flowing between instances of Gateway 2550. It uses the cryptographic key certificates provided by Introduction component 2631 in standard fashion, well known to those skilled in the art.

Turning now to FIG. 27, the procedure by which Port Randomizer 2632 operates is shown as a series of actions. The procedure begins at step 2700, in which a Gateway's administrator chooses, either specifically or through default values, a port range, a dwell time for each port to be selected while listening for incoming traffic, and an algorithm identifier for selecting the port that should be open at any given time. These parameters are chosen for optimal balance between several measures: computation intensity at both the listening Gateway 2550 and any other Gateway 2550 offering traffic to the listener; the probability of an attack finding the currently open port at any given time and thereby being able to inject “wild” traffic to the Secured Application Proxy 2552; the probability of a legitimate transaction initiation missing the correct open port due to latency in Packet Network 102; the number of applications being supported at the same Gateway 2550; and the planned balance between incoming and outgoing traffic. An optimal port range will generally be, simply, as wide as possible. Of the 2\hat{ }16 values in the TCP port number, the lowest 2000 or so should be avoided simply because the standard ports for most applications are in that range, and DoS attackers may attempt to hit them without regard for whether any service is actually deployed there. Some range should also be reserved for the incoming side of outgoing transactions. The port range for incoming transactions does not have to be contiguous. A total of at least 50,000 ports will generally provide satisfactory performance. The dwell time is chosen to accommodate the expected latency of Packet Network 102; the usual expected Internet performance, which drives the standard timeouts in TCP and other protocols, will drive a fairly long dwell time on the order of 5-10 minutes. Shorter dwell times provide better attack avoidance, and the Internet's packet latency is generally much shorter than the worst case to which TCP is designed. Therefore, a dwell time as short as 15 seconds offers a reasonable default; other values may be chosen in implementations with different performance expectations. The algorithm is chosen from among several cryptographic hash functions that are widely known to those skilled in the art. Combining the 15 second default dwell time with the 50,000 default ports and a hash function with high entropy yields an average time between repeated ports of more than 8 days. It is this behavior that ensures no illegitimate traffic will reach the Secured Application Proxy 2552.

After choosing randomization parameters, the process moves forward at step 2701 to register the Gateway 2550 to which those parameters apply in the appropriate Network Authority 160. Registration is already described above in the context of FIG. 22 and FIG. 24; to summarize again, the approach includes generating an asymmetric encryption key pair for the Gateway, certifying it at the Authority, and entering the Gateway in the Authority's private DNS in support of future Introductions. This process enhances that one slightly by encoding the randomization parameters in the certificate. That allows a transaction initiator, properly Introduced, to find the correct port number. The resulting certificate is called an Introduction Certificate in the remainder of this specification.

The next two steps prepare the Gateway 2550 for incoming and outgoing transactions. Step 2702 initializes the listening process, whereby Gateway 2550 opens a port for incoming transactions, closes it after the dwell time, and repeats endlessly; the loop is detailed below as sequence 2710. Step 2703 creates support for selecting the correct port at another Gateway 2550 when initiating outgoing transactions; the subroutine is detailed below as sequence 2720.

Sequence 2710 is the loop in which Gateway 2550, and specifically Port Randomizer component 2632, listens for incoming transactions from other Gateways 2550, while ignoring offered transactions from unauthorized sources. It begins at step 2711 with the selection of a port number from the configured port range. Port selection uses the configured encryption algorithm, one of several available one-way hash functions with high entropy, into which is fed the public key from the Gateway's certificate and the current time. Specifically, the time is truncated to a resolution matching the configured dwell time, then interleaved with the public key, and the result is hashed. The hash value, modulo the total size of the port range, becomes an index into the list of candidate port numbers (remember that the entire port range need not be contiguous), and the port number at that index is chosen. This algorithm is designed to produce a new port number in constant time, so that the performance of Port Randomizer 2632 is consistent. A true pseudo-random number generator is not used specifically because synchronizing to its current value at a transaction initiator generally requires computation time proportional to the amount of time that has elapsed since the sequence began; such behavior would not be conducive to high-performance networking.

The security of this algorithm depends on two factors. First, the Authority network and the Introduction process are designed to ensure that only certified network members, such as Gateways 2550, are permitted to receive certificates; at the same time, the usage of those certificates is constrained so that they do not leak into the normal public SSL space. Thus the public key, a major input to the algorithm, is maintained as a shared secret within the network. Second, the allowable hash functions are those with high entropy, so that for a particular sequence of timestamps input to the algorithm, the resulting port number sequence appears random and is well distributed.

With a port number selected, at step 2712 the Gateway 2550 then opens that port to listen for incoming transaction requests from Packet Network 102; in a preferred embodiment this network is the Internet, and the incoming transaction request is a TCP SYN packet. Step 2713 indicates a timeout operation; Gateway 2550 listens on the current port for the duration of the configured dwell time. If transaction requests arrive they are handled according to the correct protocol; if none arrive no work is done. At the end of the dwell time, at step 2714, the current port is closed, such that further transaction requests addressed to that port are ignored. Transactions that have commenced on an incoming port during the dwell period for that port may be handled according to one of two approaches. The port may remain open for continuing transactions only, or the continuing transactions will change port number along with the listener. In a preferred embodiment, one of these approaches is chosen prior to implementation of all Gateways 2550. In an alternate embodiment, either approach may be used as long as the one configured at a particular Gateway 2550 is encoded in its Introduction Certificate as an additional randomization parameter so its correspondents can know to behave accordingly.

Finally, the loop continues at step 2715, in which the process returns to step 2711 and repeats indefinitely from there.

Sequence 2720 is the subroutine used when opening an outgoing transaction, to select the correct destination port at the destination Gateway 2550. First, at step 2721 the originating Gateway 2550 acquires the Introduction Certificate of the destination Gateway 2550. It does this by asking its Network Authority 160 using the Introduction procedure. Recall that that procedure allows Introduction Certificates to be cached locally, so the query may go through the local cache on the way and find it there. Once obtained, at step 2722 the randomization parameters are extracted from the certificate, and at step 2723 those parameters and the current time are run through the same algorithm described above to produce a destination port number. In implementations that expect significant and reasonably consistent packet latency across Packet Network 102, the time fed into the port selection algorithm may be incremented by the anticipated latency prior to truncation, to reduce the probability of missing the open port at the other end. Note that for this to work, all Gateways 2550 require a synchronized sense of the current time, which is easily accomplished by distributing the standard Network Time Protocol (NTP) through the Authority Network.

Step 2724 launches the transaction request toward the destination Gateway at the selected port; in the preferred Internet-based Packet Network 102, this would be a TCP SYN packet. In prior art systems, if no response is received to this transaction request, the transaction may be abandoned or deferred. In the present invention, there is a non-zero probability that unanticipated network latency may cause the selected port to have been closed by the time the transaction request arrives at the destination Gateway. Therefore, step 2725 calls for the originating Gateway to delay a fraction of the dwell time if the timeout is an integer multiple of the dwell time, then recompute the destination port and retry the transaction request. If the transaction request times out a second time it is safe to assume the destination Gateway is down. Therefore in step 2726 standard TCP processing is used to complete the transaction, either successful or not.

The next two figures are message sequence charts depicting the flow of a transaction in System 2500. They are distinguished by whether or not the destination server is protected by a Gateway 2550. In both cases, the transaction originator is so protected. Two omitted cases exist as well. If neither the originator nor the destination has a Gateway 2550, the present invention has no effect and therefore no description is required. If the destination has a Gateway 2550 but the originator does not, the transaction enters the destination Gateway 2550 through its Exposed Application Proxy 2551. As has been described previously, the transaction is handled according to the capabilities of the implemented Application Proxy 2611, then if allowed to proceed it is forwarded through to the Protected Infrastructure 2503 at the discretion of Traffic Governors 2623 and 2612. No other depiction is necessary.

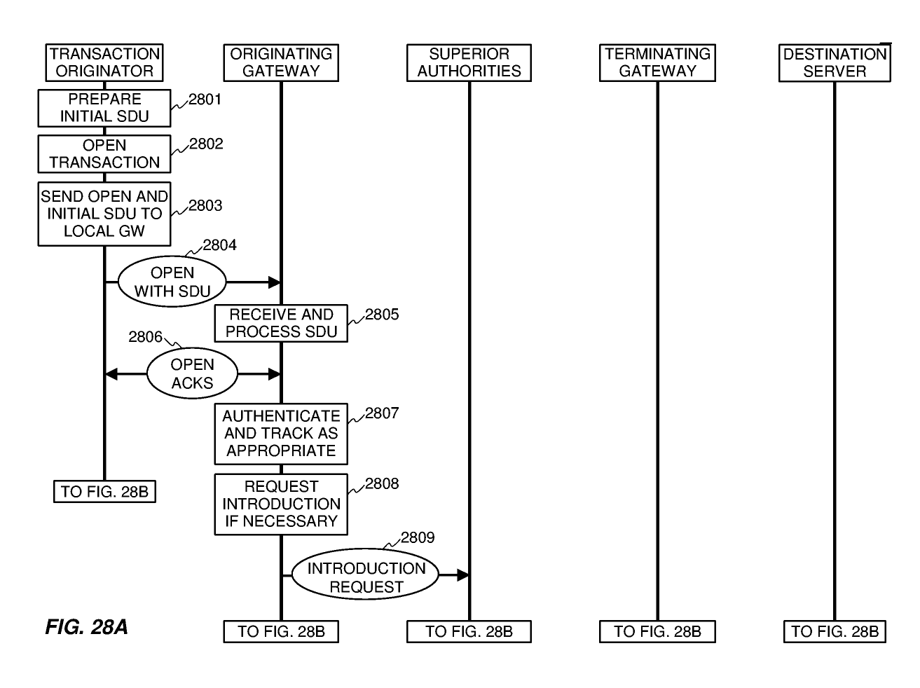

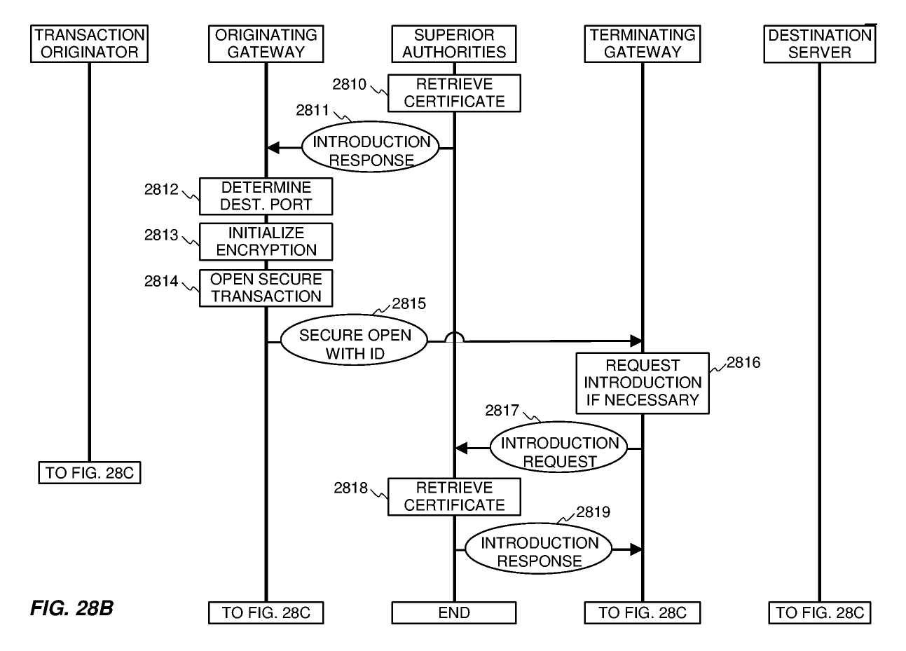

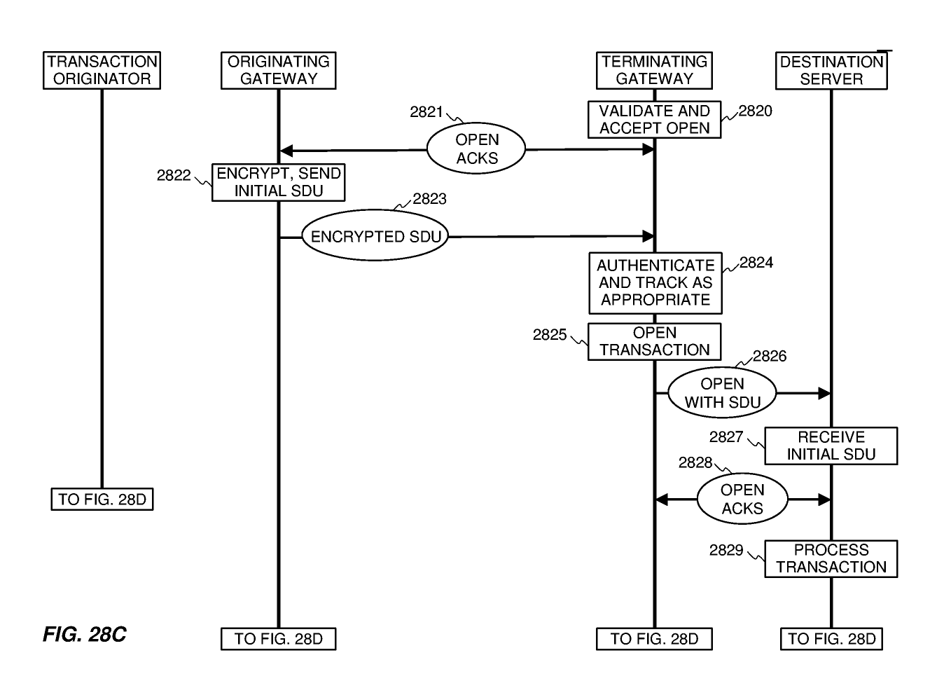

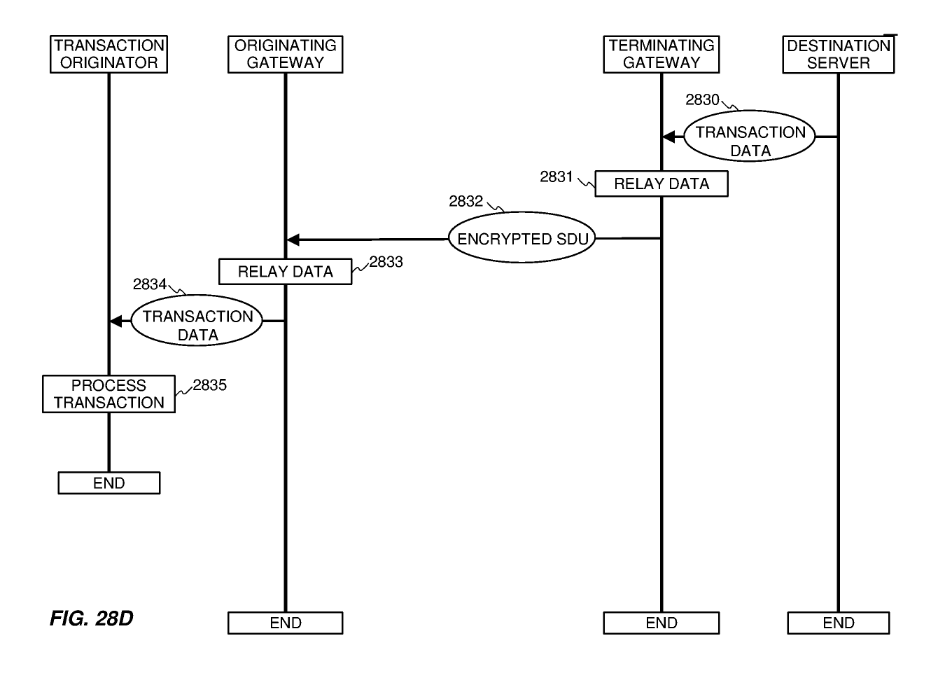

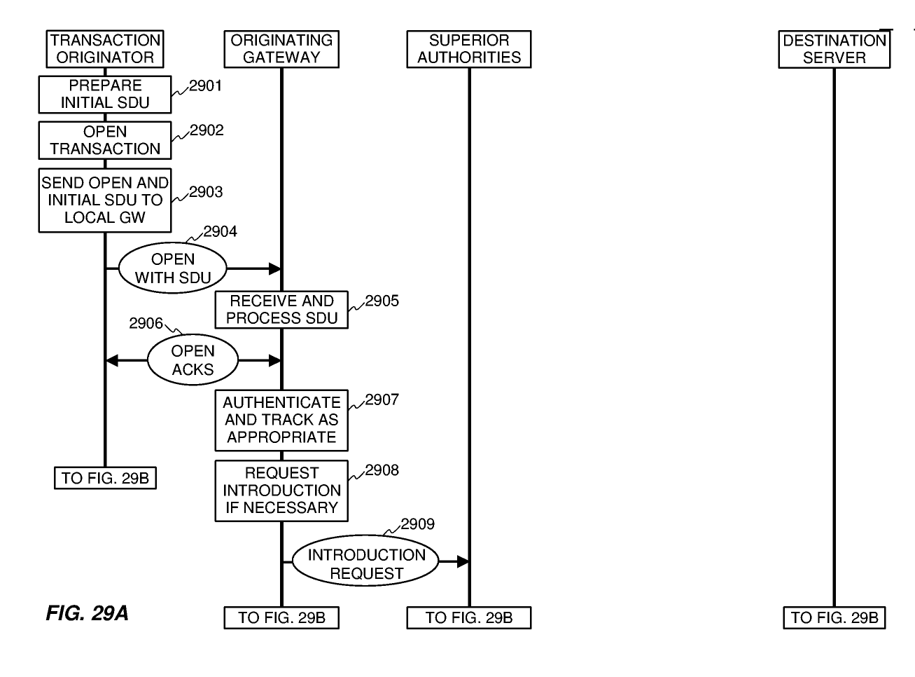

FIG. 28 shows the flow for a transaction between two Gateways 2550. In step 2801, the originator decides a transaction is required and builds the protocol element that will be carried as the initial signalling data unit (or SDU) for the transaction. This initial SDU may contain a setup or other request structured according to the protocol of the application at hand. The originator may be a mail server relaying a message, a SIP proxy initiating a call, a web server requesting information from another web server, some other kind of server, or some kind of client. At the appropriate time, the originator will in step 2802 take action to open a transaction to the destination server, generally identifying the destination by name and application by name or port number to a networking module in the platform executing the originator's function. Note that if the application has a standard port number, it is used at this stage; the originator's behavior is not altered by the presence of the Gateway 2550. That networking module will in step 2803 route the transaction request and initial SDU toward the destination server. The originator may be explicitly configured to route through the originating Gateway 2550, or the Protected Infrastructure 2503 in which the originator exists may be configured to do so regardless of requested destinations. In any case, the transaction request and initial SDU are in step 2804 transmitted to the originating Gateway 2550. Referring back to FIG. 25 and FIG. 26, the request arrives over packet transfer interface 2555 at Secured Application Proxy 2552, which at step 2805 receives it and begins to process it. Generally, its first act will be to acknowledge the transaction request according to the transport protocol, shown as the bidirectional transfer of acknowledgments in step 2806. In the Internet-based preferred embodiment of Packet Network 102, these are the SYN/ACK and ACK used in TCP.

At this point the transaction is open between the originator and the originating Gateway 2550. That Gateway will at step 2807 perform any authentication that may be required either by the application protocol or the Gateway policy. For example, mail clients may be identified using the SMTP AUTH protocol, or a web server may be authenticated using SSL. This establishes that the originator is valid. Also in step 2807, the transaction may be tracked against the originator's traffic accounting, according to the principles previously described. This accounting serves two purposes. First, it allows the Gateway 2550 to establish a baseline normal traffic pattern for the particular originator. Second, it allows the Gateway 2550 to compare that originator's recent traffic against the baseline and determine whether the transaction at hand represents normal traffic or something that may indicate misuse such as spam or participation in a distributed denial of service attack. If misuse is detected, whether intentional or driven by a zombie infection, the originator's transaction may be abandoned at this point to prevent further damage.

Assuming the transaction is allowed to proceed from here, though, at step 2808 the Introduction component 2631 of originating Gateway 2550 will attempt to determine whether the true destination is protected by its own terminating Gateway 2550. If no record of the destination is found in its cache, Introduction component 2631 will request an Introduction from its superior Network Authority 160. The Introduction Request is shown in transit in step 2809. In step 2810, since in this scenario there is a terminating Gateway 2550, the appropriate Network Authority 160 retrieves its address and Introduction Certificate. Those are returned to the originating Gateway in an Introduction Response, which is shown in transit at step 2811. Note that only the simplest Introduction is depicted here. Refer to the descriptions of FIG. 22 and FIG. 23 for complete details on this protocol and the variety of Authority arrangements that are possible.

Upon receiving the Introduction certificate of the terminating Gateway 2550, originating Gateway 2550 at step 2812 selects the timely destination port as previously covered in FIG. 27. In step 2813, it initializes the encryption tunnel used to communicate with terminating Gateway 2550, which also uses the information in the Introduction certificate along with well-known secure tunnel technology as provided by Tunneling module 2633. Now the encrypted transaction can be opened between originating and terminating Gateways 2550 at step 2814. Step 2815 shows an encrypted transaction request in transit from one to the other; this request also carries information so that the terminating Gateway 2550 can know the identity of the originating Gateway 2550. When the request arrives at terminating Gateway 2550, its first action at step 2816 is to determine whether an Introduction certificate is available for originating Gateway 2550, and if not to request on Introduction from its own Network Authority 160. This Introduction is shown as steps 2817, 2818, and 2819, and is substantially similar to the Introduction in steps 2809, 2810, and 2811.

With the originating Gateway's Introduction certificate now known, the terminating Gateway's Introduction module 2631 can at step 2820 verify the other's identity and allow its networking module to accept the transaction request. Acknowledgements are exchanged in the encrypted tunnel at step 2821. The originating Gateway's Secured Application Proxy 2552 and Tunneling component 2633 can now, as step 2822, encrypt and send the initial SDU of the application protocol; this SDU is shown in transit in step 2823.

Upon the initial SDU's arrival at terminating Gateway 2550, the Secured Application Proxy 2552 at that end handles it in step 2824 by performing any authentication of the originator that may be appropriate in the application's protocol, and tracking the transaction against the destination's traffic records. As previously described for messaging and multimedia signalling traffic, or using similar techniques that fit whatever other application is being handled here, excess or inappropriate traffic may be blocked and reported to users and administrators. If the traffic pattern indicates that the destination is the target of a Distributed Denial of Service (DDoS) attack in which the sender may be participating, this observation may also be reported back to the originating Gateway 2550 for further action by an administrator or user there. Though this action is not shown in FIG. 28, it is implied by the reference to tracking in step 2824.

Assuming the transaction is allowed to proceed, at step 2825 the Secured Application Proxy 2552 of terminating Gateway 2550 opens the transaction through to the actual destination server. The standard port for the application at hand is used, so that the destination server does not have to be modified in any way due to the presence of terminating Gateway 2550. The transaction request, along with the same initial application SDU constructed at the originator and passed along throughout this flow, is transmitted to the destination server in step 2826. There, it is received at step 2827, the transaction request is acknowledged in step 2828, and the application transaction is processed normally in step 2829.

In many applications, additional data may flow between the originator and the destination server. Steps 2830 through 2835 depict the flow of transaction data back from the destination server to the originator. Since the Gateways act as proxies, even though the originator and the destination server think they are in direct communication with one another, in actuality they are in direct communication only with their respective Gateways. Thus, the Gateways relay transaction data as well as transaction requests on behalf of their protected infrastructures. This is actually a good thing, because the inter-Gateway flow is shielded from tampering and interception by the use of an encrypted tunnel, and the protected infrastructures are shielded from wild traffic, whereas a direct flow between originator and destination server would not be so protected. In the figure, steps 2830, 2832, and 2834 show the transaction data in transit on each leg of the path in turn, while steps 2831 and 2833 show the Gateways relaying the data through their respective Secured Proxies. Finally, step 2835 is shown processing the transaction data at the originator. Similar steps, not shown but readily apparent in light of those that are shown, would occur in the opposite order for flow in the opposite direction.

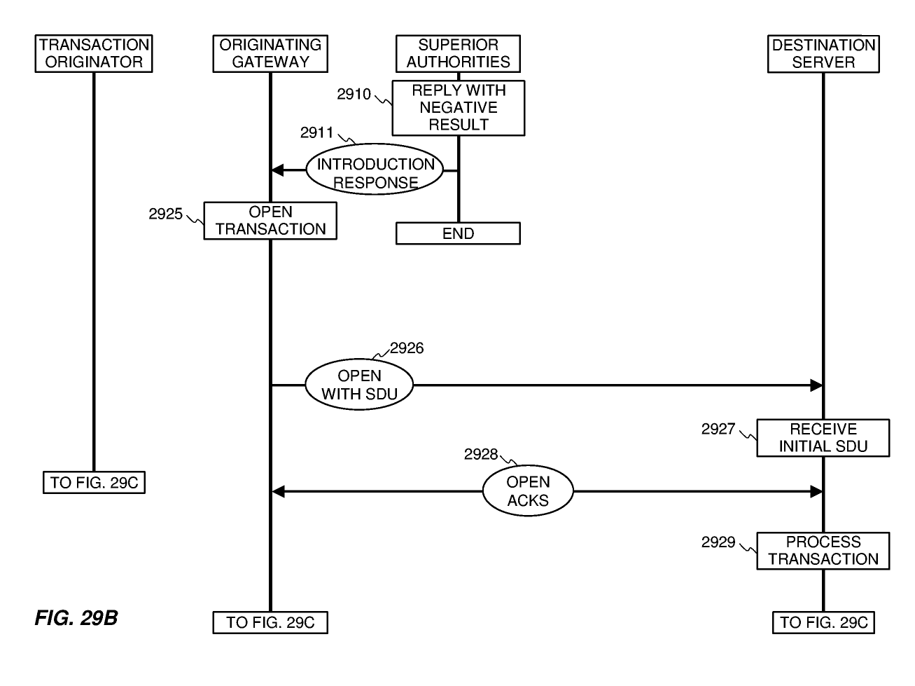

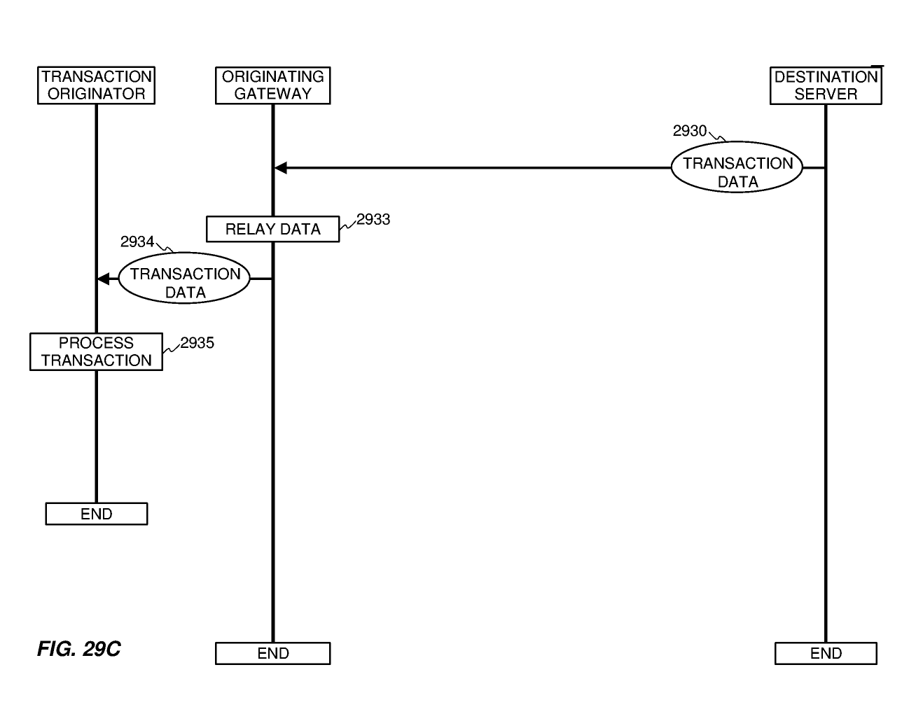

FIG. 29 depicts the scenario in which the originator is protected by an Originating Gateway 2550, but the destination server is not. The flow in this case is a strict subset of the flow in FIG. 28. Steps 2901 through 2909 are substantially the same as steps 2801 through 2809. At step 2910, however, the Network Authority determines that the destination is not protected by a Gateway. It is also possible that the Network Authority is configured to prevent secure communication between the particular originating and destination Gateway pair, after the fashion of the Authority network constraint sets described in the context of FIG. 22. In either case, the Network Authority therefore replies to the Introduction Request with a negative result; no Introduction occurs. This response is shown in transit in step 2911, and upon its arrival originating Gateway 2550 recognizes that it will interact directly with the destination server itself. Therefore, no counterparts to steps 2812 through 2824 occur in this scenario, and at step 2925 the originating Gateway opens an unencrypted transaction to the destination server. A subtle but significant difference between step 2925 and step 2825 is that in this case, Secured Application Proxy 2552 hands the transaction over to Exposed Application Proxy 2551 inside originating Gateway 2550, so that the latter handles unprotected transactions with destination servers across Packet Network 102. This further protects Secured Application Proxy 2552 by avoiding exposure of its address to insecure servers. It also prevents unintended establishment of SSL sessions (secure tunnels) with non-Gateway entities, which could risk revealing the Gateway's Introduction certificate to non-Gateway entities. But for that difference, steps 2926 through 2929 are then substantially similar to steps 2826 through 2829 in the previous figure. Here, too, transaction data may flow subsequent to the transaction establishment and initial application SDU, and steps 2930 through 2935 show the flow back to the originator from the destination server and imply the opposite direction. As with the transaction request flow, and for the same reasons, the relay action at step 2933 is subtly different from the corresponding action at step 2831 and 2833. In step 2933, the data is handed from Exposed Application Proxy 2551 to Secured Application Proxy 2552 in the direction shown, or from Secured Application Proxy 2552 to Exposed Application Proxy 2551 in the opposite direction, whereas in steps 2831 and 2833 the data is handled entirely by a Secured Application Proxy 2552.

The invention has been described above with reference to preferred embodiments and specific applications. It is not intended that the invention be limited to the specific embodiments and applications shown and described, but that the invention be limited in scope only by the claims appended hereto. In particular, while the Messaging Spam Prevention System 100 is described as pertaining primarily to end-user messaging applications such as email and IM, and Multimedia Spam Prevention System 1900 is described as pertaining primarily to end-user media sessions such as VoIP and videoconferencing, other applications may be built upon them as well. For example, machine-to-machine automatic messaging or data streaming may take advantage of the secure communication provided by System 100 or System 1900, respectively. The various Clients described may be augmented by adaptor functions to provide service for other protocols as well, such as HTTP-based web services protocols, localized data-recording protocols, proprietary EDI protocols, and so forth. It will be evident to those skilled in the art that various substitutions, modifications, and extensions may be made to the embodiments as well as to various technologies which are utilized in the embodiments. It will also be appreciated by those skilled in the art that such substitutions, modifications, and extensions fall within the spirit and scope of the invention, and it is intended that the invention as set forth in the claims appended hereto includes all such substitutions, modifications, and extensions.

1. A system for preventing messaging spam, comprising:
a packet network;
one or more gateways coupled to the packet network and operable to authenticate messages and message senders, reject inauthentic message traffic, and detect and control excessive message traffic; and
one or more network authorities coupled to the packet network and operable to register and certify gateways and other network authorities.

2. The system of claim 1, further comprising one or more user registries coupled to the packet network and operable to provide per-user management of questionable message traffic.

3. A messaging anti-spam gateway comprising:
an information security element operable to create authentication tokens for outgoing messages and to verify authentication tokens in incoming messages; and
a message relay element operable to forward messages with verified authentication tokens.

4. A user registry comprising:
an information security element operable to register and authenticate users; and
an account management element operable to provide users access to information related to their registration and, as necessary, create authentication tokens.

5. The user registry of claim 4, further comprising a webmail proxy that permits users to send and receive authenticated messages.

6. A network authority comprising:
an information security element operable to register and certify other network elements; and
an introduction management element operable to provide other network elements with encryption/authentication certificates issued by the network authority.

7. A system for preventing multimedia spam, comprising:
a packet network;
one or more gateways coupled to the packet network and operable to authenticate multimedia signalling units and their senders, reject inauthentic multimedia signalling traffic, and detect and control excessive multimedia signalling traffic; and
one or more network authorities coupled to the packet network and operable to register and certify gateways and other network authorities.

8. The system of claim 1, further comprising one or more user registries coupled to the packet network and operable to provide per-user management of questionable multimedia traffic.

9. A multimedia antispam gateway comprising:
an information security element operable to create authentication tokens for outgoing multimedia signalling units and to verify authentication tokens in incoming multimedia signalling units; and
a signalling relay element operable to forward multimedia signalling units with verified authentication tokens.

10. A method of preventing spam in a messaging service, comprising:
deploying an antispam gateway at the boundary of each protected network;
authenticating the sender of every outgoing message;
placing an authentication token in every outgoing message;
verifying the authentication token in any incoming message containing one; and
discarding any message for which the authentication token does not verify.

11. A method in accordance with claim 10, further comprising:
deploying an antispam agent adjacent to the messaging client of any user not served by an antispam gateway in a protected network; and
inviting the sender of any message not containing an authentication token to acquire an antispam agent.

12. A method in accordance with claim 10, further comprising:
tracking and limiting the amount of messaging traffic of each user;
providing feedback to each user regarding excessive and suspicious traffic; and
learning new traffic limits based on user response to feedback.

13. A method in accordance with claim 10, further comprising:
tracking the amount of incoming messaging traffic; and
providing feedback to sending gateways regarding sources of excessive messaging traffic.

14. A method of preventing spam in a multimedia service, comprising:
deploying an antispam gateway at the boundary of each protected network;
authenticating the sender of every outgoing multimedia signalling unit;
placing an authentication token in every outgoing multimedia signalling unit; and
verifying the authentication token in any incoming multimedia signalling unit containing one.

15. A method in accordance with claim 14, further comprising:
providing distinctive alerting to a called user that the calling user identified by a multimedia signalling unit is unverified.

16. A method in accordance with claim 14, further comprising:
deploying an antispam agent adjacent to the multimedia signalling client of any user not served by an antispam gateway in a protected network.

17. A method in accordance with claim 14, further comprising:
tracking and limiting the amount of multimedia signalling traffic of each user;
providing feedback to each user regarding excessive traffic; and
learning new traffic limits based on user response to feedback.

18. A method in accordance with claim 14, further comprising:
tracking the amount of incoming multimedia signalling traffic; and
providing feedback to sending gateways regarding sources of excessive multimedia signalling traffic.

19. A system for enabling dynamic electronic advertising with interactive communication, comprising:
a spam-free messaging medium;
one or more directory engines operable to collate and present listings and to support communication between users and listers; and
a directory clearinghouse operable to coordinate listings and communication services among multiple directory engines.

20. A method of providing mediated communication between advertisers and prospective customers, comprising:
deploying a spam-free communication medium;
offering advertising listings featuring mediated communication opportunities;
requesting a mediated communication; and
delivering the mediated communication such that the prospective customer's identity is not revealed to the advertiser.

21. A system for preventing denial of service attacks against applications, comprising:
a packet network;
one or more secure application gateways coupled to the packet network and operable to characterize and enforce normal application traffic levels, encrypt legitimate application traffic, and randomize communication ports so that wild traffic cannot interfere with legitimate application traffic; and
one or more network authorities coupled to the packet network and operable to register and certify secure application gateways and other network authorities.

22. A secure application gateway comprising:
an exposed application proxy element, operable to process and track wild traffic;
a secured application proxy element, operable to process and track protected traffic; and
an information security element, operable to randomize communication ports, authenticate correspondents, and encrypt communications.

23. A method of randomizing communication ports such that wild traffic cannot interfere with legitimate application traffic, comprising:
storing randomization parameters associated with a destination server in that server's encryption and authentication certificate;
selecting a listening port at that server by combining its randomization parameters with the current time;
at a requesting server, retrieving from a network authority the encryption and authentication certificate, including randomization parameters, of the destination server for a particular transaction; and
at the requesting server, selecting a destination port on the destination server by combining the destination server's randomization parameters with the current time.

24. A method of enforcing normal application traffic levels, comprising;
characterizing normal traffic;
detecting abnormal traffic;
tracing abnormal traffic back to its originators; and
preventing those originators from creating further abnormal traffic.
